(19) United States
(12) Patent Application Publication
(10) Pub. No.: US 2021/0239152 A1
(43) Pub. Date: Aug. 5, 2021

(54) KEY THREAD AND KEY THREAD SYSTEMS

(71) Applicant: Dale E. Van Cor, Winchester, NH (US)

(72) Inventor: Dale E. Van Cor, Winchester, NH (US)

(21) Appl. No.: 17/165,530

(22) Filed: Feb. 2, 2021

Related U.S. Application Data
(60) Provisional application No. 62/969,420, filed on Feb. 3, 2020.

(51) Int. Cl. F16B 39/30

(52) U.S. Cl. CPC F16B 39/30

(57) ABSTRACT

Key threaded systems that include key threads having a female lock and male key on a two-dimensional plane and in which the female lock envelops the male key when fully engaged and has a shape that creates lateral resistance to separation from the male key when the female lock fully engages the male key.

### CLAIM OF PRIORITY

This application claims the benefit of priority of U.S. Provisional Patent Application Ser. No. 62/969,420 filed on Feb. 3, 2020.

### FIELD OF THE INVENTION

The present invention relates to threaded mechanical fasteners and to threaded mechanical fastening systems.

### BACKGROUND OF THE INVENTION

All mechanical threads are a type of rotating fastening system. The four Van Cor Threads are a subset genre of mechanical threads that are based on the mathematics of total surface contact. They are high surface contact in practice. They are the Conic Thread (U.S. Pat. No. 9,080,590), the Wave Thread (U.S. Pat. No. 8,858,144), the Concentric Thread (U.S. Pat. No. 9,080,591), and the Key thread. The basic Wave Thread is a stack of circles. The basic Concentric thread is a stack of any shape not a circle. The Conic thread is a collection of mated thread profiles perpendicular to the thread train.

### SUMMARY OF THE INVENTION

The Key thread is every perpendicular profile that is not a Conic thread. All Van Cor Threads rotate into a specific, repeatable terminal position where all the surfaces engage at the same time. In practice, fabrication tolerance determines the amount of high surface contact.

The Conic thread is based on the Conic gear (U.S. Pat. No. 6,543,305) where teeth on a cone mesh with helical gear teeth to transmit torque. The helical involute profile engages the conic involute profile on the same plane. The Conic thread has a train of male profiles passing through female profiles. Where the thread train terminates, the male and female tooth profiles are both on the same plane, perpendicular to that train.

The Key thread is a lock and key function. There already is a female “locking thread form” in current use, so the Key thread name was selected. Like the Conic thread, the Key thread has a train of male profiles that pass through female Lock profiles to a terminal position where each male Key engages with its female Lock on the same plane. What is different is the locking and train movement.

Normally threads have a helix, a spiral around a cylinder that defines the location of a thread. The Key Thread has a Rail. Every point on the Key Rail has a perpendicular plane containing the Lock and Key profiles at their terminus. The difference is the Key Rail can be spiral, circular or straight; and either singular or part of a collective system. It determines the angular orientation of the thread profile relative to its start.

The other difference is the locking concept. The two-dimensional Key profile is any male shape that “hooks” to mate inside female Lock cavity. The Lock profile envelopes the male key pressing against its profile at its terminus. This “hook” is any lateral resistance engaging the inside of the Lock. To arrive at this terminus, the Key profiles have to pass through lock profiles until all keys arrive at all their locks at the same time. Then all the thread surfaces are engaged.

The Key profiles have to change in size, or shape, and/or angular orientation on its plane relative to their Rail. Another way to visualize this is that every key profile is a slice of a plug that has to pass through all lock cavities until the entire plug reaches its stop.

What is revolutionary is the simple rule that the Key has to pass through Locks to its terminus. That is limited of whatever any two-dimensional Key and Lock profiles can be. In addition, the Key Rail can go anywhere that allows the resulting train of Keys to pass through the Locks. This expands the capacity to fasten a cylinder, cone, disk, flat panel or spherical panel to a mating shape, or other geometries that follow the simple rule.

While the lock is female and the key is male, it is important for consistency to designate the parts these threads are on as male and female. The preferred embodiment is an external male part with both key and lock profiles that engage with a corresponding locks and keys on an internal female part.

Starting with the traditional cylinder shape, all threads are measured in tensile and compressive strength. Tensile strength is the amount of tensile stress or load it can resist before elongation or failure. Compressive strength is the resistance to size reduction or being crushed. On a cylinder these forces align with the axis with one degree of freedom. The locking aspect of the key thread always pushes and/or pulls in directions not aligned with the axis of rotation. Their profiles can be a range of directional resistance to stresses that change along the length of the thread train. Collectively they are spherical in scope and degrees of freedom become meaningless.

### Key Profile

Key threads are a collection of mating profiles ranging from a simple wedge shape to complex geometries. Key profiles have to transit, or transit and penetrate into the Lock profiles to their terminus without interference. Transit is the thread train's movement through the Locks and penetration is more specific movement into Lock while in transit. The lock shapes have to allow a key shape to penetrate into and/or transit through to avoid interference. The Lock and Key profiles always change in shape, size or angular orientation on its plane, along a Rail that is on one axis or a Rail's changing angular orientation along two or more axis relative to its start.

The lock and key are always a hook between two parts that adds spatial properties to the connection. Traditionally, threads are linear. The Key thread is spherical, and different thread geometries configure their scope of applications.

Relative to the direction of rotation, the key shapes can push away from the axis, pull towards it or both. A wedge shape can be made to push or made to pull. A dove tail shape does both, like wedge shapes in both directions. A wedge shape that stays the same shape has a transit and penetration path through different orientational positions relative to the Rail's axis. Each profile still has a specific mating terminus. The wedge shape can also change its angular orientation, which is a new shape, over the length of its train. A dove tail shape has to change its size because it will have less penetration and more transit. The push and pull are visual aids. The actual mechanics are relative to their use.

The preferred embodiment is altering lock and key shapes where space between the keys become the locks of the mating keys. These key threads are referred to as zipped like a zipper. Being both lock and key they are androgynous. Wedge shapes work. There can be better ones relative to their application.

The fabrication of Key thread profiles follows a path on a part body(s). These body(s) can have cylinder, cone, concave, convex, or disk features, combinations thereof or other geometries. There can be partial threaded components in an assembly with a single rotating connection. The rotation of the Key threads will never be mathematically circular. There will always be a spiral component to their movement. They will never have total surface contact; fabrication tolerance is always the rule. The goal is to be as reliable as possible. Key threads have to change in shape, size, and/or angular orientation along with changes in their Rail axes from start to their terminus to prevent interference and to achieve high surface contact when engaged. High surface contact is the effect of fabrication tolerances subtracted from the mathematics of total surface contact.

From the curved to flat bodies the lock profiles align the key profiles to match the rate of penetration with the transit rate of motion. The desired key profiles can be angled towards the axis, away from, include both, or have no angle. Then the clockwise or counter clockwise direction is selected second. The angle away from the axis seems counter-intuitive, like it is being unscrewed. It is just part of the box of tools.

A cylinder body shape will have a constant rate of engagement across the thread transit with no penetration. The cone body shape will have partial penetration of the male into the female body relative to the conix (cone) angle with a faster net rate of engagement. The disk body shape is the fastest way to engage with full penetration and the least transit. The curved concave and convex body shapes have varying rates of engagement. The concave will engage first at the large diameter and move inwards. The convex will engage the small diameter first and move outwards to the larger diameter. These rates of engagement are design functions for such things as avoiding interference and achieving high surface contact. The concave and convex shapes are based on the internal female shape. The external male will be the opposite.

The cylinder body shape is total transit and requires a changing profile size for all surfaces engage at the terminus. This change in size adds a small spiral feature. This applies to a spiral and circular path. The spiral is limited by the part body and how much room there is. The circular path is more limited to a half cylinder key that penetrates a half cylinder lock.

The disk and other curved bodies can also be transit only, with no penetrations. This requires up to half of the rotational space to be open for the starting position. Then the parts are rotated into their terminus position. The profiles still have to change in size such that at their terminus all surfaces engage at the same time. This is more practical for a partial threaded application that has the open starting space.

A disk can have total penetration along a spiral transit without changing thread size. A wedge shaped push or pull profile is well suited without changing the profile size or shape. This is all about the angular orientation along the Rail. With the transit and penetration in sync the wedge penetration stays aligned into the lock with the rotation to the terminus.

The body can also be a concentric or wave threaded surface. This would add key fastening components to these larger threaded structures such as an additional locking mechanism to resist unloosening. These examples demonstrate that the key threads can be added to other types of connecting systems.

The key thread profiles can also have additional structures for the purpose of increasing the surface area or other properties. An example is a miniature conic thread on the bottom of a dove tail profile. This partial conic thread will penetrate with the profile as the key and lock rotate to terminus. Increasing the surface area will conduct more heat; make more electrical contact; and increase the amount of friction to overcome to unscrew; a consideration for permanent assemblies.

Multiple transits on the same part have to be designed to engage as evenly as possible. Everything is limited by fabrication tolerances. A disk can be a mix of longer and shorter transits that still have to have a related rate of change. The longer radius would start with a smaller key that would increase in size at the same rotational rate as the shorter radius, but over a longer distance. This is not an issue with a cylinder with a fixed radius.

The Key thread profiles can be designed to create cavities with keys smaller than the locks to form channels. Such channels can be grouped similar to honey comb structures that affect strength, elasticity and/or reduce weight.

The Key thread is a force distributor. Its shape determines how and where mechanical stresses are to be channeled and resisted. These constantly changing thread profiles may be difficult to machine and more suited to 3D printing and molding.

The devil is in the details. All these transits and penetrations are relative to fabrication tolerances. Longer transits will require larger changes then smaller ones even on the same part. Penetrations will be usually shorter and not as relative as the transits, meaning transit design will be more important.

Threads are a clamping tool. While traditional threads are a linear clamp, Key threads are linear and spatial. The thread Rail on a body determines the major clamping direction and length. The spatial aspect adds a force cloud of varying intensities to the clamping directions. The Key thread will start with a small surface contact and proceed to full surface contact. The clamping strength starts small and increases to its maximum over the length of its thread train.

The Key thread is a profile on a curved path that can be formed from a concentric thread. This will allow a square shaped concentric thread converted to a lock and key profile to be used in attaching square sided panels together. This can be applied to any concentric thread including multi-axis ones that screw around a corner. The lock and key profiles can be added to wave threads in the same manner. These profiles add spherical resistance to mechanical stresses for these applications.

### Key Rail

On a standard thread the thread train is based on a helix that wraps around a cylinder shape at a constant helical angle. That helix is the Key Rail on a Key thread except it can be a line, curve or spiral that can have one or more axis of motion on shapes that include cylinder, concave, convex, conic, disk or flat panel. This Key Rail is a collection of points for each perpendicular plane. With the exception of a straight Rail, Key Rails have an angular orientation that is inherited by the Key profiles.

The Key Rail is the first design step and is added to geometries. The Rail is one unit that the thread train has to follow with the same rotation and/or insertion. Once in place, next is designing the key profiles to fit the desired path. While Key threads are continuous, their Key profiles are continuously changing.

The Key thread profiles are hung on their Key Rail. Hung is an appropriate word because it allows for another degree of freedom. The profiles can follow the shape of the surface they are on or they can be positioned flat for a disk thread; upright for a cylinder thread and any conic angle in between with the net Key thread fitted to any surface shape.

### Key Thread Train

A Key thread train represents all the Key profiles that pass through Lock profiles en route to engage all their termini at the same time. The thread train follows the Key Rail in a circle, a constant spiral or an accelerating spiral. Technically the circle is in concept, only. The profiles have to change thus netting a spiral motion, although it will be small. The thread train can be around a cylinder, cone, concave, convex, disk or combinations of these and other shapes.

The disk and cylinder can have a circular train; all others are a spiral train. The cylinder is transit only. The disk can be either transit or transit and penetration. Of the shapes, the disk has the most penetration relative to transit. Cone, concave or convex surface shapes have transit and penetration.

Where the Key thread really distinguishes itself is in how it can fasten surfaces together into layers of a dome, cylinder or disk. This can include groups of Key threads. The disk threads can expand their radius into straight lines creating flat surfaces applications. These are surface trains and they overlap.

### Key Thread Systems

The Key thread systems include applications from the Conic, Concentric and Wave Threads patents such as optic, electronic, and channel alignments; valves and fasteners. Many unique Key thread applications are interlocked. According to Wikipedia, an interlock is a feature that makes the state of two mechanisms or functions mutually dependent. Key interlocking multiplies the properties of two or more Key threads on a body. They include multiple layers with overlapping threads and threads that position and align assemblies. Interlocking layers of key threaded disks have truss-like properties, but a truss consists of two-force members where force is applied on two points. Key interlocks apply forces circularly or spherically. The mechanical stresses are distributed, not focused on points.

Interlocked layers can be different thicknesses and different threads. These can be small sealed layers sandwiching larger stronger layers.

Key Thread Systems often have threads on different axes of rotation, different planes or different angular orientations on the same part.

Key threaded systems are mechanically assembled and can be mechanically dis-assembled. They are designed to maintain the desired parts properties and be resistant to loosening. Dis-assembly most likely will be in the reverse order. This allows reuse of components or the recycling of materials. Most key threaded systems are assemblies of multiple base parts with some special parts thrown in, such as connectors to other assemblies.

The Wave thread has a bolt application designed to evenly distribute tensile load with the unexpected effect of 25% more load capacity based on Finite Element Analysis. The Key thread can use the same body and path with a locking profile that will resist more load than the Wave thread because of how it pulls more out of its mated Key thread.

Unique Key threaded systems are Key Bricks, Key Disks and Panels, Key Tubes, Key Domes, Key Beams and Keypods. Key bricks connect without mortar with interlocking layers. Key Panels are like laminated layers—stronger than a solid layer. Key Tubes are like the Key Panels except that they form a cylinder with unique layers. Key Domes are also similar to the Key Panels except they are designed spherically and each layer is different like the Key Tubes.

Key Beams are assemblies that include I-beam, Angle Iron, T Iron, Channel Iron, and Trusses that are components used to make larger constructs. This is similar in concept to Lego blocks, except screwed together and difficult to unscrew. They will have Key threaded connections to other parts.

Keypods are used to attached three or more corners. Where ever there are three or more connections, there is a Key threaded cone that can fit over all of them.

### Key Bricks

The brick is a rectangular body with mortar applied to the ends, top and bottom. The mortarless Key Brick has cylinder threads on the ends and disk threads at its flatter top and bottom. The cylinder threads and disk threads transit while rotating the brick into position. The bottom of the brick is the full disk thread while the top has two partial threads. The partial threads are aligned with the neighboring bricks so the full threaded bottom of the next brick will pull them together in an interlocked system.

Another type of Key Brick has the disk threads on the ends and the half cylinder threads on the top and bottom. They rotate vertically into position.

Key Bricks can be designed for arch or dome constructions. These can be curved Key Brick shapes and/or different Key threads.

The Key Brick materials and fabrication can be the same as traditional bricks or with any aggregate plus a binder agent. This additional material could be ground up recycled plastic with 20% new binder material added. It could be ground up glass, tires or slag as a way to re-purpose material destined for the landfill. These could make buildings, bridges, embankments, retaining walls, or foundations for roads. Their use and reuse have applications beyond traditional bricks.

### Key Panels

Key Panels are very much like the Key Bricks only with a larger scale flat side. The emphasis is on the key threads offset to the opposite side. They are connected to form a stack like laminates, but laminates are permanently assembled by heat, pressure, welding or adhesives. They would be a collection of repeating patterns to be made in bulk. Sub-panels that engage with panels would be the threaded ends or would square off the end. The net edges of multiple sub-panels could be a larger threaded connector to other parts.

### Key Tubes

The Key Tube concept is to make stacks of uniform parts that can be assembled into a tube. Such parts could be easily molded, compacted into packages delivered and assembled into pipes. This would be more efficient transportation and storage than empty pipes.

The basic Key Tube can be rectangular-like parts whose connections form a multi-layered cylinder part. Each layer has a unique set of parts. The layers have interlocking Key threads that alternate in angular direction. High angle cylinder threads can use the outside edges to connect the first layer. The outside surfaces of the first layer had multitudes of high angle cylinder threads in the opposite direction as the connected edges. If the edges are clockwise, the surface threads are counter-clockwise. The multitudes of cylinder threads are best covering the outside surface. They interlock with the second layer in a way that covers the connecting edges. It is preferred to have at least a third layer so the outside of the second layer will be in the opposite direction. The third or more layer has the finished outer layer.

There can be as many layers as desired. Each layer is based on a different diameter, connection and size. The inner and/or outer layers could be designed to form a seal while the middle layers could be larger for load capacity of higher pressures. These would be like a laminated structure. They would be repairable tubes.

### Key Spheres

The concept of the Key Sphere is any dome-like construct. Flat-paneled structures like Geodesic domes or Plutonic solids have corners that are on a sphere but their flat sides are between these points. These points are used by the Key Spheres to define Key Sphere panels using the same corners, but the boundary lines are on the sphere's surface. These spherical panels engage in layers like the Key Panels and the Tubular Panels. Their difference is one, two or three axes of motion for these panels to engage in overlapping layers.

### Key Beams

Expansion of the panels and corners can create structural I-beams, Angle Iron, T-Iron, Channel Iron, Gussets, and new construction shapes. They can also be designed with built in connectors to other parts.

An I-beam shaped part can be made from slices of a threaded conic or concave or convex shapes. The middle, or web of the I-beam will be triangular slices out of those shapes. These will mate with inverted parts that are either rotated in an arc or twisted on its axis to engage. Subsequent triangles can be added inside the web, contributing to its thickness. These offset the first triangles covering their connections.

An Angle Iron is similar to the I-beam, but with two triangles at 90-degrees with the same insertion rate so one motion engages. Like the I-beam, the web can be multiple layers. These angular components can be any angle and do not have to be straight, but could have curved characteristic.

Channel Iron is a U-shaped bar. Like the Angle Iron, these will be triangular slices across the web with the channel flanges on side of the slices. There can be multiple interlocked layers.

Gusset Plates are structural components used to reinforce inside corners. Key threads can be used to fasten them. A Key threaded 45-degree cone has a net 90-degree angle and a partial Key thread on the outside edges of a Gusset Plate which will connect two structures at 90-degree angles. It can be applied to any angle such as 60-degrees or 110-degrees. They are either twisted or arced into position. The receiving threads on two sides have a common radius and can have a common thread profile. The terminal position can be into a third side with the same common thread radius. A twisted Gusset is a section cut out of a Key threaded cone. An arced engagement path is a disk thread. If the surface is curved then the twisted thread is based on a concave or convex shape.

This invention will allow products to be made with fewer fasteners. Motor mounts will have multiple Key threaded posts that engage with a threaded mount. The motor is rotated a few degrees to engage the mounts. The direction of the engine torque is always into the mounts, not out of them. This replaces several bolts with one to keep it from unscrewing. This is an example where interlocking Key threaded parts reduce the need of other fasteners.

### Keypods

A Keypod is for fastening panels with a quick rotation to assemble a square box or any structure. A square box has three planes so corners will have either a conic or convex shape with circular or spiral key threads. These engage a tripod shaped keypod who's inside legs have the mating threads. Each inside key leg is part of the key thread. The panels will have mating outside matching threads. This will allow boxes that can be quickly assembled and dis-assembled with the benefit of packing flat.

### Multi Axis Locking

Multi axis is from multiple sets of key threads each with their axis of rotation on a part. The preferred embodiment is a Keyed brick. It's a brick shape with six sets of key threads and four different axes of rotation. Assembling the bricks in a wall with all four axis of rotation fully engaged adds rigidity or locking to the total assembly.

### Shape Resistance

In the Keyed Brick, the key threaded ends have a circular shape. This geometry resists sheer planes. The key threads are locking both sides of the shape and this breaks up linear loads.

While a Key thread system is not permanent, its disassembly would be in the reverse order of assembly. The purpose of disassembly would be for salvaging materials or recycling parts.

The Key threads can easily be beyond machining capacity. Most 3D fabrication will make Key threaded parts. Molding is the most likely manufacturing process. The limitation is that removing the key threaded part will require unscrewing the part from the mold.

### Aspects of the Invention

### Profiles:

It is an aspect of the Key thread profiles that there be a female Lock and male Key on a two-dimensional plane whereby the female Lock shape envelops the male Key shape when fully engaged and has any shape that creates a “hook” or lateral resistance to the male and female separation when the Lock and Key profiles fully engage.

It is an aspect of the Key thread to have different male Keys pass through female Locks en route to their termini; to have Keys transit, or transit and penetrate Locks en route to terminus; and to have all Keys and Locks engage at their terminus at the same time.

It is an aspect of the Key thread to have profile shapes that change in size, shape and/or the angular orientation on their plane.

It is an aspect of the Key thread to have partial engagement by design, that add properties such as less weight and more flexibility; to have complex shapes unique to threaded fastening.

It is an aspect of the Key thread for the profile shapes to have directional or spherical mechanical properties by design.

It is an aspect of the Key thread to have two Key threads on a part that rotate on one axis but move in opposite directions, one inward the other outward. This is called a Keynection.

It is an aspect of the Key thread to have Lock and Key profiles that engage in different directions to their terminus.

It is an aspect of the Key thread to have the adjacent Keys sides forming Lock cavities. This is called a Zipped Key Thread.

### Rails:

It is an aspect of the Key Rail to be the designated path of the Key thread train representing a collection of points, with each point having a directional vector to the next point; to have a profile plane on each point perpendicular to that directional vector; and to be the coordinate and angular orientation that the profile inherits as its spatial position.

It is an aspect of the Key Rail to determine the rate of change added to the profiles rate of change; to be the transit, or transit and penetrate, the profiles on cone, concave, convex, cylinder, disk and other shapes; to be straight, circular or spiral in direction or to be flat with no ascending, constant ascend, accelerating ascend or ascend straight up.

It is an aspect of the Key Rail to be singular or collective on a shape, to have any degree of rotation starting at zero for a straight motion.

It is an aspect of the Key Rail to be on a disk at any radii and thus functionally straight at a large radius; to have a straight motion from any angle at its origin.

It is an aspect of the Key Rail to have the Rail and the Key and Lock independent in design, dependent in practice; to have multiple Key train designs on the same Rail,

It is an aspect of the Key Rail to be added to Concentric or Wave threads or other surface geometries employing a Key Thread.

### Trains:

It is an aspect of the Key Thread Train to be a collective of all the Key profiles that move through all the Lock profiles to terminate at the end of the Key Rail; for the Keys to transit, or transit and penetrate, the Locks en route to the terminus without interference; and for the Key and Lock profiles be changing in size, shape or angular orientation en route.

It is an aspect of the Key Thread Train motion to its terminal engagement to be through a one-axis linear, two-axis circular, archemedic spiral or logarithmic spiral; three axis constant or expanding circular, archemedic spiral or logarithmic spiral; or an exotic multi-axis configuration.

It is an aspect of the Key Thread Train to have circular trains that transit only.

It is an aspect of the Key Thread Train to have multiple trains on a disk and to have two or more spiral trains Keynected that move in opposite directions with the same rotation.

It is an aspect of the Key Thread Train to have circular trains that are half-thread and half-open landing area profiles for pre-transit positioning; that then transits into the other half with full thread profile at the terminus.

It is an aspect of the Key Thread Train to have a circular train whose profile is half the landing area and half the thread that initially are positioned in the landing area, then transit to the thread profiles engaging at terminus where all the threaded half of the profiles engage.

### Key Thread Systems

It is an aspect of Key Threaded Systems to connect two or more Key threads on two or more sides. This is called an Interlock.

### Interlocked Key Brick

It is an aspect of Key Thread Bricks to combine disk and cylinder/conic/concave/convex Key threads on a brick part that has a designated front and back face; that has a mating end with a partial cylinder/conic/concave/convex thread, preferably a cylinder thread; that has a second mating end with the same thread at the opposite end of the mating end; that has a designated bottom with a partial disk thread; that has the designated top with the second half of the bottom thread followed by the first half for the purposes of mating with halves of two other bottom threads; to assemble the mating curves such that the bottom threads overlap top threads from two other bricks forming an interlocked connection.

It is an aspect of Key Thread Bricks to have a designated face with a curve and the second mating end rotated relative to that curve; and to have the second bottom thread rotated relative to that curve to align with the next curved brick to be added.

It is an aspect of Key Thread Bricks to have the designated top end angled on a wedge shape, with the second mating end also angled on the wedge so that the next layer of bricks is on the same angle to form a cylindrical or arched structure.

It is an aspect of Key Thread Bricks to combine curved and wedge processes by reducing the size of each layer relative to the curve to form a dome.

### Interlocked Panels

It is an aspect of Key Thread Panels that are based on any disk train(s) with any two-dimensional shape cut out, such as a square, oval, or star, that it is used as a panel surface that engages with a mating surface. Zipped Key Threads are preferred.

It is an aspect of Key Threaded Surface Panels that they can have multiple trains with the same center of rotation on a parts surface; that they can have multiple trains on different surfaces of a part with the same center(s) of rotation, move into their terminus at the same time.

It is an aspect of Key Threaded Surface Panels that they can have multiple trains with the same center of rotation on a parts surface; that they can have multiple trains on different surfaces of the part with the same center(s) of rotation, that move into their terminus at the same time.

It is an aspect of the Key Threaded Surface Panels with multiple trains on different surfaces of the part move in the same direction and time into their terminus.

It is an aspect of Key Threaded Surface Panels to have its panel assemblies be in a sequential order of assembly with each subsequent placement locking the previous placements in position.

It is an aspect of Key Threaded Surface Panels to have a Lock Step between two adjacent edges allowing clearance for the next layer to engage the locks without interference from the panel it is passing over to achieve this. The next layer adjacent panel will terminate against the first panel.

It is an aspect of Key Threaded Surface Panels to have a Panel Step between two adjacent edges allowing clearance for the next layer to engage the locks without interference from the panel it is passing over, and clearance over the next layer adjacent panel, allowing the first panel to be added/removed without interference. This reduces some of the sequentialness of assembly.

It is an aspect of Key Threaded Surface Panels with straight Key threads to have a Panel Step between two adjacent edges eliminating the sequential assembly.

It is an aspect of Key Threaded Surface Panels to have Split Recessed Key Threads that are multiple Key Threads on a panel, with some recessed, allowing one threaded panel to move over the recess Key threads to its terminus; and then a mating recess Key threads on a separate panel engage to its terminus; and thus completing an interlocked connection.

### Tubular Interlocks

It is an aspect of Key Threaded Interlocked Tubes to be a collection of curved panels with cylinder or spiral Key Threads, whose Key Thread Train is curved or straight; that different panel layer sets for different diameters; that assemble in one angular direction while the Key Rails run in a different direction, so that the effect of the next layer is interlocked and crossing previous layer edges, as opposed to aligning.

It is an aspect of the Key Threaded Interlocked Tubes to use straight threads aligned with the axis for the purpose of precision positioning in that the angular direction of the straight threads are not affected by fabrication tolerances while curved and angular threads are.

### Spherical Interlocks

It is an aspect of Key Threaded Spherical Interlocks to use the geometric points of geodesic polyhedrons and any other solids with intercept surface points, as the boundaries for surface panels.

### Key Beam

It is an aspect of the Key Beam to create a truss system by connecting web and flange components using disk and cylinder/conic/concave/convex Key threaded parts; with the web having triangular parts that are locked at the intercepts by flange components with circular locking Key threads to form a beam.

It is an aspect of the Key. Beam to create a truss system by connecting web and flange components to create I beams; H beams, Channel Irons, Square Tubes, T Irons and Angle Irons; and other structural tools.

### Keypod

It is an aspect of the Key Threaded Keypod to be inside and outside corner components using a circular or spiral Key thread on a conic, concave or convex shape that matches the corner's edges; to cut out the arms of the Keypod for partial threads that engage in a small rotation; to create the mating threaded surfaces the Keypod will engage.

It is an aspect of the Keypod to have its inside or outside be used for mechanical properties such as hardened footing, height for a forklift, rails to slide into a locking position.

### Bolts

It is an aspect of Key Threads applied to a Bolt, to follow the geometry of the Wave Thread, which is designed to evenly distribute mechanical stresses while adding more tensile strength. This will result in similar distributions of stress on the Bolt, and will add more resistance because of the “hook” properties.

### Multi Axial Locking

It is an aspect of sets of Key Threads applied to multiple surfaces on a part that engages with an assembly of parts to resist individual rotation. The more accumulated sets of threads that engage other parts, the tighter the resistance to movement.

### Shape Resistance

It is an aspect of the placement of key threads on surfaces that are more resistant to mechanical stresses based on their shape. A curved shape resist the formation of a sheer plane.

These aspects of the invention are not meant to be exclusive and other features, aspects, and advantages of the present invention will be readily apparent to those of ordinary skill in the art when read in conjunction with the following description and accompanying drawings.

### Key Thread Glossary

As used in the present application, the following terms have the following meanings:

“Keynector” is at least two different sets of key threads that engage in the same direction of rotation. They can be for designing stress resistance and/or connecting parts together.

“Interlock” is where one or more threads overlap on one or more parts for the purpose of locking the parts together

“Zippered or Zipped key threads” where the Key sides create the Lock cavities.

“Split lock circular train” has at least one partial Key thread and at least one open landing area sized to receive a partial key thread. The partial thread(s) is positioned in their landing area(s) of the mating part and then a rotational transit of the partial Key moves then into their mating Lock.

A “Lock Step” is part of a panel design allowing the Locks to be accessible above adjacent panels so that the next panel layer may be assemble into those Locks.

A “Panel Step” is also a panel design allowing for individual panels to be added or removed among a construct of panels.

The “Terminus” is the terminal position where all the Key profiles are inside of their mating Lock profiles on their shared planes.

A “Key Profile” has a male Key enveloped by a female Lock with a locking shape in its geometry at its terminus.

A “Key Rail” is the path the Key Train follows to its terminal position.

A “Key Train” is the collection of Key profiles that pass through the Lock profiles to their terminus.

A “Multi Axial Lock” consist of multiple sets of key threads on a part that engage with the key threads of other parts and at other axis of rotation with net effect of locking the part from movement on any axis.

A “Set” or “Key Thread Set” is a group of one or more adjacent key threads with a common axis of rotation and specific clamping characteristics that engages with another set that can be on one or multiple parts.

A “Keyed Brick” or Keyed Block” are construction components with key threads on multiple sides that connect with multi axial locking without adhesives.

### BRIEF DESCRIPTION OF THE DRAWINGS

FIG. 1 is an angled view of a Key threaded part that morphs from a cylinder, concave to a disk shape.

FIG. 2A is a cross section view of an upward wedge-shaped Lock relative to a vertical axis.

FIG. 2B is a cross section view of a downward wedge-shaped Lock relative to a vertical axis.

FIG. 2C is a cross section view of a dove tail shaped Lock beside a vertical axis.

FIG. 2D is a cross section view of bulbous shaped Lock beside a vertical axis.

FIG. 3A is a cross section view of an inward lateral wedge-shaped Lock towards a vertical axis.

FIG. 3B is a cross section view of an outward lateral wedge-shaped Lock away from a vertical axis.

FIG. 3C is a cross section view of a lateral dove tail shaped Lock beside a vertical axis.

FIG. 3D is a cross section view of a bulbous shaped Lock beside a vertical axis.

FIG. 4A is a cross section view of a small Key in a larger Lock.

FIG. 4B is a cross section view of the small Key in FIG. 4A expanded in size to represent the passage of the changing Key through the Lock.

FIG. 4C is a cross section view of the small Key in FIG. 4A fully transited to its terminus position in the Lock.

FIG. 5 is an example of how a Key Thread Train can still have more Key to finish in an enclosed cavity.

FIG. 6A is a cross section view of the beginning of a Key shape in a Lock forming a honeycomb cavity.

FIG. 6B is a cross section view of the middle of a Key shape moving out to form a honeycomb cavity.

FIG. 6C is a cross section view of the end of the Key shape movement that formed an eight-sided honeycomb cavity.

FIG. 7A is a cross section view of a dove tailed shaped Key in a Lock at its terminus.

FIG. 7B is a cross section view of a dove tailed shaped Key in a Lock with a different angle than FIG. 7A.

FIG. 8A is the beginning cross section of a wedged shaped Key entering a Lock.

FIG. 8B is an example of the synchronized movements of the wedge from FIG. 8A Key moving into the Lock.

FIG. 8C is the result of the synchronized movements of the wedge from FIG. 8B Key deep into the Lock acting on two different directions.

FIG. 9A is the beginning cross section of a Key with a different angle shape than the Lock.

FIG. 9B is the cross-section example of the Key from FIG. 9A that is getting larger and its angle is changing towards the Lock angle as the Key penetrates the Lock, as it is moving downwards and into the Lock.

FIG. 9C is the cross section of the combined expansion in size of the Key, its change in angle and its lateral and vertical movement into the Lock.

FIG. 10A is a cross section of the starting position of a demonstration in combined Key movements into a Lock.

FIG. 10B is a cross section of the upward movement of the wedge into the lock combined with the downward motion of the thread and the lateral motion of fastening.

FIG. 10C is a cross section of a deep penetration for the Key into a Lock with a combination of an upward and inward motions of the Key.

FIG. 11A is a cross section of a starting position of a smaller Key with a different shape than the Lock about to penetrate into an upward shaped Lock.

FIG. 11B is a cross section of a Key expanding in size and an angular orientation as it penetrates halfway into the Lock moving to two angular vectors.

FIG. 11C is a cross section of a Key close to its terminus that is expanding in size and angular orientation to mate with the Lock.

FIG. 12A is a cross section of a cone shaped bolt and cap with two sets of zipped Locks and Keys angled in opposite directions representing a type of Keynection.

FIG. 12B is a cross section of a cone shaped bolt and cap with the cap half screwed on showing the Key penetrations into the Locks while the opposite directions become closer.

FIG. 13 is a cross section of a cone shaped pipe and partially inserted cap with two wedge shaped threads in opposite directions configured as a keynection.

FIG. 14 is a cross section of a cone shaped pipe with a cap fully inserted fully engaging both sets of threads.

FIG. 15A are circles positioned for circular Key Rails around a cone shape.

FIG. 15B is a constant spiral of a Key Rail around a cone shape.

FIG. 15C is an expanding spiral Key Rail around a cone shape.

FIG. 15D are the positions of multiple and different high angles expending spiraled Key Rails on a cone shape.

FIG. 16A are circles positioned for circular Key Rails around a concave shape.

FIG. 16B is a constant spiral Key Rail around a concave shape.

FIG. 16C is an expanding spiral Key Rail around a concave shape.

FIG. 16D is the positions of multiple and different high angle expanding spiral Key Rails on a concave shape.

FIG. 17A are circles positioned for circular Key Rails around a convex shape.

FIG. 17B is a constant spiral Key Rail around a convex shape.

FIG. 17C is an expanding spiral Key Rail around a convex shape.

FIG. 17D is the positions of multiple and different high angle expanding spiral Key Rails on a convex shape.

FIG. 18A are circles positioned for circular Key Rails around a disk shape.

FIG. 18B is a constant spiral Key Rail around a disk shape.

FIG. 18C is an expanding spiral Key Rail around a disk shape.

FIG. 18D is positions of multiple and different high angle accelerating spiral Key Rails on a disk shape.

FIG. 19A are circles positioned for circular Key Rails around a cylinder shape.

FIG. 19B is a constant spiral Key Rail around a cylinder shape.

FIG. 19C is an expanding spiral Key Rail around a cylinder shape.

FIG. 19D is positions of multiple and different high angle accelerating spiral Key Rails on a cylinder shape.

FIG. 20A are Key Rails on the crests and roots of a concentric threaded part.

FIG. 20B are Key Rails on the crests and roots of a wave threaded part.

FIG. 21A is the continuous Key Rail starting on a disk, morphing to a convex and ending on a cylinder shape around the Key threaded part in FIG. 1.

FIG. 21B is a constant circular spiral Key Rail on a cylinder that ends by engaging a constant disk spiral Key Rails at the bottom of the cylinder.

FIG. 21C are partial circular Key Rails on a cylinder and disk that will position first, then transit 90-degrees.

FIG. 21D are three layers of circular Key Rails that can be on different shapes that engage at the same time.

FIG. 22A is a cross section of the start of a disk Lock and Key on an angular insertion of a wedge shape.

FIG. 22B is a cross section of the middle of a Lock and Key angular insertion of a wedge shape.

FIG. 22C is a cross section of the terminus position of the Lock and Key angular of a wedge shape.

FIG. 23 is the cross section of the middle of a Lock and Key angular insertion of a different angled wedge.

FIG. 24. is an angled view of two disk threads, one that screw inward and one that screws outwards to demonstrate a Keynection.

FIG. 25A is a cross sectional slice of two sets of Locks and Keys at opposite angles to each other, at their initial engagement.

FIG. 25B is cross section of two sets of Locks and Keys in their middle engagement position with the Keys moving away from the center.

FIG. 25C is a cross section of the two sets of Locks and Keys at their terminus position.

FIG. 26A is an angled view of a partial circular dove tail Key over a mating circular landing on a disk.

FIG. 26B is an angled view of a partial circular dove tail Key thread being lowered into the circular landing of mating disk.

FIG. 26C is an angled view of a partial circular dove tail Key thread rotated halfway into the circular Lock of the mating disk.

FIG. 27A is the cross-sectional slice from FIG. 26 B of the dove tail Key shape half way into its landing channel.

FIG. 27B is the cross-sectional slice from FIG. 26 B of the Lock on the mating disk.

FIG. 27C is the cross-sectional slice from FIG. 26C showing the Key in the Lock of the mating disk.

FIG. 28A is the Top Key of a circular split Lock positioned above a mating bottom split Lock Key.

FIG. 28B is the Bottom Lock of a circular split Lock Key thread positioned for the mating Top Key.

FIG. 28C is the partial Key of a split Lock Key thread in the bottom Lock landing area.

FIG. 28D is the partial Key rotated halfway into the Lock of the bottom split Lock Key thread.

FIG. 29A is the cross-sectional slice of the Lock at the bottom Lock of the split Lock Key thread from FIG. 28D.

FIG. 29B is the cross-sectional slice of the top Key in the bottom Lock at its transit starting position from FIG. 28D.

FIG. 29C is the cross-sectional slice of the top Key approaching the sides of the bottom Lock while in transit from FIG. 28D.

FIG. 30A is a cross section of a left facing Key positioned over the Lock of a split Lock Key part.

FIG. 30B is a cross section of a right facing Key opposite FIG. 30A.

FIG. 30C is the transit starting position of the left facing Key in the landing of the Lock.

FIG. 30D is the transit starting positing of the right facing Key in the landing of the Lock.

FIG. 30E is the transit position of left facing Key inside the left facing portion of the Lock.

FIG. 30F is the transit position of right facing Key inside the right facing portion of the Lock.

FIG. 31 is the bottom disk of multi-ring split Lock Key threads with multiple split Locks on the same rings.

FIG. 32A is a top view of a diagram of a partial disk with two mating threads in square shapes.

FIG. 32B is a top view of upper threaded square shape moving into lower square shape.

FIG. 32C is a top view of the upper and lower threaded square shaped fully engaged.

FIG. 33 are oval, Star and hexagon shapes fully engaged on a threaded disk.

FIG. 34A is the top view of two mating circular zipped Lock and Key disk threads at starting position.

FIG. 34B is the top view of two mating circular Lock and Key disk threads partially rotated.

FIG. 34C is the top view of two mating circular Lock and Key disk threads fully engaged.

FIG. 35A is the cross section of a dove tail Key in a Lock for a short transit.

FIG. 35B is the cross section of smaller dove tail Key in a Lock for a longer transit than FIG. 35A.

FIG. 36A is the cross section of different sized circular and zipped Locks and Keys engaging the first third of the Key threads.

FIG. 36B is the two thirds engagement of the key threads noting the diminished space between the threads.

FIG. 36C is the at the terminus position of different sized zipped Key threads.

FIG. 37 is the front view of a cone shaped part with zipped wedged shaped Locks and Keys.

FIG. 38 is the front view of convex shaped part with zipped wedged shaped Locks and Keys.

FIG. 39 is the front view of concave shaped part with zipped wedged shaped Locks and Keys.

FIG. 40A is the front view of partial sphere with an angled straight Key thread Lock.

FIG. 40B is the front view of partial sphere with a straight Key thread Lock.

FIG. 40C is the front view of partial sphere with a curved Key thread Lock.

FIG. 41A is the angled view of cylinder half with an angled Key thread Lock.

FIG. 41B is the angled view of cylinder half with a straight Key thread Lock aligned with its axis.

FIG. 41C is the angled view of cylinder half with a circular Key thread Lock.

FIG. 42A is a flat panel with straight Key thread Lock.

FIG. 42B is a flat panel with straight Key thread Lock at an angle.

FIG. 42C is a flat panel with curved Key thread Lock.

FIG. 43A is a profile of a Wave threaded part with varying period and amplitude.

FIG. 43B is a profile of Key threaded part with the FIG. 43A wave thread characteristics.

FIG. 44A is a design mechanism of disk and cylinder threads used to design a Key brick with flat sides.

FIG. 44B is the boundaries of sides and bottom of a Key brick from FIG. 44A.

FIG. 44C is the boundaries of the top and end of a Key brick.

FIG. 45A is the interlocking positions showing bottom of a top Key brick over the tops of two bottom bricks.

FIG. 45B is the starting position of a top Key brick engaging with three Key bricks, two on the bottom one on top end.

FIG. 45C is the terminus position of Key brick engaging with three other Key bricks adding to the structure.

FIG. 46A is the design mechanism of disk and cylinder threads used to design a Key brick with curved sides.

FIG. 46B is a curved sided brick with bottom and end threads from 46A.

FIG. 46C is a curved wall structure from curved sided bricks.

FIG. 47A is a design mechanism of disk and cylinder threads with straight sides at different heights.

FIG. 47B are the boundaries of the sides and bottom of Key brick from FIG. 47A.

FIG. 47C is the wedged shaped brick from FIG. 47A with top threads not added.

FIG. 47D is the arched wall of wedged shaped Key bricks that are changing in size.

FIG. 48A is the start of Key brick designed to rotating vertically into position.

FIG. 48B is the terminus position of Key brick from FIG. 48A in the wall structure.

FIG. 49. is the Key brick structure with Key bricks that fasten on two layers at different fastening positions.

FIG. 50A is a top angled view of a cylinder component for a panel with four partial Key threads.

FIG. 50B is the bottom angled view of a cylinder component from FIG. 50A for a panel with one full Key thread.

FIG. 51A is a top angled view of Key threaded cylinder components positioned to start making a panel.

FIG. 51B is a top view of FIG. 51A with second layer of Key threaded cylinder components for a panel.

FIG. 51C shows six layers of Key threaded components and ending components building the panel.

FIG. 52A is a top angled view of a two layered cylinder Key threaded component with ten partial/full Key threads.

FIG. 52B is a bottom angled view of two layered Key threaded components with full Key threads on the bottom and side.

FIG. 53A is top angled view of two layered Key threaded components in first layer starting positions for a panel.

FIG. 53B is a second layer view of FIG. 52A components screwed into the first layer holes.

FIG. 53C is a nine-layer structure of FIG. 52A components with a smooth top finished layer.

FIG. 53D is the FIG. 53C structure with partial Key threaded components that collectively form an end piece.

FIG. 53E is the FIG. 53D structure with a finished piece added to the end.

FIG. 54A is a multi-Key threaded curved Locks on a bottom panel with the top mating panel in starting position.

FIG. 54B is the top panel from FIG. 54A rotated into its bottom panel forming a single paneled assembly.

FIG. 55A is a multi-Key threaded angled straight Locks on a bottom panel and top panel in position to engage.

FIG. 55B is the FIG. 55A top panel inserted into bottom panel forming single paneled structure.

FIG. 56A is a multi-Key threaded straight Locks on a bottom panel and top panel in position.

FIG. 56B is the FIG. 56A top panel inserted into bottom panel forming single paneled structure.

FIG. 57A is two FIG. 54A bottom panels with the clearance height of the first panel above the second panel.

FIG. 57B is the first FIG. 57A bottom panel with a top panel engaged.

FIG. 57C is the second bottom panel with a top panel engaged.

FIG. 57D is the first and second panels from FIG. 57D with additional clearance height to remove first top panel.

FIG. 58A is a top angled view of a square surface panel component with four partial threads.

FIG. 58B is a bottom angle view of a square panel component with one full thread from FIG. 54A.

FIG. 58C is the first layer of nine square panel components in a panel structure high lighting full Key threads formed by the partial Key threads at junctions of four square panel components.

FIG. 58D is the second layer from FIG. 58C of a panel structure also high lighting a full Key thread junction.

FIG. 59A is the cross-section view of a top Key thread engaged with the first a mating thread while positioned over a recessed Key thread.

FIG. 59B is FIG. 59A top Key thread engaging more with its mating Key thread.

FIG. 59C is the Top Key thread from FIG. 59A at the terminus of its mating Key thread leaving the recessed Key threads accessible.

FIG. 60A is a second top thread engaging the bottom recessed Key thread from FIG. 59C.

FIG. 60B is the additional engagement of the bottom recessed thread from FIG. 60A.

FIG. 60C is the terminus engagement of the bottom recessed Key thread with the second top Key thread.

FIG. 61 is a front view of a tube with two types of circular panel components in opposite directions.

FIG. 62. is a front view of a tube with straight circular panel components and pipe thread panel components.

FIG. 63 is examples of Geodesic Polyhedron from Wikipedia.

FIG. 64 is dome panels with boundaries base on a Geodesic structure.

FIG. 65 is a truss structure.

FIG. 66A is a side view of three Key threaded Web Beam components in position to receive its flange lock.

FIG. 66B is the Web Beam components from FIG. 66A with the Flange Lock one third engaged.

FIG. 66C is the Web Beam components from FIG. 66A with the Flange Lock two thirds engaged.

FIG. 66D is the Flange Lock fully engaged with three Web Beam components from FIG. 66A.

FIG. 67A is an angled view of a Web Beam components.

FIG. 67B is an angled view of three Web Beam components as shown in FIG. 66 A.

FIG. 67C is an angled view of Flange Lock component.

FIG. 68A is an angled view of FIG. 67BA of three Web Beams and Flange Lock on third engaged.

FIG. 68B is an angled view of FIG. 66D with full engagement of the Web Beams with a Flange Lock.

FIG. 69 are cross section shapes of various structural beams.

FIG. 70A is an angled view of a box with Key pods on its corners.

FIG. 70B is a front view of a Key pod.

FIG. 70C is an inside view of Key pods showing its conic or concave internal Key threads.

FIG. 70D is a design tool with a conic/concave Key threads and the Key pod shape added.

FIG. 70E is an angled view of a three sided pyramid with key pods on its corners.

FIG. 71A is side view of a keyed brick showing the profiles of the key threads on the top, bottom, open end and closed end.

FIG. 71B is an angled perspective top view of a keyed brick showing the two different axes of rotation on top and one axis on the open end.

FIG. 71C is an angled perspective bottom view of a key brick showing one axis shared with two bottom sets of key threads and one on the closed end.

FIG. 72A is top view of a reference keyed brick partially rotated into position.

FIG. 72B is a front view of a reference keyed brick fully rotated into positioned

FIG. 73A is a top view of a key threaded brick partially added to the open end of the reference brick.

FIG. 73B is a front view of a key threaded brick fully engaged with the open end of the reference brick.

FIG. 74A is a top view of a key threaded brick partially engaging the closed end key thread set of the reference brick.

FIG. 74B is the front view of a key threaded brick fully engaged with the closed end key thread set on the reference brick.

FIG. 75A is a top view of a key threaded brick partially engaging the opened end key thread set of the reference brick.

FIG. 75B is the front view of a key threaded brick fully engaged with the opened end key thread set on the reference brick.

FIG. 76A is top view of a keyed brick wall highlighting the curved shape of the keyed bricks.

FIG. 76B is a top view of a keyed brick wall with a sharper curve than FIG. 76A

FIG. 76C is a top view of a keyed brick wall with a larger off-center curve than FIG. 76A.

### DETAILED DESCRIPTION OF THE DRAWINGS

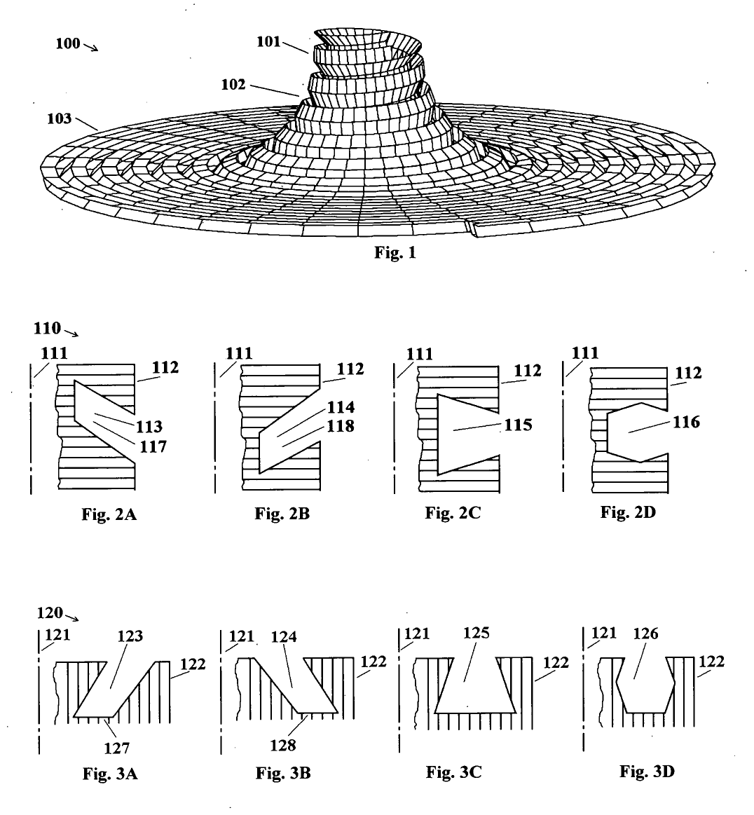

The Key thread is a broad concept as exemplified in FIG. 1. This is a test model of a Key thread 100 that started on a cylinder shape 101, changed to a concave shape 102 and ended on a disk shape 103. The disk 103 portion fastens laterally.

### I. Key Profile

The concept of the Key thread is a mating of Key and Lock profiles on a two-dimensional plane at their terminal position. The Lock envelopes the Key fully or partially with any shape or angle. Unlike any other fastener, the Key being enveloped by the Lock adds a range of mechanical properties.

FIG. 2 A-D are cross sections of Lock profile shapes 110 on a cylinder 112 relative to its axis 111. The upward 117 wedge shape 113 and downward 118 wedge 114 are the same at different angles. The dove tail 115 is a combination of two wedges. The bulb 116 is different.

FIG. 3 A-D are cross sections of Lock profiles shapes 120 as shown in FIGS. 2 A-D 113 114 115 116 except on a disk 122 relative to its axis 121. FIG. 3A shows a wedge shape 123 angled 127 towards the axis 121 while FIG. 3B is a similar wedge 124 but angled 128 away from the disk axis 121. These figures are more about using penetration at an angle then transiting. FIG. 3C is a dove tail 125 and FIG. 3D a bulb shape 126. They are more about transiting then penetration.

These cross-sectional shapes are the terminal shapes that a Key profile mates with. Multiple Key profiles have to transit, or transit and penetrate, through these Locks to reach their mating profile. These are but four examples of an enormous range of possible two-dimensional shapes that these profiles can be.

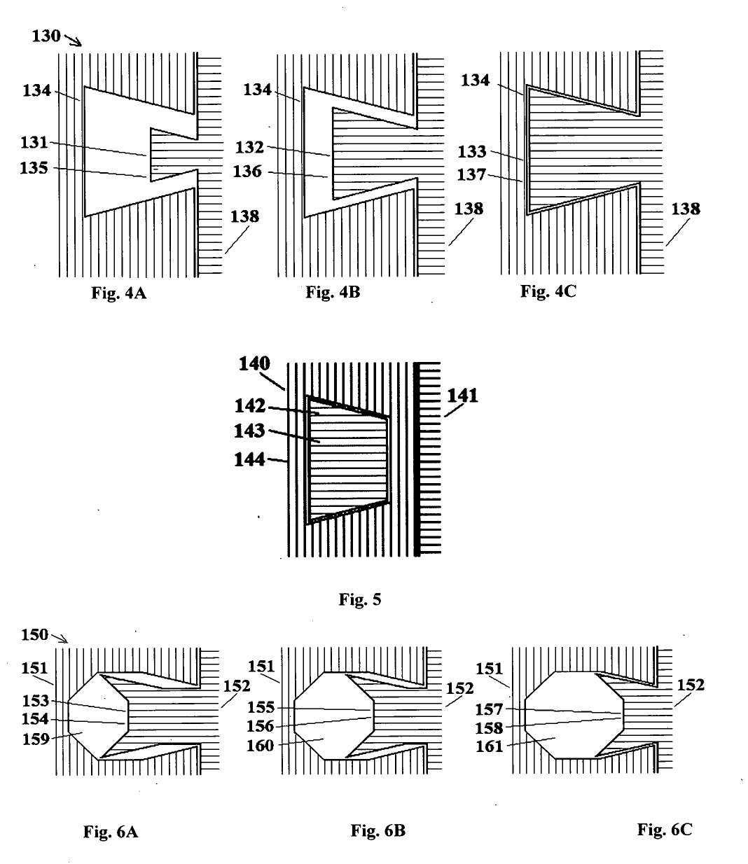

FIG. 4 A-C are an expansion of FIG. 2C with a cross section 130 of a dove tail Lock profile 134 with a progression of transiting Key profiles 131, 132, 133 on a part 138. FIG. 4A is the small Key profile 131 at position 135 in the Lock 134. FIG. 4B is the result of rotation of 138 to another larger Key 132 at position 136. It is still the same thread on part 138, but a slice of it at position 136. FIG. 4C is the terminal position 137 for Key 133. This shows how a Key profile changes in size en route to its terminus.

The Key can transit into the part 140 as shown in FIG. 5. The Key slice 142 is a continuation of the part 141 that is fully enveloped by the Lock 144 at position 143. This is a possibility, not a necessity.

The Key thread can be designed to create a space like a honey comb structure in the Lock where the Key closes the top. This is not for a traditional fastening, but is a unique application the Key thread has. This structural space will reduce weight, increase strength and add flexibility to its application.

This is demonstrated in FIGS. 6A-C 150 showing a cross section of a Lock 151 that has extra space. This starts in FIG. 6A with the initial slice 153 of the Key 152 penetrating into the Lock 151 at position 154. There is an initial cavity 159. FIG. 613 shows the midway Key slice 155 at position 156. The cavity 160 has increased in size. FIG. 6C shows the Key 157 at its terminal position 158 with the full cavity 161. This is how a structure similar to a honey comb can be added to a Key thread.

The shape of the profiles determines their fastening characteristics. A directional shape like a wedge is easier to use for penetration and directs resistance more in one direction. An omnidirectional shape like a bulb or dove tail is more suited for transit only. It distributes mechanical stresses.

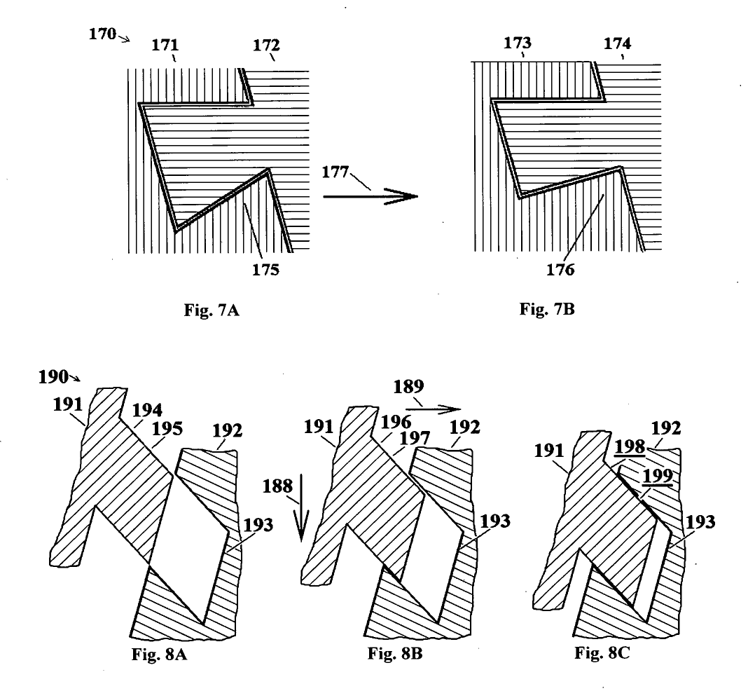

FIG. 7 A-B are two slightly different dove tail shapes 170. FIG. 7A has a Lock 171 and Key 172. FIG. 7B has a Lock 173 and Key 174. FIG. 7A Key 172 is at a sharper angle 175 than the similar angle 176 on the FIG. 7B Key 174. The effect of this is that the sharper angle 175 will be more resistant to the directional stresses in the direction 177. Different profile shapes will affect the amount and direction of resistance to mechanical stresses.

The Key thread has complex motions for any shape that is not a cylinder or disk. That is the cone, concave and convex shapes. The first positions in FIGS. 8A-C 190, 9A-C will be with the Key angled downwards. The second positions will be FIGS. 10 A-C 200, 11 A-C 230 with the Key angled upwards while the thread is screwing downwards.

It is important to note that the downward motion of the thread is locked into the rate of change with the penetration into the Lock.

The FIGS. 8 A-C 190 is a cross section of a wedge-shaped Key angled downwards relative to the thread that is screwing downwards into a Lock. FIG. 8A shows on part 191 a Key 194 that is positioned 195 in front of a Lock 193 on part 192. Note that Lock 193 is not at the beginning of the part 192. That would be further up the part 192. FIG. 8B has a different Key slice 196 that has penetrated the same Lock 193 at a different position 197. The Key slice 196 represents a downward axial movement 188 relative to the Lock 193 and a lateral movement 189 into the Lock 193. These movements are aligned and synchronized. FIG. 8C shows a further example of FIG. 8B with on the part 192 with a different Key slice 198 positioned 199 deeper into the Lock 193.

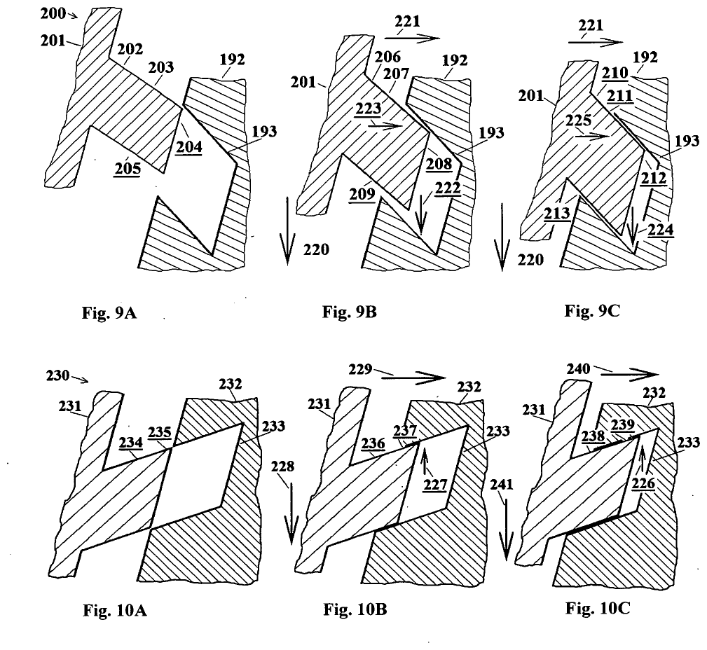

FIG. 9 A-C 200 is similar to FIG. 8 A-C 190 but shows how the lateral and axial movements can start with different rates as long as they both end simultaneously at their terminus. This will use the same cross sectioned Lock 193 on part 192 that was used in FIGS. 8 A-C 190 only with different cross sectioned Keys on the Key part 201. FIG. 9A shows the part 201 with the Key slice 202 at a starting position 203 to penetrate the Lock 193. The Key slice 202 is angled 205 and extended 204 relative to the Lock 193 such that there is room for the unaligned movement.

FIG. 9B shows the new Key slice 206 positioned 207 just inside of the Lock 193. Its length 208 is shorter than 204 the Key 202 in FIG. 9A and its angle 209 is sharper than FIG. 9A 205. FIG. 9C demonstrates more changes with Key slice 210 almost at its terminal position 211 with a shorter length 212 and shallower angle 213 then in FIG. 9B. These changes in angles and lengths are examples of the design tools used to design how stress is distributed, and employ in unique environs or artist creation.

The movement of the Key part 201 downwards 220 and laterally 221 into the Lock part 192 is similar to FIGS. 8 A-C. What is different is that the Key slices each have a relative different rate of change. The difference between FIGS. 9A and 9B is that the angle 209 is at a faster downward rate 222 than the angle 205 which is faster than the Key part 201 rate 220. The lateral rate of penetration 223 of slice 206 is slower than the Key part 221 rate because the Key slice 206 is shorter than 202. These changes continue in FIG. 9C with Key slice 210 positioned 211 at a sharper angle 213 and with an even shorter length 212. The downward rate 220 of the Key part 201 is slower than the Key slice 210 rate 224. The lateral rate Key part 201 rate 221 is faster then the Key slice 201 rate 225 because it is becoming shorter.

FIG. 10 A-C 230 is in the opposite angle from FIGS. 8 and 9. FIG. 10A has a part 231 with a Key slice 234 at the starting position 235 to penetrate the Lock 233 on the Lock part 232. FIG. 10B has the Key slice 236 positioned 237 just inside the Lock 233. The Key part 231 has moved laterally 229 while it is moving downwards 228. The end of Key slice 236 has moved upwards 227. FIG. 10C is the slice 238 key part 231 further penetrating 239 the lock 233 in part 232. The key if moving upward 226 while the key part 231 is moving downwards 241 and lateral 240. This is relevant to the design of stress distribution.

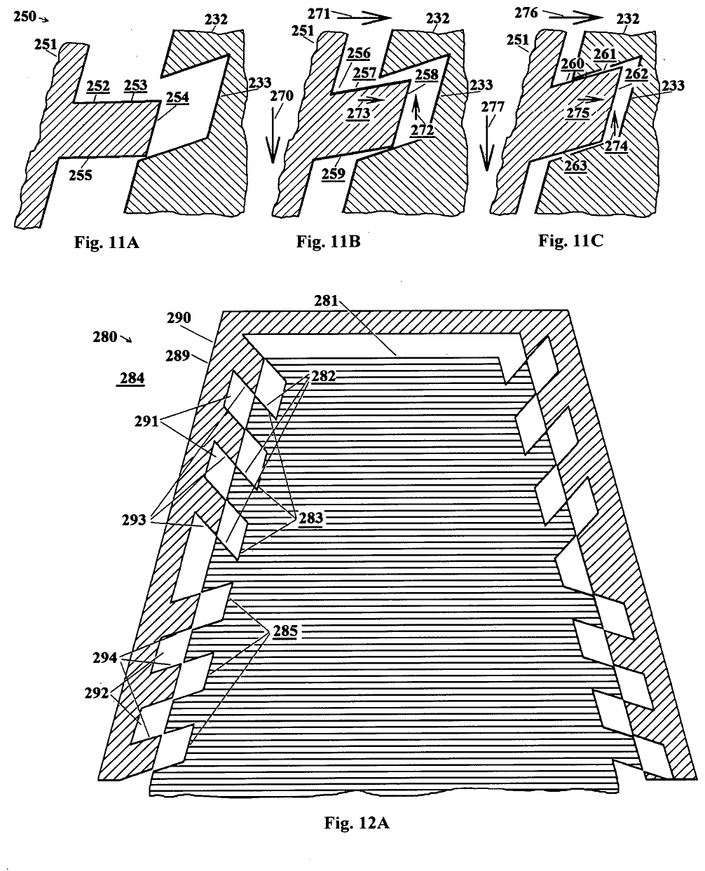

FIG. 11 A-C 250 is a demonstration of changing lengths and angles similar to FIG. 9 A-C. Using the same slice of Lock part 232 and Lock 233 from FIG. 10 A-C., FIG. 11A has the Key slice 252 on the Key part 251 at an angle 255 initially penetrating 253 into the Lock 233 at a given length 254. FIG. 11B shows the result of the part 251 in rotation with a new Key slice 256 and position 257 and a shorter length 258. The angle 259 in FIG. 11B is steeper than the angle 255 in FIG. 11A. FIG. 11C has an even sharper angle 263 and shorter length 262 that are approaching the shape of the Lock 233. The Key 260 on the part 251 is positioned 261 close to the terminus.

FIG. 11 A-C 250 has different rates of change. The rotation of the Key part 251 is moving through different Key slices 252, 256, 260. This results in a lateral direction 271 into the Lock part 232 and downward 270 relative to the Lock part 232. In FIG. 11B the Key 256 is positioned 257 higher relative to the starting position 253 of Key 252 in FIG. 11A with an upward 272 movement. The changing length 258 of that Key slows 273 its lateral movement into Lock 233. FIG. 11C has further upward movement 274 because of the steeper angle 263. It has less lateral movement 275 with a shorter 262 Key 260. The net effect is more lateral movement 276 into the Lock and downward 277 relative to the Lock part 232. These are design functions.

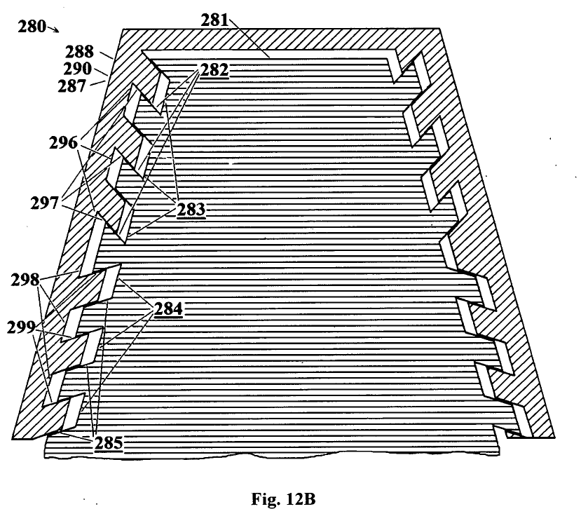

FIGS. 12A-B are two combinations 280 of Lock and Key profiles. The top and bottom have opposite angles. Also, the Lock and Key profiles are zipped together. The sides of the Keys are the spaces for the Locks; and the solid sides of the Locks are Keys. Like a zipper except they are rotated into place. These are the most efficient type of Lock and Key design. There are other profiles that can be zipped.

One way to keep a nut and bolt from self-loosening is to tighten a second nut down on the first nut. This is called jamming and it compresses the two nuts together. The use of Key threads in opposite directions has one set of Key threads angled upwards and the other set angled down. Tightening the male and female parts has a transit and penetration action that compresses the connection. This is called a Keynection. This works if the Key threads are on a cone, disk or any curve in between. It will not work on a cylinder because there is no penetration, only transit.

The Keynection 280 example in FIG. 12A has a cross section of a cap 290 with Keys 293 294 at the position 289 with the corresponding cross section of the bolt 281 with Locks 283 285. These are zipped Lock and Keys so the cap 290 has Locks 291 292 that mate with Keys 282 284 on the bolt 281.

FIG. 12B 280 has the same bolt 281 but the cap 290 has rotated to a different position 288. That is showing a different cross section 287 of the cap 290. At that position 291, the Keys 297 299 have penetrated the Locks 283 284. The zipped Locks 296 298 on the cap 290 were penetrated by the bolt Keys 282 285 at the same rate.

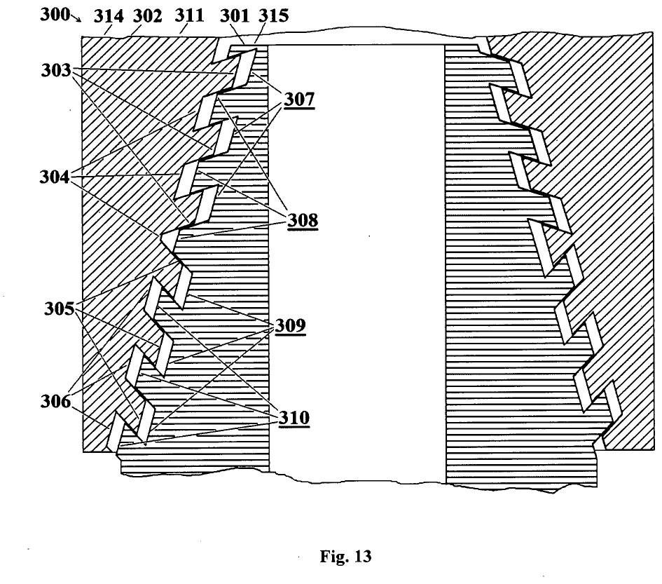

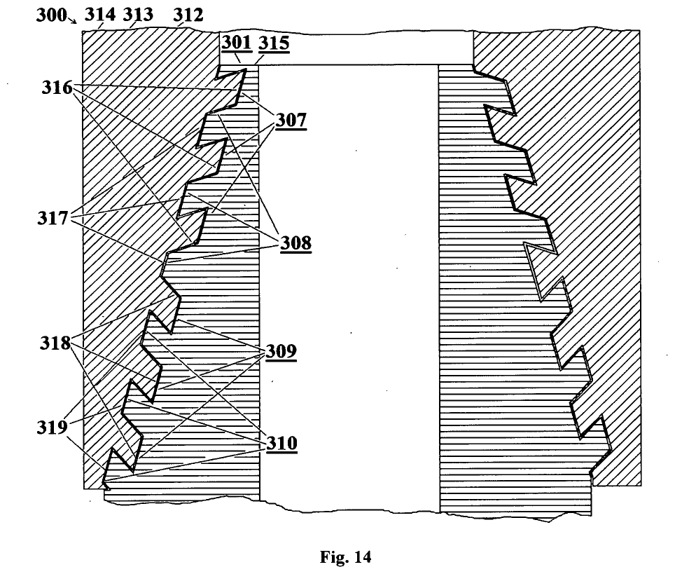

FIG. 13 is a slice of a Keynection tube connection with keys and locks 300 angled in the opposite direction of FIG. 12 A-B 280. FIG. 13 has the female part 314 with the slice 302 at position 311 that has Locks 304 306 and Keys 303 305. The male tube part 315 with slice 301 in FIG. 13 has Locks 307 309 and Keys 309 310. The female slice 302 is partially positioned 311 in the male slice 301. In FIG. 14 the female part 314 is rotated into its terminus 312 position shown in slice 313. The terminus new slice 313 has different Locks 317 319 and Keys 316 318 profiles fully engaged with the male 315 slice 301 Locks 307 309 and Keys 309 310 from FIG. 13.

### II. Key Rail

The Key Rails were originally based on the conic thread as shown in a page from the American Fastener Journal, September/October issue article “Conic Thread Geometry 3.5”. The Conic thread is a way to position any standard thread profile to achieve total surface contact minus tolerances. The “FIG. 5” shows the cone with a helix wrapped around it where a perpendicular line 12 to the tangent at p is created. “FIG. 6” shows the same cone populated with perpendicular lines 12. And “FIG. 7” has the perpendicular lines replaced with v-shaped thread profiles. “FIG. 8” is the 90-degree extent of the of the conic thread concept on a disk. This was for show. There are no standard thread profiles that fasten disks together. The smaller the cone angle, the better.

The Key Rails are similar to the Conic thread helix. Their biggest difference is the that conic thread resists the linear tensile load on the thread axis while the key thread resists mechanical stresses spherically. Also, the conic thread cone angle should be as small as possible. The standard thread profiles were developed to be efficient at a 0-degree cone angle and become weaker as this angle increases. The Conic thread requires some angle in order to fully engage.

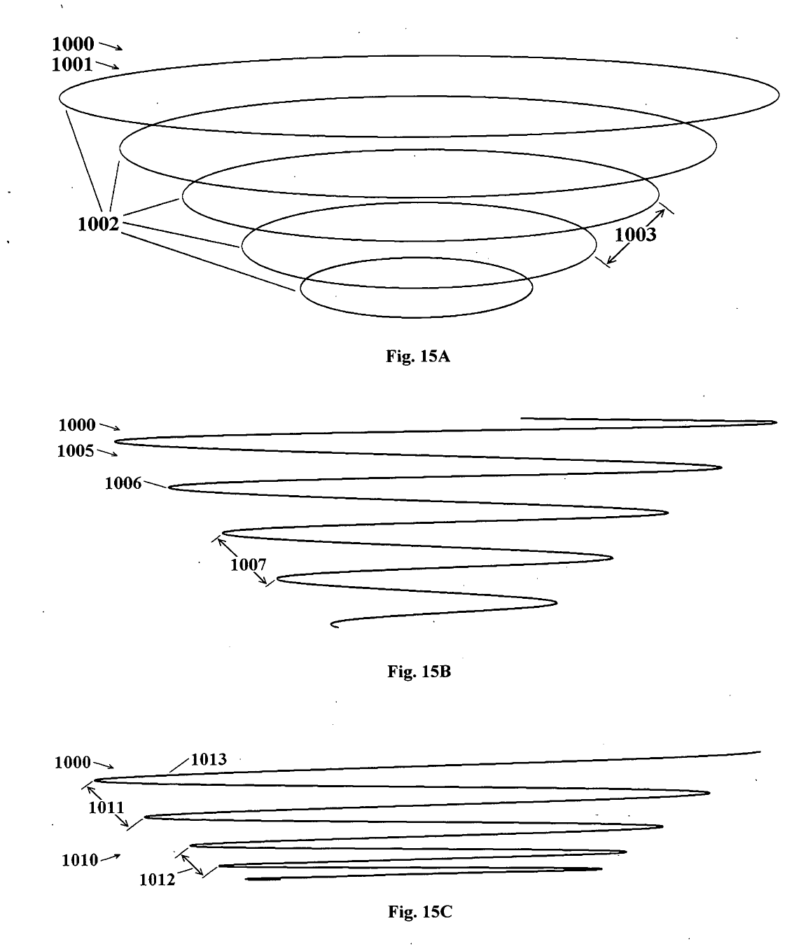

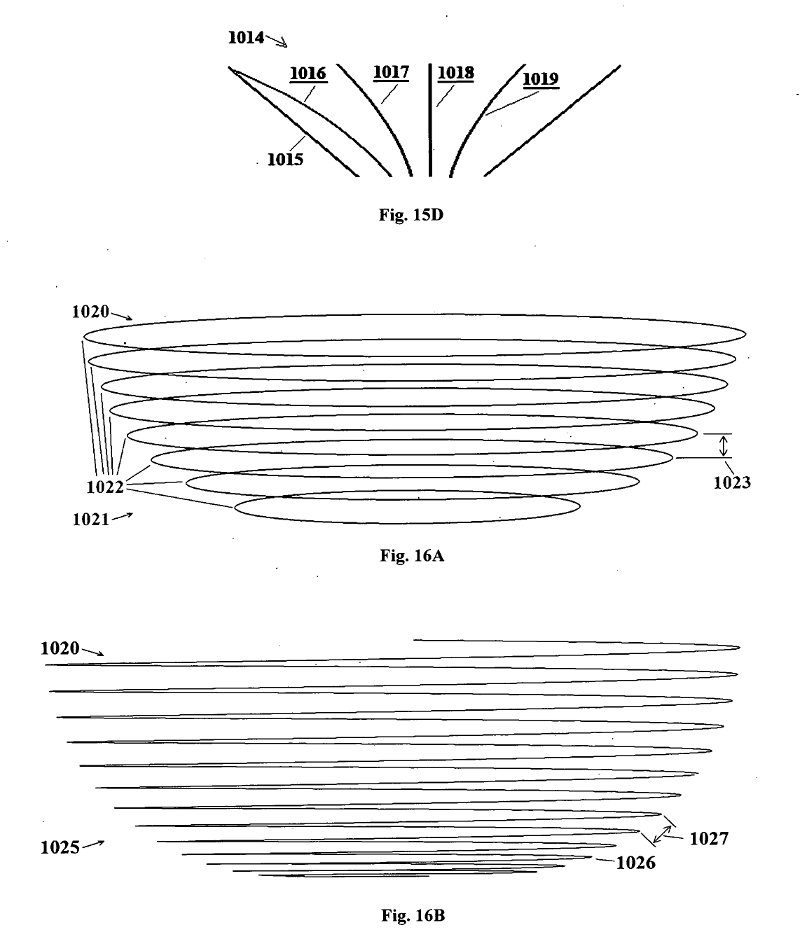

The Key Rail will be demonstrated on a cone, concave, convex, cylinder, disk and other shapes. The FIGS. 15 A-C are the conic shape 1000 with the key expressed in stacks of circles 1001, in a constant spiral 1005, and in an expanding spiral 1010. The FIG. 15 A 1001 stack of circles 1002 shows the distance between the circles 1003 as constant, but this can be any distance. FIG. 15 B 1005 is a constant spiral 1006 with an equal distance 1007. FIG. 15 C 1010 is a single expanding spiral 1013 where the smaller distances 1012 pass through the larger ones 1011.

FIG. 15 D is a cone 1015 with examples of expanding spirals 1014. These exemplify different rates of change between the rotation and the increase in Z height. FIG. 15 A did not have any increase in Z resulting in circles. The first Key Rail 1016 on the left in Fig. D did not rotate around the cone because its rate of change increased its Z value faster reaching the top with a small rotation. The next Key Rail 1017 demonstrates an even faster change in z. The straight Key Rail 1018 has zero-rotation following the cone 1015 shape. The last Key Rail 1019 has a negative rotation per change in Z height.

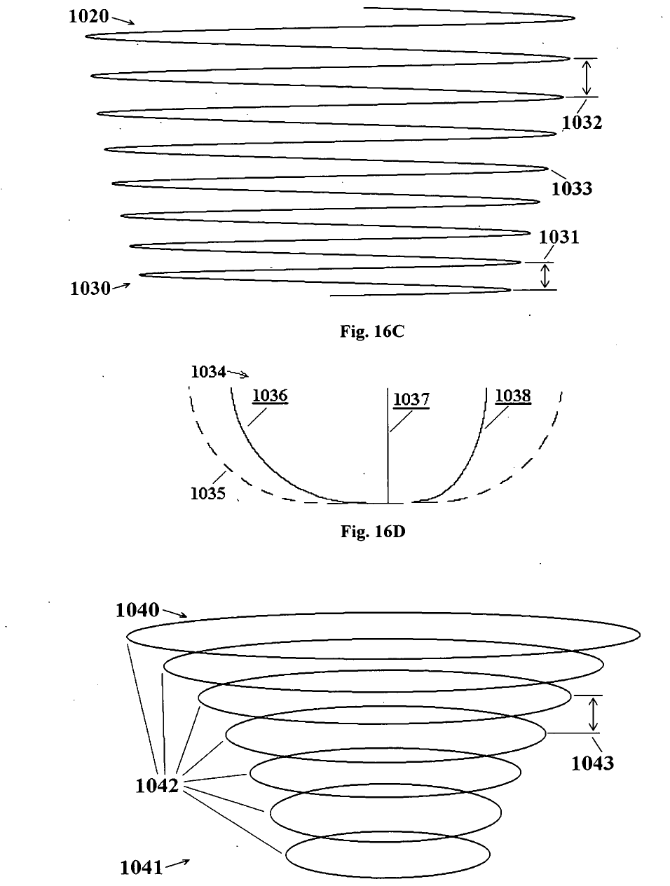

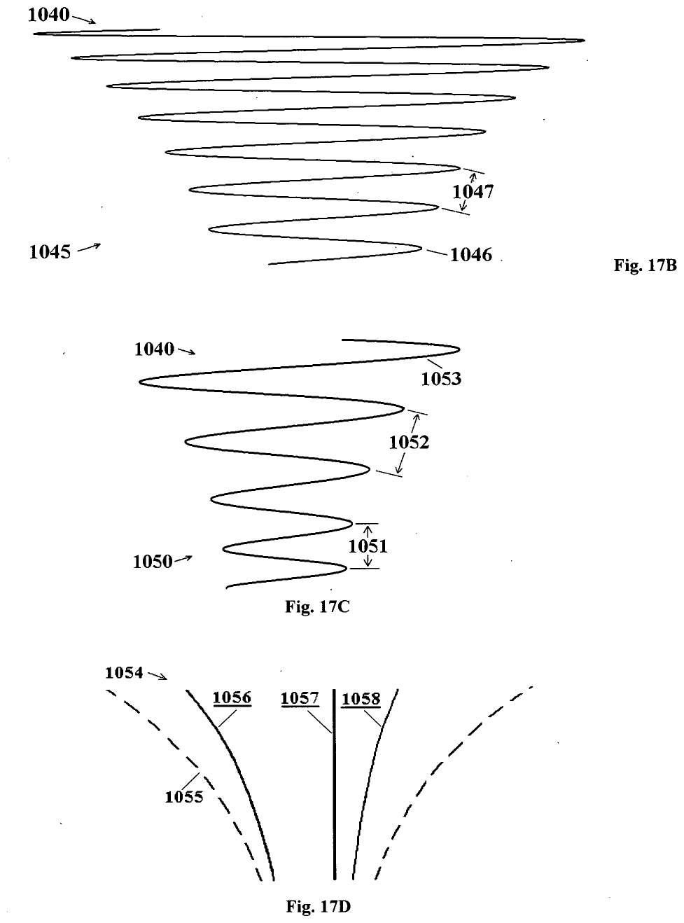

One reoccurring issue with all four Van Cor Threads is with the concave and convex shapes such as FIGS. 16 A-C and FIGS. 17 A-C. The internal female thread always determines the fabrication limitation, and so is used as the basis of the thread design. The problem lies in that the female concave shape renders a convex external male shape. Furthermore, it is the male shape the is used to identify the thread. This will not be changed. Those engineering these threads will understand this.

FIGS. 16 A-C are the concave shapes 1020: with FIG. 16 A the stack of circles 1021; FIG. 16 B being a constant spiral 1025; and FIG. 16 C, an expanding spiral 1030. The stack of circles 1022 in 16 A 1021 are at a constant height 1023, but they do not have to be. Each circle 1022 is independent and is limited by the interference of its key threads. The single constant spiral 1026 in FIG. 16 B 1025 holds a constant distance between rotations of the concave shape 1020. The expanding spiral 1033 in FIG. 16 C 1030 is increasing its distance between the helix's, as shown between the lower width 1031 and the upper width 1032. While much of the thread will insert into the concave 1020 shape before contact, once the threads engage, the smaller threads 1031 have to transit through the larger threads 1032 that will be based on this Key Rail 1030.

FIG. 16 D has the spiral threads at different rates of change 1034 on a concave shape 1035. The first lines 1036 Z height is increasing faster than its rotation. The middle line 1037 is increasing its Z with zero rotation and the ending line 1038 is increasing its Z at a negative rotation.

FIGS. 17 A-C are the convex shape 1040: with FIG. 17 A being the stack of circles 1041; FIG. 17 B being a constant spiral 1045; and FIG. 17 C, an expanding spiral 1050. Understand, the convex is the internal female shape. FIG. 17 A has circles 1042 stacked 1041 such that they form the convex shape 1040 with an even distance 1043 between them. FIG. 17 B has a spiral 1046 that is at a constant width 1047. FIG. 17 C has an expanding spiral 1053 as shown with the lower width 1051 smaller then the upper width 1052.

FIG. 17 D is the convex shape 1055 with different rates of change 1054. The first line 1056 has its Z height rate of increase faster than its degrees of rotation. The middle line 1057 is straight following the shape with a Z height at zero degrees of rotation. And the last line 1058 rate of change has a negative rotation per Z height.

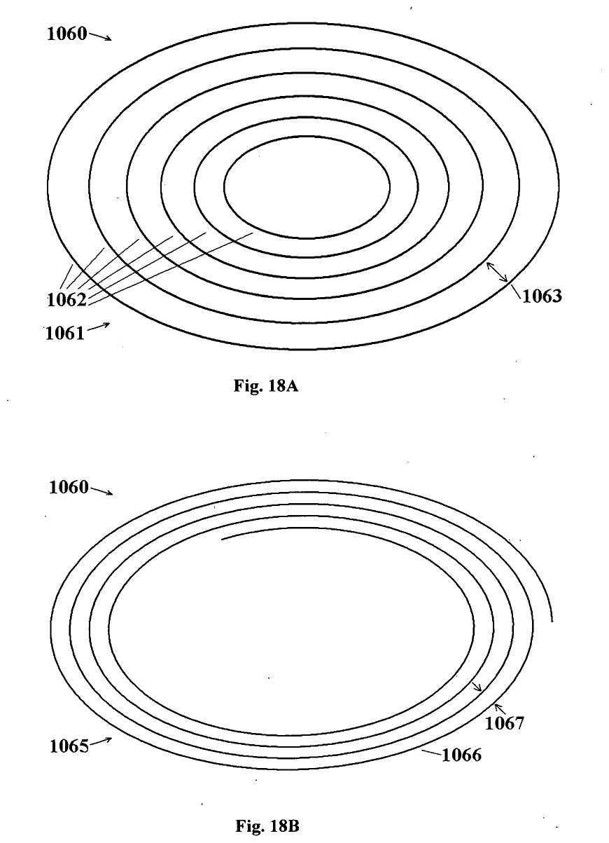

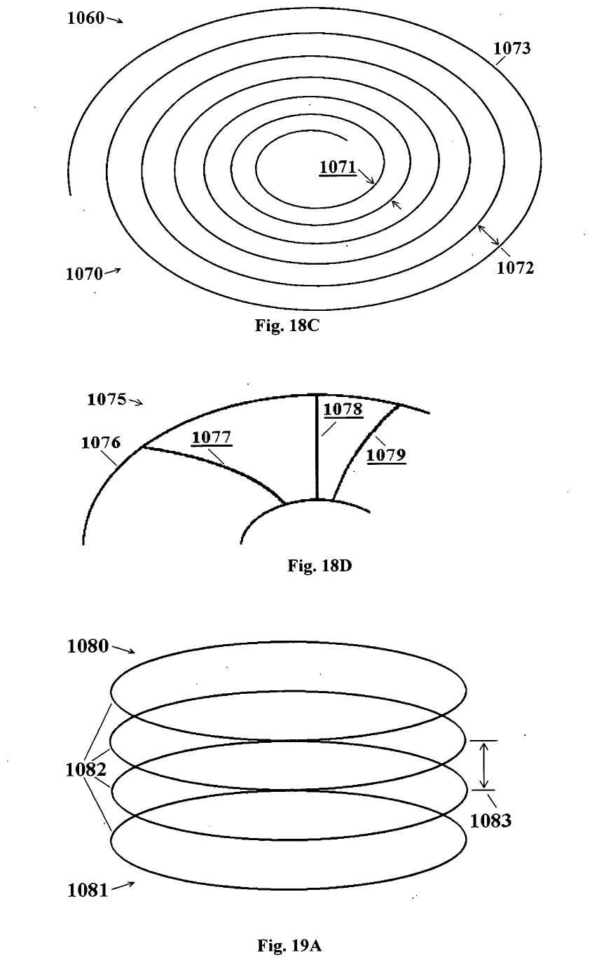

FIGS. 18 A-C are a disk shape 1060 viewed from an angle. FIG. 18 A is collection of concentric circles 1061, FIG. 18 B a constant spiral 1065 and FIG. 18 C, an expanding spiral 1070. The circles 1062 in FIG. 18 A are each at a constant distance 1063. FIG. 18 B is a constant spiral 1065, with the spiral 1066 maintaining a fixed distance 1067. FIG. 18 C is an expanding spiral 1070 with spiral 1073 increasing its distance as seen comparing the beginning 1071 with the end 1072.

FIG. 18 D shows different rates of expanding spirals 1075 on a disk 1076. The first 1077 is expanding its Z length faster than its rotation. The middle line 1078 is expanding at zero degrees of rotation and the last line 1079 is expanding at a negative degree of rotation.

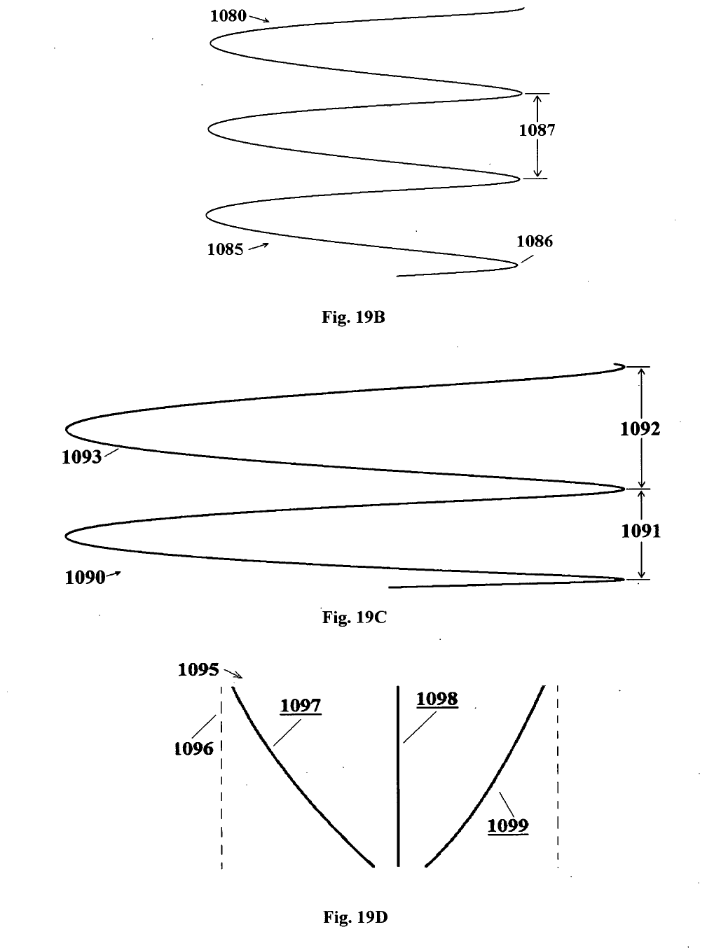

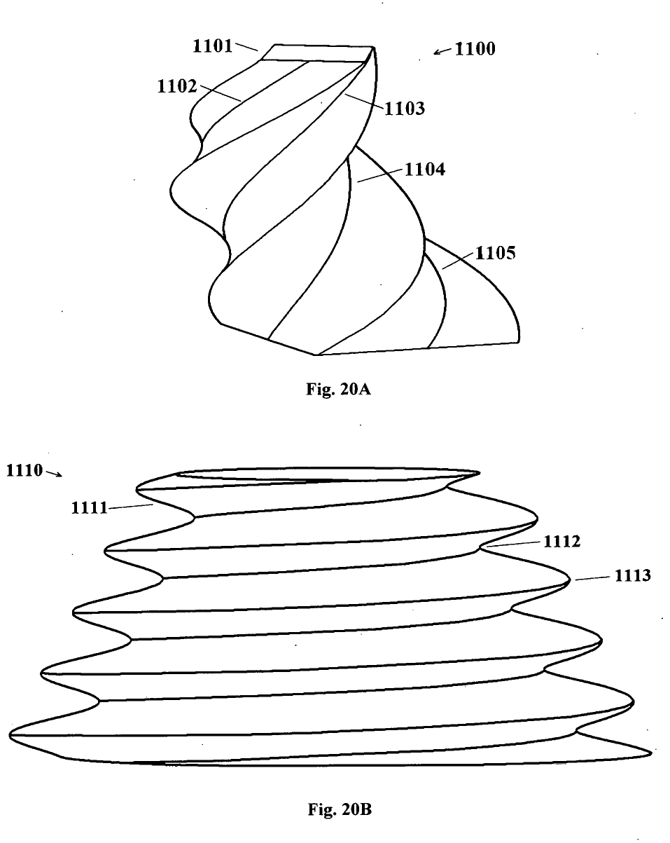

FIGS. 19 A-C are a cylinder shape 1080 with FIG. 19 A a stack of circles 1081, FIG. 19 B a constant spiral 1085 and FIG. 19 C, an expanding spiral 1090. The stack of circles if FIG. 19 A 1082 is only in theory, in practice these will be partial circles because the cylinder shape can only have transit, no penetration. For transit only, the circular arc has to be aligned and then rotated with a maximum of 180 degrees or half a circle. FIG. 19 B has a constant spiral 1085 with the spiral 1086 maintaining an equal distance 1087. FIG. 19 C has an expanding spiral 1090 showing the spiral 1093 at different widths 1091 1092.

FIG. 19 D is the cylinder shape 1096 with Key Rails of expanding spirals 1095. The first Key Rail 1097 is expanding its Z height faster than its rotation. The middle line is expanding its height while its rotation is zero. The last Key Rail 1099 is expanding its Z height while its rotation is negative.

The Key Rails can follow any type of threaded surface such as the Concentric threaded part 1100 in FIG. 20 A and the Wave threaded part 1110 in FIG. 20 B. FIG. 20 A has a Concentric thread 1110, and is rotating on three axis which allows it to screw around a 70-degree corner. The Key Rails 1102 1103 1104 1105 are shown as being on that three axes surface. In practice they demonstrate that three or more axis of rotation can be used to create one or more Key Rails. FIG. 20 B has a wave thread 1111 geometric surface showing the position of two Key Rails at the root 1112 and crest 1113. The inside Key Rail will lend itself to a Lock profile while the outside Key Rail 1113 will be a key profile. These Key Rails can represent a center point in the Lock key terminus as long as it does so for the whole thread.

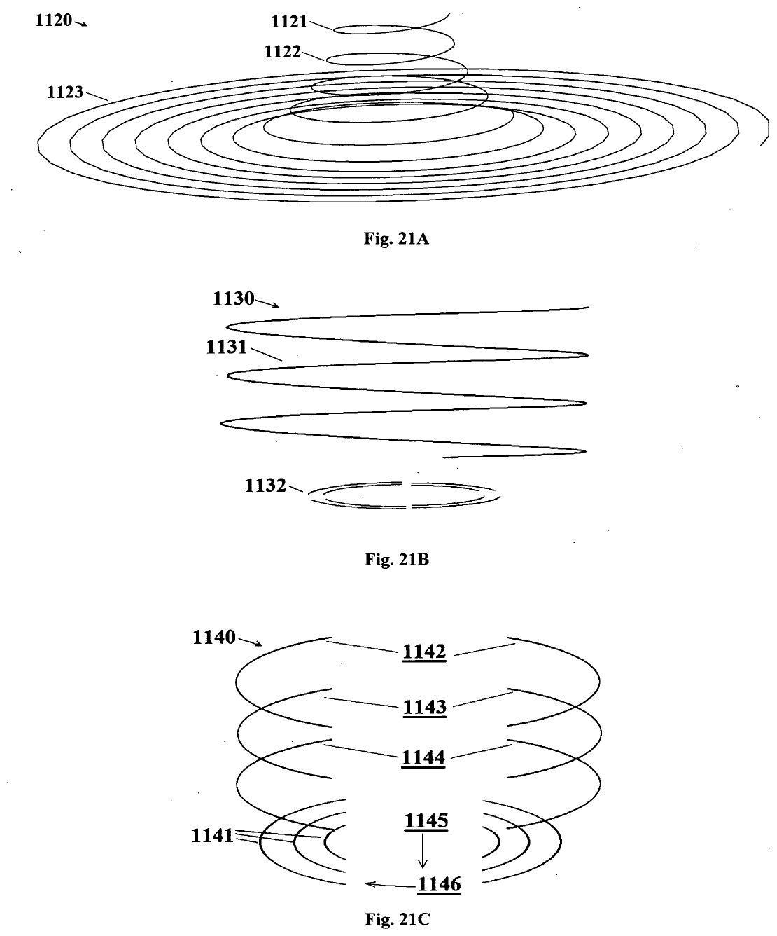

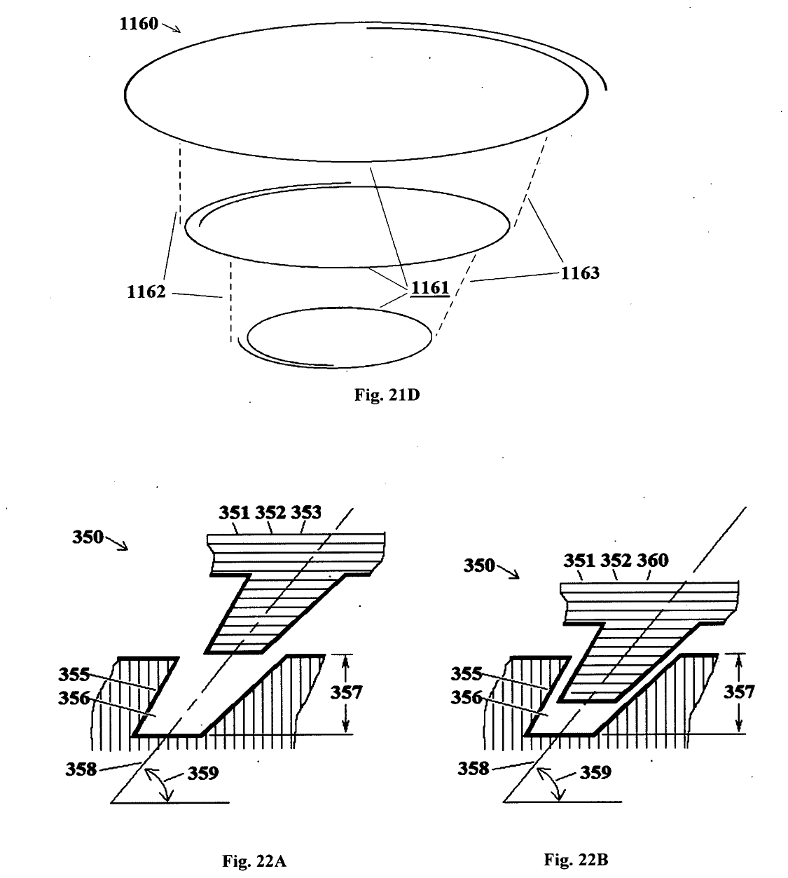

These Key Rails can be grouped in a continuous line or in partial lines on the same part. FIG. 21 A 1120 is the Key Rail from part 100 in FIG. 1 that starts as a cylinder 1121, morphs into a convex 1122 (female) surface shape and ends as a disk 1123. FIG. 21 B 1130 has a cylinder with a constant spiral 1131 and the 8 partial Key Rails that are constant spirals 1132 on a disk. These disk Key Rails demonstrate a short rotation with a fast insert. FIG. 21 C 1140 has pairs of partial cylinder circle 1142 1143 1144 Key Rails, and partial disk circle 1141 Key Rails that are oriented for a 90-degree rotation transit-only connection. The mating part for these Key Rails will be positioned downward 1145 into the blank area and transited 1146 through both sets of circular threads.

FIG. 21 D 1160 has disk circles 1161 of increasing sizes demonstrating that they can be part of a multi-cone 1163 shape or a concentric stack of cylinders 1162. The rule of the multiple Key Rails is that they have the same rate of change as a unit.

The Key Rail is a special entity from which the key thread profiles will be hung perpendicular to their point on the Key Rail. The Key Rail determines the passage and rate of change for the Key thread train through the profile Locks, which is the combined rotation and insertion to the terminus.

### III. Key Thread Train

A key thread train represents all the key/Lock profiles that pass through a stationary key train of the corresponding Lock/Key profiles en route to engage all their termini at the same time. The thread train follows the Key Rail in a circle, a constant spiral or an accelerating spiral. Technically, the circle is in concept only. The profiles have to change, thus netting a spiral motion, although it will be small. The thread train can be around a cylinder, cone, concave, convex, disk or a combination of these and other shapes.

The disk and cylinder can have a circular train; all others are a spiral train. The cylinder is transit only. The disk can be either transit or transit and penetration. Of the shapes, the disk has the most penetration relative to transit.

The circular train on a disk needs a landing. This is a disconnected area that is used for the initial position of the Key threads. From there they transit to their terminus. These can be combined.

The spiral train on a disk does not need a landing, it penetrates while engaging. It can be the most efficient disk because it has the maximum amount of thread connection.

The central aspect of a spiral train is that it penetrates while it transits. That means the rate of insertion to depth is relative to the transit rate of rotation.

### Disk Spiral Train

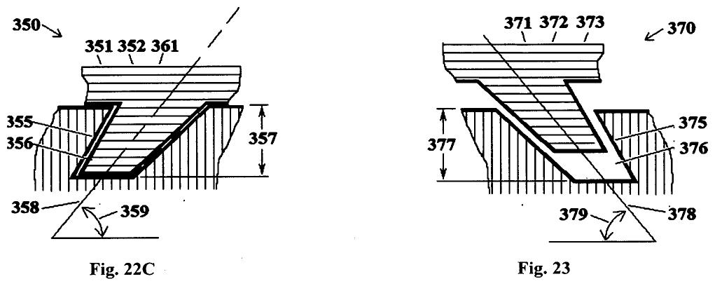

FIGS. 22 A-C demonstrate 350 this penetration. It is based on a test part of an acme thread style profile rotated into a forward Key thread profile. These are zipped threads where the Keys sides create the Lock cavities. In FIG. 22 A the top thread 351 has a Key 352 at the entry position 353 of the bottom thread 355 Lock 356 cavity. There is a penetration reference line 358 at an angle of 39.1 degrees 359 for the depth of 0.10″ 357. The net thread lateral movement is 0.0813″. The width of the thread is 0.2309″ so the insertion is complete at 35.2% or 126.7-degrees of rotation of the test model.

FIGS. 22 B and C are the rest of the top Key thread 352 penetrating the bottom Lock 355 at positions 360 and terminus 361.

FIG. 23 is the mirror image 370 of FIG. 22 B. It has a top thread 371 with a Key profile 372 positioned 373 halfway into a Lock 376 in a bottom thread 375. The Lock and Key have a common axis 378 at an angle of −39.1 degrees. The complete depth 377 of the Lock 376 is 0.10″. Like FIG. 22 350 it will also take 126.7-degrees of rotation to insert the Key 372 into the Lock 376.

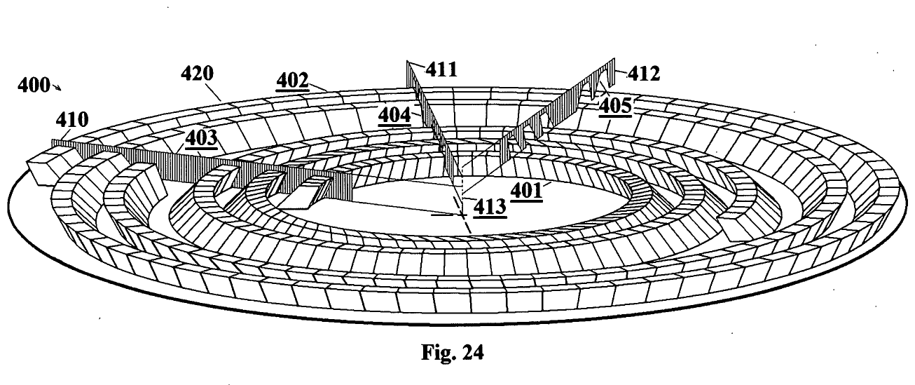

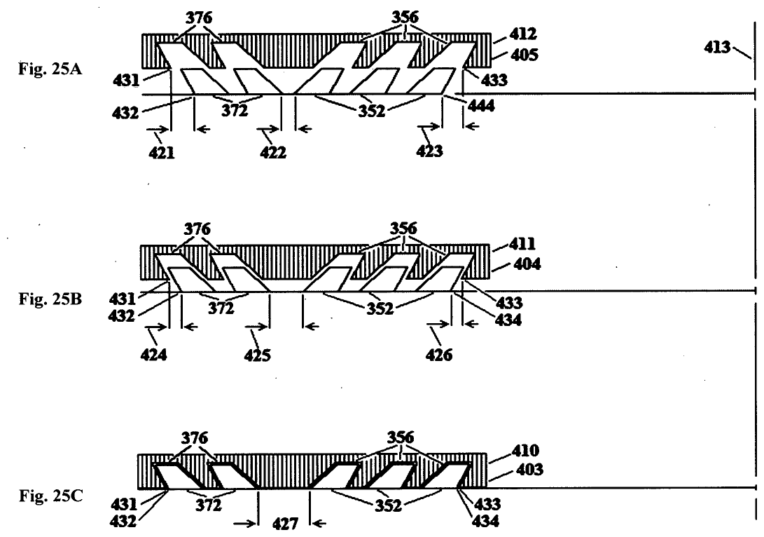

FIGS. 22 A-C and FIG. 23 can be on the same part called a Keynection 400, shown in FIG. 24. It has a disk 408 with a forward Key thread 401 from FIG. 22 and a backward 370 Key thread 402 from FIG. 23. It is difficult to show a mating thread, so slices 410 411 412 relative to the center axis 413 is shown at positions 403, 404 and 405. FIGS. 25 A-C will show the differences between these positions. What is important to understand is that the forward 350 thread 401 migrates towards the axis 413, while the backward 370 thread 402 moves away from the axis 407. It screws on in opposite directions at the same time.

Starting in FIG. 25 A slice 412 at position 405 that corresponds to FIG. 24 has its forward Locks 376 positioned over Keys 372. The forward Locks 376 have a terminus reference point 431 and its mating forward Keys 372 have a reference point 432. The starting distance between them is 421. The backward Locks 356 and Keys 352 have their corresponding terminus reference point 433 for the Keys 352 and 434 for the Locks 356. Their starting distance 423 is the same as the forward starting distance 421 and these will decrease. The starting distance 422 between the forward Keys 372 and backward Keys 356 will increase.

FIG. 25 B shows the slice 411 has moved to position 404 relative to FIG. 24. This represents a rotation of the top thread. It is not shown what the slice represents. The effect is to move the Keys 372, 352 half way into the Locks 376 356. The difference between the forward terminus points 431 432 is that it has decreased 424. It is the same as with the backward terminus points 433 434 that have decreased. The distance between the Keys 372 352 has increased 425 by the amount that the terminus lengths 424 426 have decreased.

FIG. 25 C has the slice 410 at its terminus 403 relative to FIG. 24. The Keys 372 352 are in their Locks 376 356. The forward terminus points 431 432 are adjacent, as are the backward terminus points 433 434. The distance 427 between the forward Keys 372 and backward Keys 352 is equal to the previous distance 425 plus the previous terminus lengths 424 426.

### Disk Circular Train

The unique aspect of a circular train is that it is all transit and no penetration. The thread has to change its shape and/or size such that all surfaces engage at the same time. That requires the male and female threaded parts to be in an aligned position called a landing area and from there they are rotated into their terminus. There are two ways this can be done, either with a partial thread or a split profile thread. The partial thread has half of its circular space as the landing area and half the transit thread. The split profile thread is a combination of a landing area with part of two Key thread profiles.

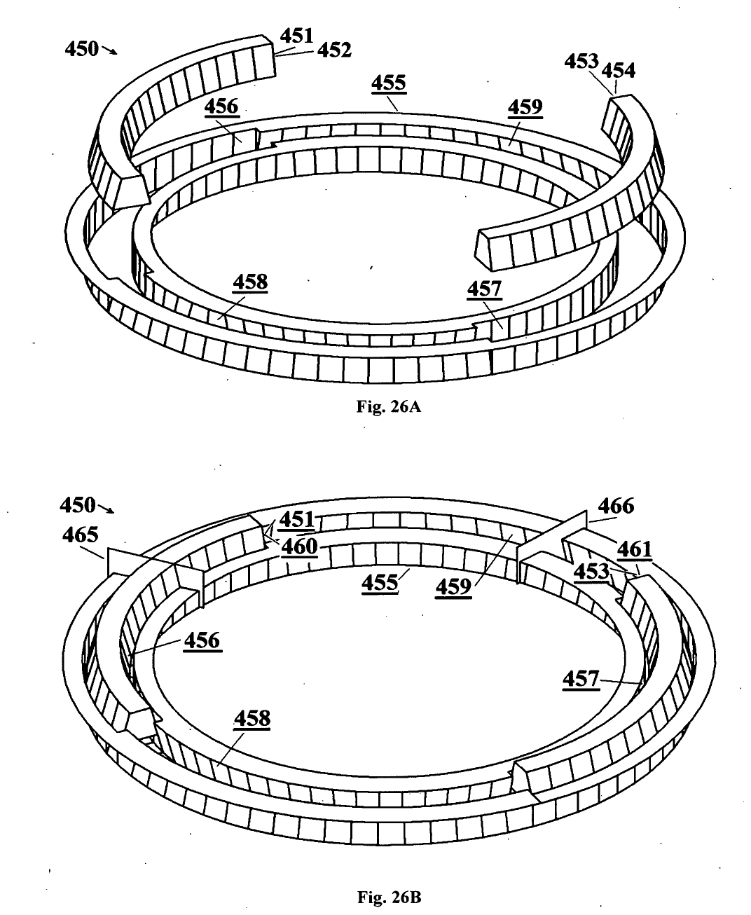

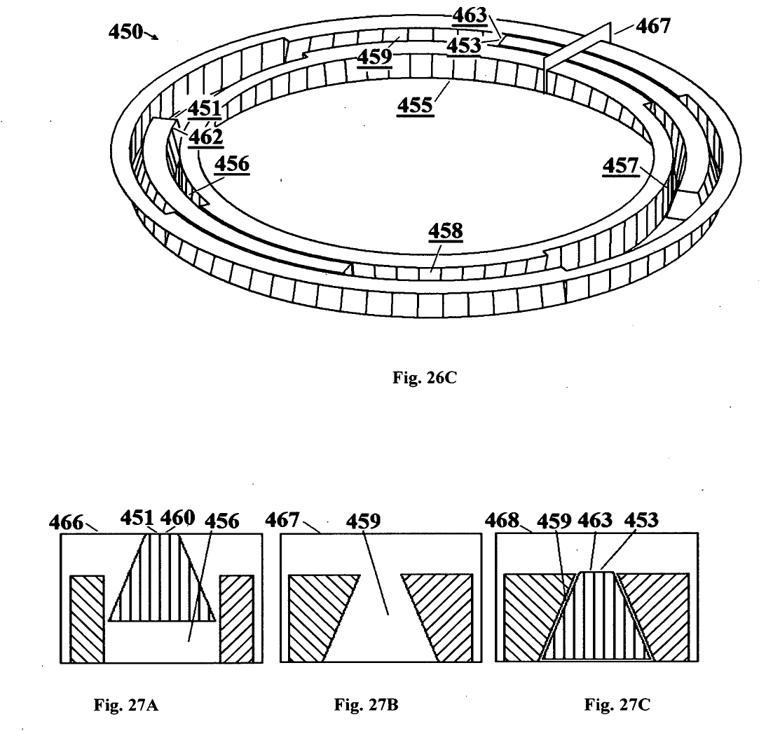

A partial thread 450 in two sections is demonstrated in FIG. 26 A. The two floating 452 454 parts 451 453 represent the Key profile of a partial thread. Normally they 451 453 would be attached a corresponding surface, but it is easier to demonstrate how they connect by showing the movement of the connecting Keys 451 453. The lower disk 455 has the landing area 456 457 and the partial thread Locks 458 459. The landing area is where those floating 452 454 Keys 451 453 are partially inserted 460 461 as shown in FIG. 26 B. In FIG. 26 C the Keys 451 453 have transited half way 464 465 from the landing area 456 457 into the Locks 458 459.

Cross sections 466 467 468 in FIGS. 27A-C are slices taken from FIGS. 26 B and 26 C. The first slice in FIG. 27 A 465 is the Key 451 half way inserted 460 into the landing area 456, from FIG. 26 B. The second slice in FIG. 27 B 466 shows the Lock 459, also from FIG. 26 B. The third slice 467 in FIG. 27 C demonstrates the Key 463 in 463 the Lock 459 from FIG. 26 C. This shows the process of insertion 465 to transition 467.

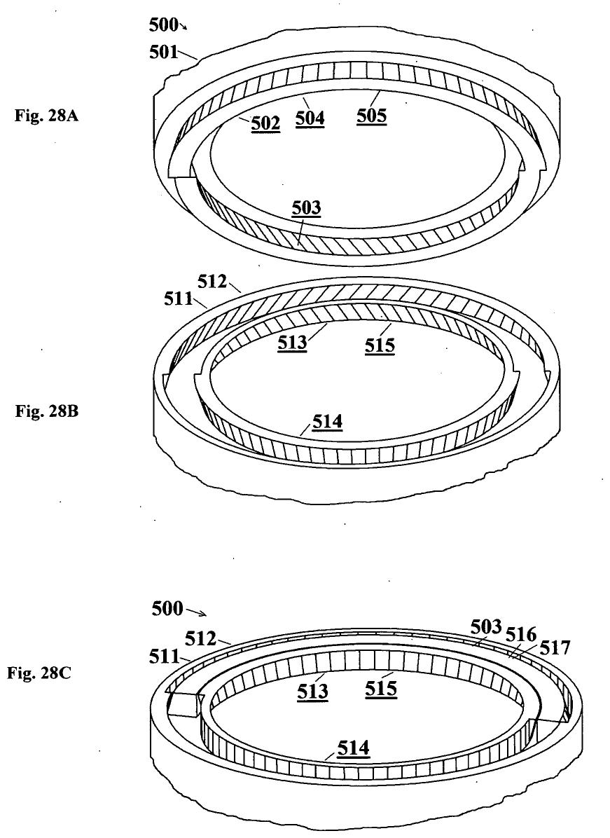

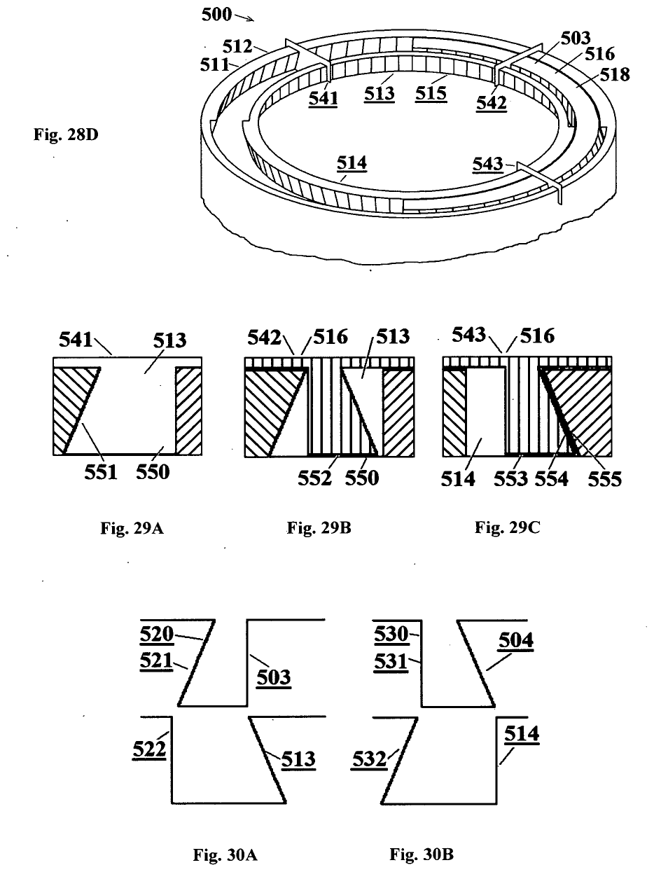

The weakness of the partial thread is that only half of the disk is engaged. The other half is the landing area. Ideally it would be better to combine the landing and thread connections. That is literally what the Circular Split Lock Key thread does. This will be explained using FIGS. 28A-D 500. The top part 501 has a ring 502 of partial Keys 503 504 at location 505. The bottom part 511 has a ring 512 of partial split Locks 513 514 positioned 515 below.

The engagement process of the split Lock 500 is for the Keys 503 504 to land in the split Locks 513 514. FIG. 28 C shows just the Key portion 516 of the Key thread 503 in the landing area 517. The next step is for the Key portion 516 to transit into 518 the split Lock 513 adjacent to the landing split Lock 514 as demonstrated in FIG. 28 D.

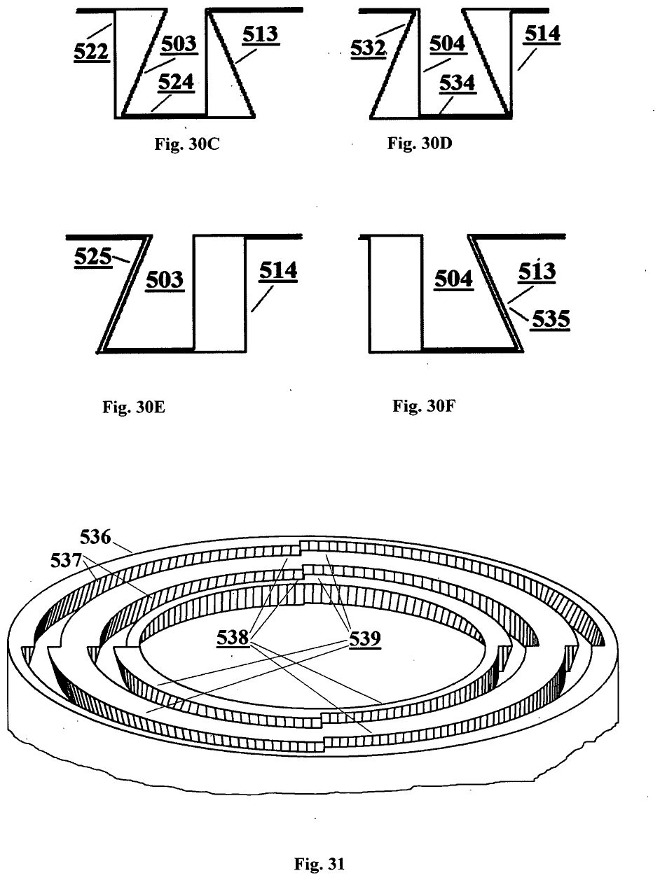

This process will first be explained using the slices 541 542 543 of FIG. 28 D in FIGS. 29 A-C; and then more comprehensively using FIGS. 30 A-F. The first slice 541 in FIG. 29 A shows the split Lock 513 profile. This has a landing area 550 and its Lock profile 551. The next slice 542 in FIG. 29 B is across split Lock 513 and Key profile 516 at 552 the landing area 550. The slice 543 in FIG. 29 C has the Key profile 516 moved into its split Lock 514 where its Lock profile 553 mates 554 with the Key profile 555.

The split Lock concept is to land a Key 503 into a Lock 513, then transit into another Lock 514 to the terminus. FIG. 30 A is a cross section diagram 520 of the Key 503 positioned 521 over a Lock 513 slice 522. FIG. 30 B is the same with the cross-section diagram 530 of the other Key 504 over 531 its landing Lock 514 slice 532. Note that first Key 503 is facing the opposite direction of the other Key 504. In FIGS. 30 C and D the Keys 503 504 are in their landing areas 524 525. FIGS. 30 E and F are the Keys 503 504 in transit positions 525 535 into the adjacent Locks 514 513.

In FIG. 29 A the profile 551 was facing away from the axis. In FIG. 29 C the profile 555 is facing towards the axis. On opposite sides of a ring, this Key-split Lock pair are pushing in the same general direction and are not practical. The split Key should have more than one pair at least and preferably multiple rings 537 such as 536 FIG. 31. There are two inward facing 538 and two outwardly facing 539 pairs. They do not have to be different sizes of the same rings as shown 537. They can be rings rotated 90-degrees.

### Disk Engagements

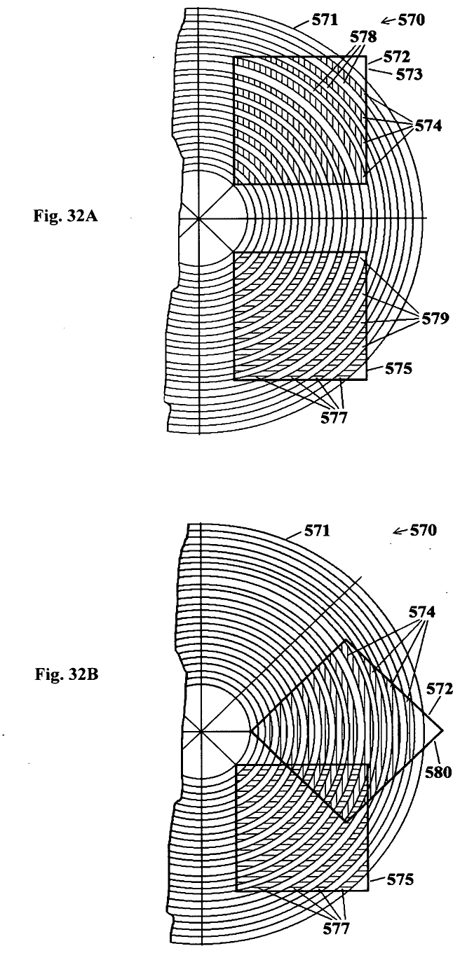

The circular or spiral threads can rotate with an offset center of axis. The FIGS. 32 A-C is a diagram 570 of two squares 572 575 on a part of a disk shape 571. The majority of the circular arcs are references of the path the threads will follow as the squares engage. These threads are zipped which means the profile of the Keys forms the cavity of the Locks. In FIG. 32 A the Keys 574 on the first square 572, positioned 573 above the second square 575, will engage with the Locks 579, and at the same time, the Locks 578 of the first square 572 will engage with the Keys 577 of the second square 575.

A partial engagement is shown in FIG. 32 B with the upper disk 572 moving 580 into the second disk 575. The full engagement in FIG. 32 C shows all the Keys 574 577 threads zipped together. Standard threads are “zipped” in this context. What is different is that the Key thread profiles are constantly changing.

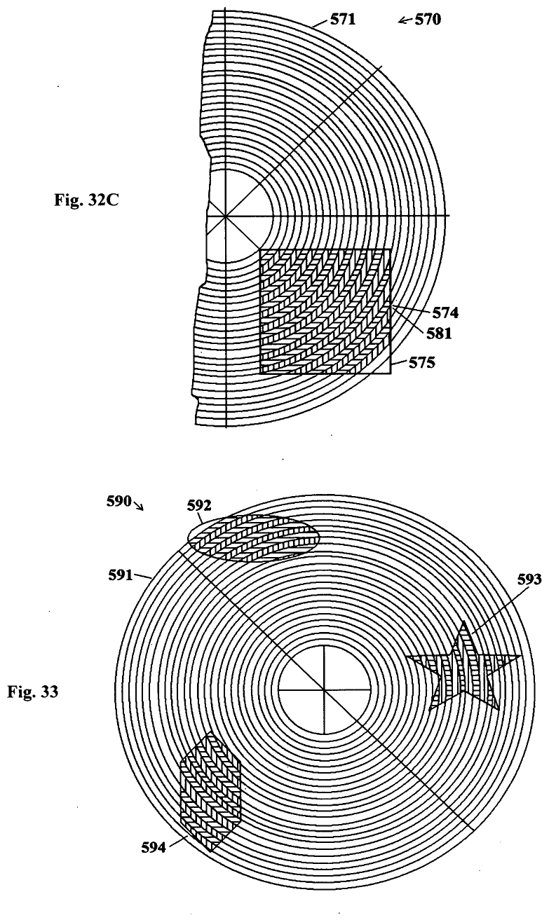

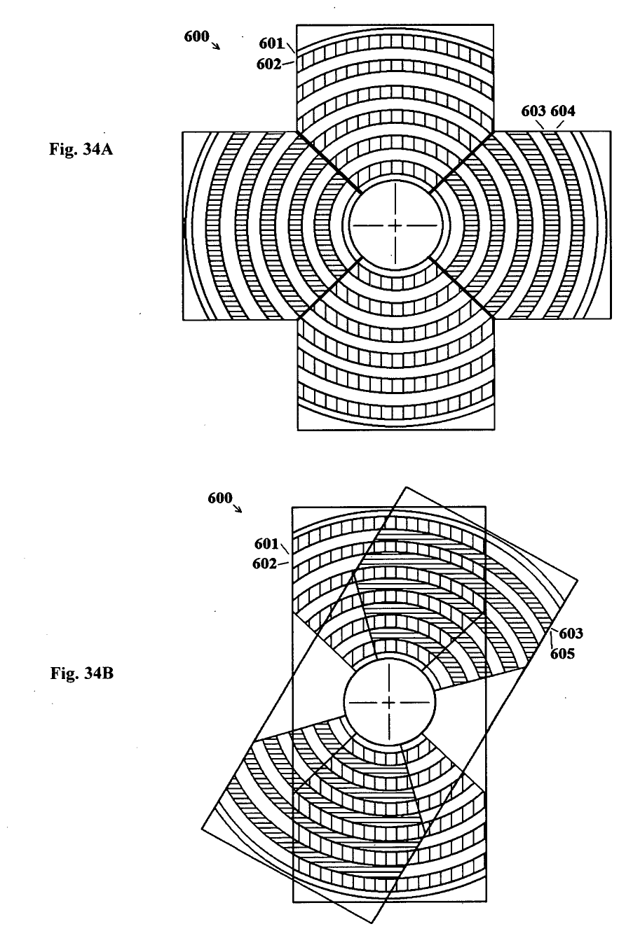

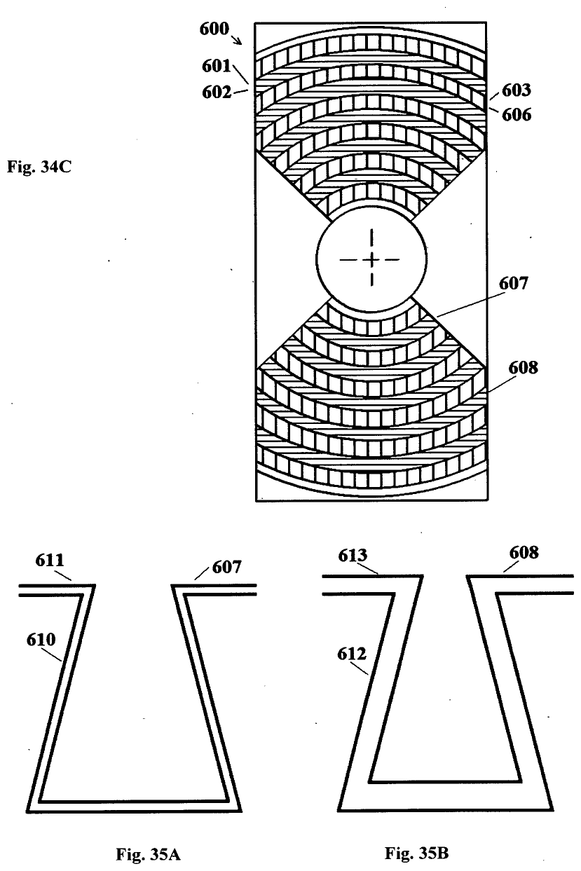

FIG. 33 590 is a diagram of a disk 591 with three mating parts 592 593 594. This is to demonstrate that multiple parts 592 593 594 can be connected on a common plane. FIGS. 34 A-C 600 is a more practical application. FIG. 34 A is the starting position 602 of the Lock 601 relative to the Key 603 position 604. FIG. 34 B has the Key 603 rotated to position 605 and finally FIG. 34 C is the terminus position 606 of the Key 603.

There is one characteristic about Lock and Key design that should be noted. Here 600 in FIGS. 34 C, the Key 606 is about one third the length of the Key 607. In practical terms the Lock and Key profile change in size should be proportionally bigger as demonstrated in FIGS. 35A and B. FIG. 35 A is the profile starting Lock 610 and Key 611 for Key 607 in FIG. 34 C. FIG. 35 B is the starting Lock 612 and Key 612 for the longer Key 608 in FIG. 34 C. During transit, the rate the Keys approach the Locks have to be relatively equal, so the different lengths have to be proportionally different sizes. This allows an equal tolerance to be applied to fabrication.

### Cylinder, Cone, Concave and Convex Shapes

A Key thread on a cylinder shape is a transit only thread. There is no penetration designed, but the change in size could technically be penetrating.

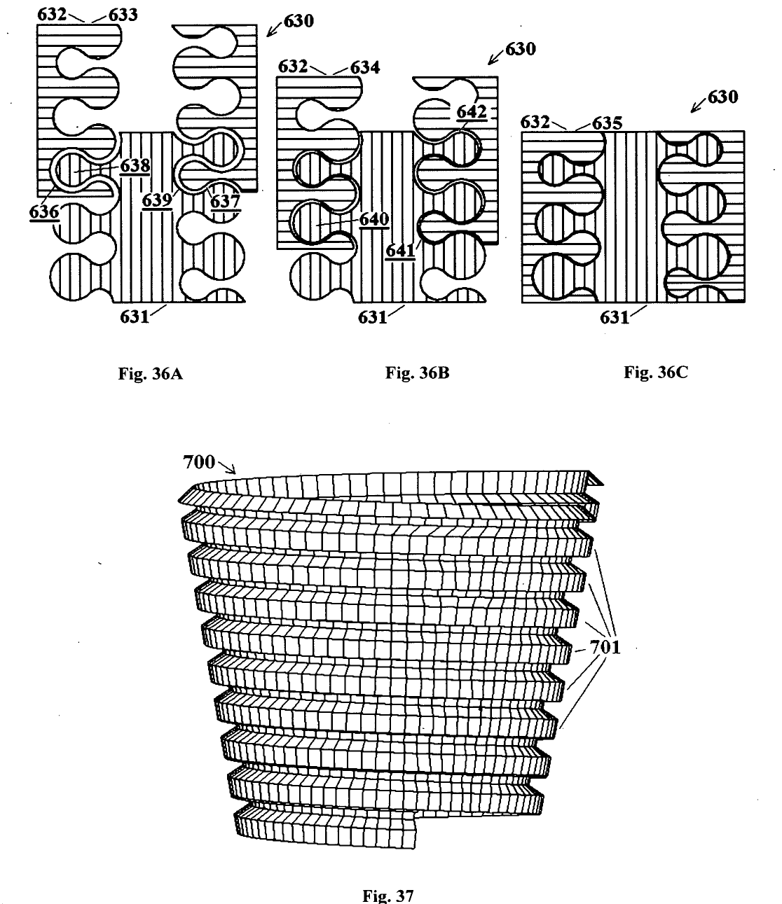

FIGS. 36 A-C is the cross section of cylinder Key thread 630 engaging at three position 633 634 635 as the female part 632 transits through the male part 631. To transit, the Keys and Locks have to change in size till all the surfaces engage at their terminus 635 in FIG. 36 C. FIG. 36 A shows the large Lock 636 on the first thread on the female and the small Key 637. That allows it to transit the male part with corresponding small Key 638 and large Lock 639. FIG. 36 B shows the next male thread Key 640 is larger and Lock 641 is smaller. The space 642 between the first female thread is getting smaller. FIG. 36 C has the transit complete with the female 632 at it terminus 635.

The profile shape of the Keys 637 638 640 and Locks 636 639 641 are circular. They could be a wedge, dove tail or any shape that fits and changes in size. In this example 630, the threads are zipped meaning the sides of the Keys 637 638 640 create the voids of the Locks 636 639 641.

All Key threads on a cone, concave or convex surface shape have transit and penetration. That allows the Key and Lock profiles to stay the same size and shape. The Key profiles on the concave and convex shape change their angular orientation while the cone shape stays at a constant angle.

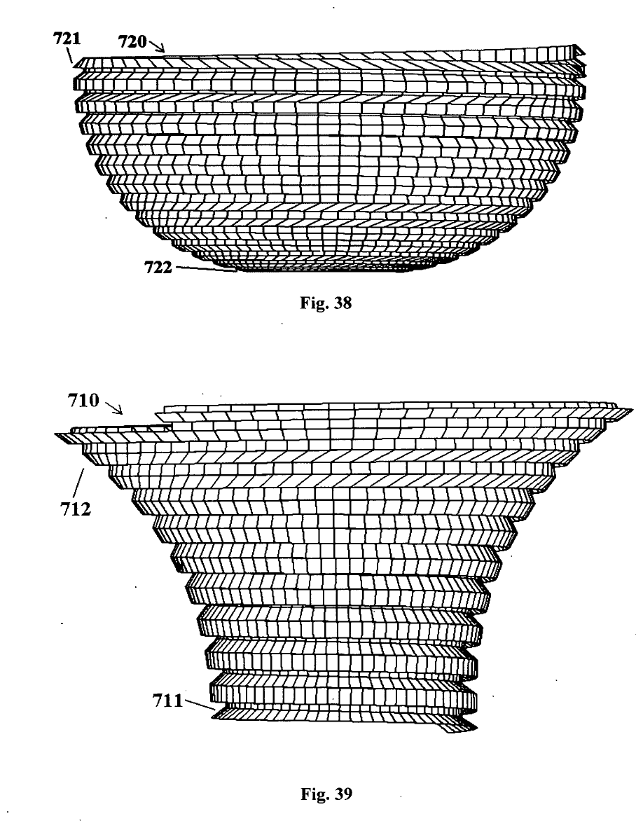

The cone shape 700 in FIG. 37 has wedged shaped profile not shown. The threads 701 engage at the same time and rate. The convex shape of FIG. 38 710 and concave FIG. 39 720 appears to be reversed. This is a convention of all the Van Cor threads where the internal female thread determines the limitations of the threads and its shape, but the external male picture is used in its depiction.

In FIG. 38, the surfaces on the convex shape 710 approach each other at different rates. They engage at its bottom 711 first and accelerate to its top 712. The vertical rate of engagement is constant, the additional surfaces increase in area.

In FIG. 39, the surfaces on the concave shape 720 approach at an accelerating rate. Initial engagement 721 is at the top and while the vertical rate is constant, more surface area is added as it approaches the bottom 722.

### Surface Trains

Surface Trains are an application of Key threads to create surface components where their rotational movement is more a slide into position. Typically, these are in groups as will be seen in the Key threads systems. The surfaces that are spherical are three-axis with two-axis of rotation, cylindrical are two-axis with one-axis of rotation or flat with one or two-axis with the possibility of one-axis of rotation. There are always at least two mating surfaces the Key threads will be joining. There can be multiple surfaces around a single thread connection or multiple threads around a single surface connection. From a starting point relative to the axis, the Key Rail is projected outwards with a positive, zero or negative axis of rotation. The train of profiles follows this Rail rending the mating Key and Lock structure.

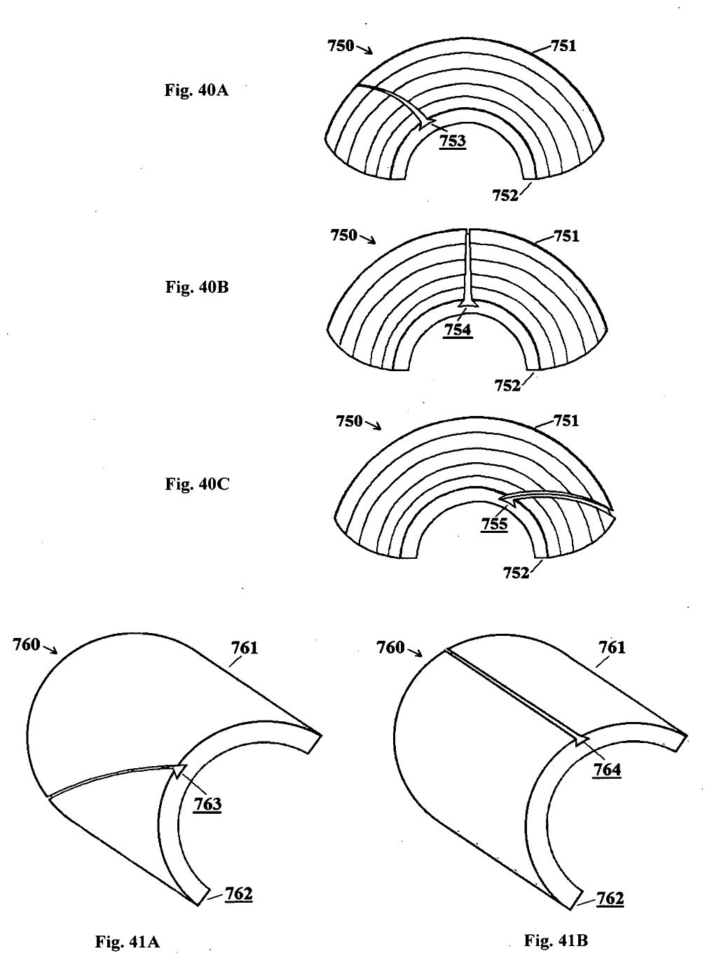

FIGS. 40 A-C 750 are a partial hollow sphere 751 perpendicularly slice 752. FIG. 40 A has a straight Key thread Lock 753 at an angle to the starting slice. Its curve is relative to the viewing position of the sphere. The mating Key will move in a straight line, but at an angle to the starting plane 752. FIG. 40 B has a straight Key thread Lock 754 perpendicular to the starting slice 752. Because it is on a sphere, the mating movement will be around the sphere's surface face at a linear direction. FIG. 40 C has a circular curved Key threaded Lock 755. Its mating Key will rotate the part it is on into position following the curvature of the sphere.

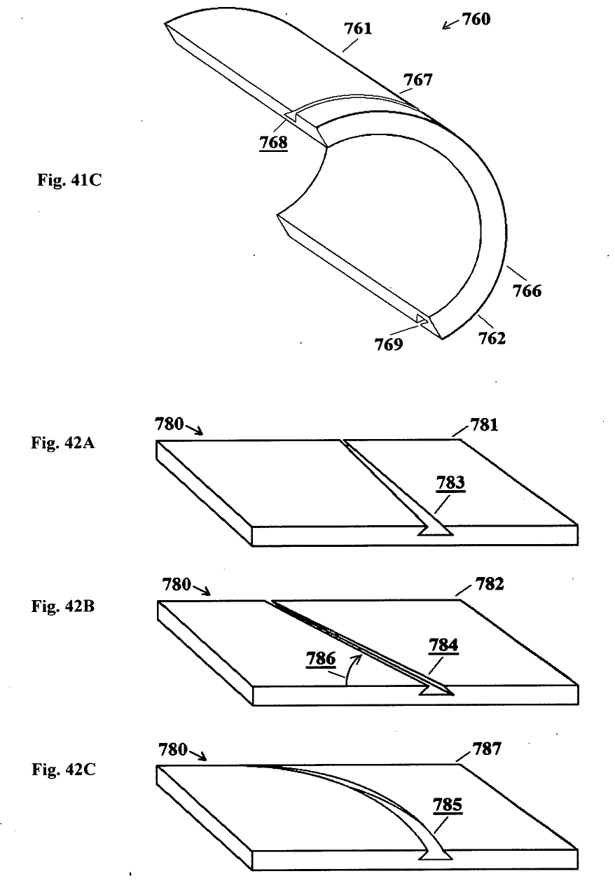

FIGS. 41 A-C 760 is a semi cylinder 761 with a perpendicular plane 762 on the end. FIG. 41 A has a line 763 at a fixed angle 765 to the plane 762. It has to follows the curved surface of the cylinder rotating as it inserts. FIG. 41 B is a straight line 764 perpendicular to the plane 762. FIG. 41 C is the semi cylinder 761 rotated 766 to show the circular line 767 that begin 768 and end 769 parallel with the end plan 762.

FIGS. 42 A-C 780 are a flat panel 781 with a straight 783, angled 784 and curved 785 Key threads. FIG. 42 A is a straight 783 thread and is shown perpendicular to the end of the panel 781. The straight Key thread distinction of precision placement in that a single axis of tolerances while all the others have two or more axis. FIG. 42 B is a straight thread 784 at an angle 786 to the end of the panel 782. FIG. 42 B is a curved thread 785 from the end of the panel 787.

There are more exotic surfaces that can have partial threaded components added to their surfaces.

These surface trains of Key threads are in groups and they overlap. This means two Key thread Locks can pass through each other for two different surface parts. Some surface trains are finishing parts to an assembly that cover the outside.

### IV Key Threaded Systems

Key threaded systems are unique applications made possible with Key threads.

### Bolts

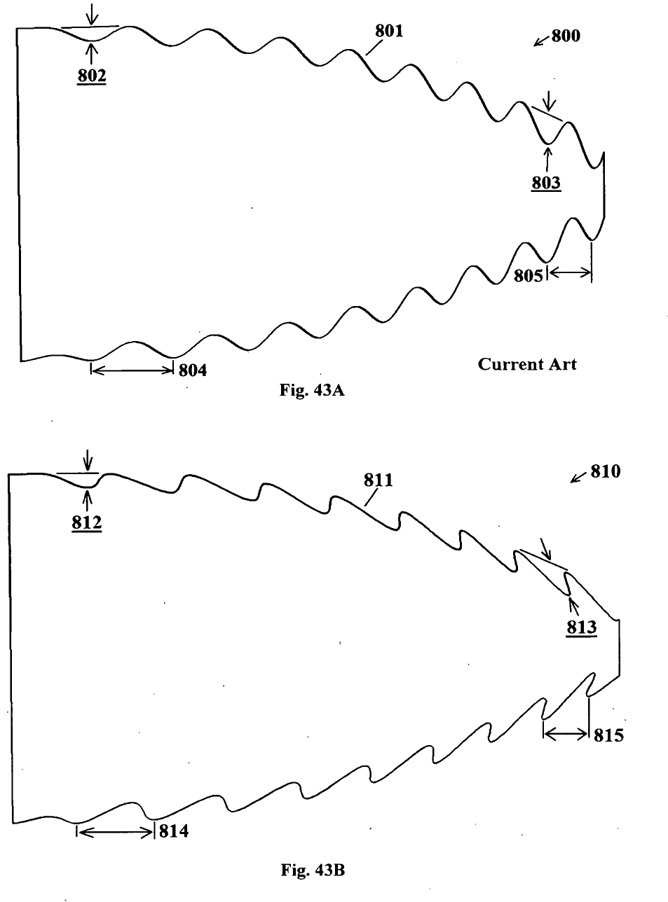

The wave thread is a high surface contact thread that had optimized variables that resulted in 25% more strength then a standard UNC thread. Optimizing similar variables could result in an even stronger Key thread system. The shape of the bolt was a circular curve; the starting size of the thread was similar to Unified Threads using the number of threads per inch for any given diameter. In FIG. 43 A 800 the wave thread 801 profile has the last height 802 half the height of the beginning 803. The starting width 805 is doubled at the end of its length 804. This wave thread 801 as shown in FIG. 43 A is current art.

These can be applied to the Key thread 810 shown in FIG. 43 B. The cross section 811 shows the beginning height 813 is half the ending height 812. The beginning width 815 is doubled at the ending width 814. These variables will have similar stress distribution characteristics. This Key thread design has a notable directional hook.

### Key Brick

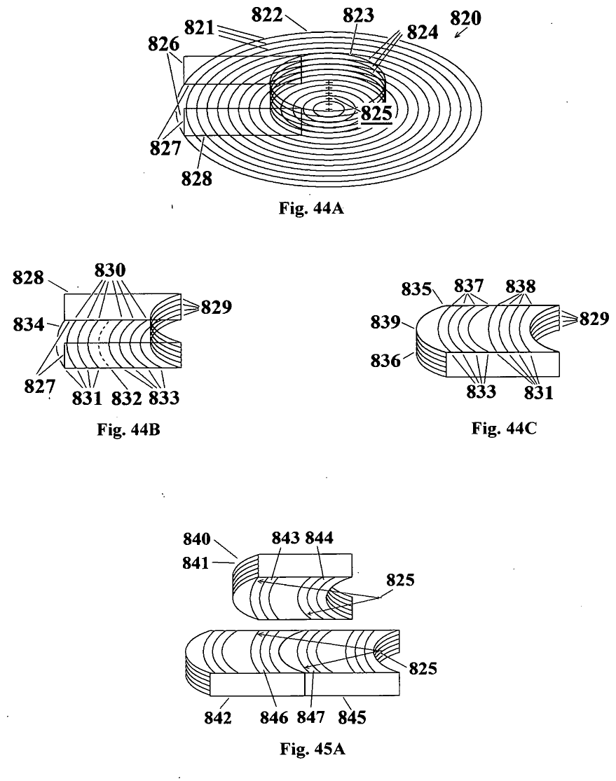

The concept of the Key brick is that it is used to make a wall with overlapping bricks. It is based on adding Key threads to a brick shape. In FIG. 44A are the basis of those threads 820 shown as Key Rails. There is a circular thread 821 positioned as a bottom disk 822 and cylinder threads 823 positioned 824 in the middle of that circular thread 821. The disk and cylinder threads have the same center 825 of rotation. The position 826 of side boundaries 827 layout the relationships of the brick 828.

FIG. 44B is the basis of the Key brick 828 with two sides 827, part of the cylinder threads 829 and part of the disk threads 830. The bottom 834 of the brick has partial disk threads 830. The dashed Key Rail 832 is being removed. That separates the inner cylinder threads 833 from the outer cylinder threads 831.

To finish the brick 835 in FIG. 44C with interlocked threads, the other cylinder thread 836 and disk thread 837 have to be added. The other cylinder threads 836 are the same as the first cylinder threads 829, but positioned 839 at the other end. These are Key Rails from which the perpendicular Lock and Key profiles will be positioned on. Each subsequent brick will connect with the same cylinder threads 829. The bottom disk thread 837 have to overlap the tops of other bricks. This requires the mating top thread to have an outer bottom thread 831 in the inner top positioned 838 and the inner bottom thread 833 in the outer top position 837.

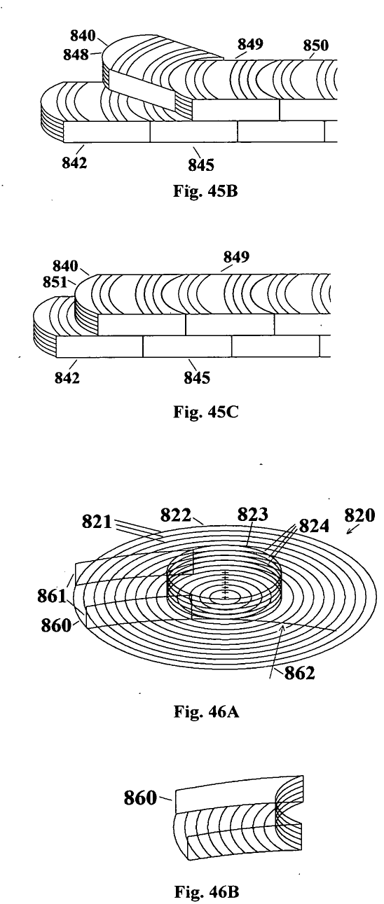

FIG. 45A shows Key brick 840 positioned 841 above two connected bricks 842 845. The inner 843 and outer bottom 844 Key Rails on the one top brick align with the inner 847 Key Rails of the second bottom brick 845 and outer 486 Key Rails of the first bottom brick 842. These disk threads 843 844 846 847 all have the same center of rotation 825. This type of multi-thread connection is called interlocking.

FIG. 45B demonstrates the top brick 840 in a rotating position 848 into the bottom two bricks 842 845 and into a lateral brick 849 that represents part of the wall 850 being constructed. FIG. 45 C represents the completion of the assembly with the top brick 840 inserted 851.

This is a way to assemble against a wall because the rotation is on one side only.

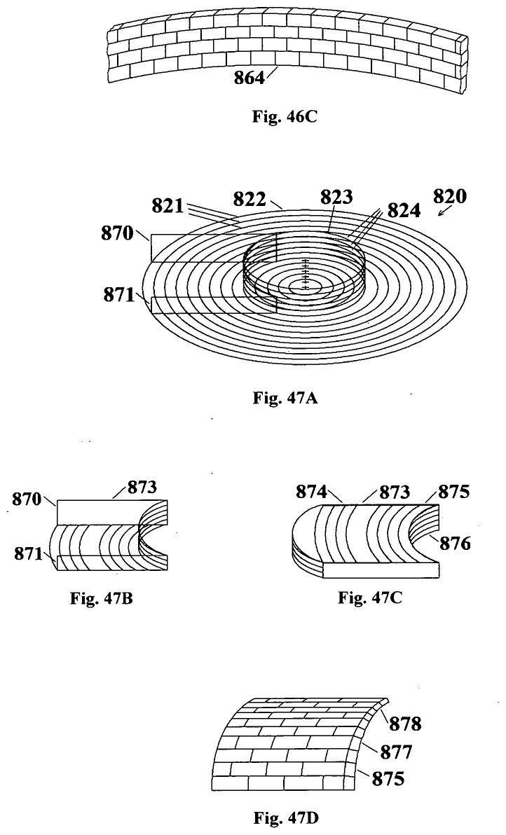

The Key bricks can be different shapes. FIG. 46 A has the same disk 822 and cylinder 823 from FIG. 44 A. The difference is the sides 861 of the brick 860 are on a curved path demonstrated with a radius 862. FIG. 46 B is the basis of the curved brick 860. FIG. 46 C represents a curved wall 864 that these bricks would make. This is an example of how different shapes can come out of the same disk 822 and cylinder 823 threads.

The Key brick can be relative to different planes such as a wedge shape. In FIG. 47 A is the same disk 822 and cylinder 823 as FIG. 44 A. The wedge shape is created from the different side boundaries 870 871. The front side 871 is lower than the back side 870 and FIG. 47 B is the basis for the wedge-shaped Key brick 873. FIG. 47 C represents the wedge shape 874 with the top surface 875 at a different angle to the bottom 876. The disk threads on this top surface will represent a different angular plane for the layer and each succeeding layer will have an accumulative effect creating an arch. FIG. 47 D is an example of an arch wall 877 that these wedge-shaped Key bricks 875 would make. The bricks 878 can change size.

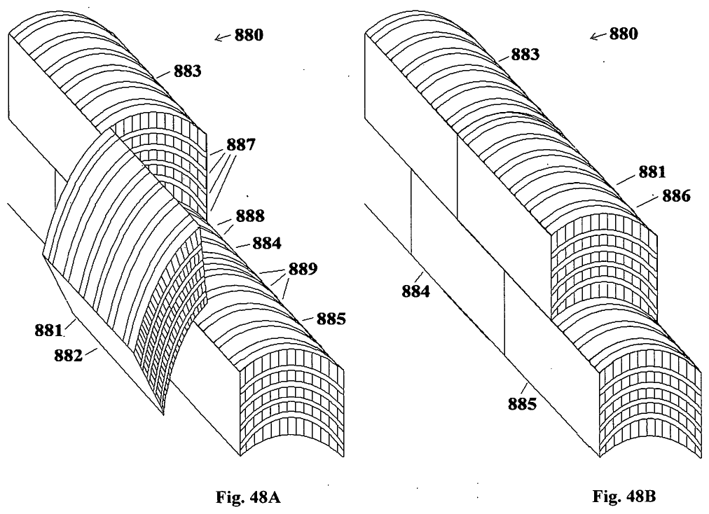

A wide range of Key threaded bricks can be made having the same disk 822 and cylinder 823 threads. Another way is shown in FIG. 48

FIGS. 48 A and 48 B are Key threaded bricks 880 that rotate vertically. It is the same principal as the FIGS. 44-47, just different. In FIG. 48 A the Key brick 881 is in the process of rotating 882 into the other Key bricks 883 884 885. In FIG. 48 B the Key brick 88A is in position 886. The brick 881 in FIG. 48 A is engaging with the circular threads 887 on end of the brick not shown; and with part of the cylinder Keys threads 888 on brick 884 and part of brick 885 threads 889.

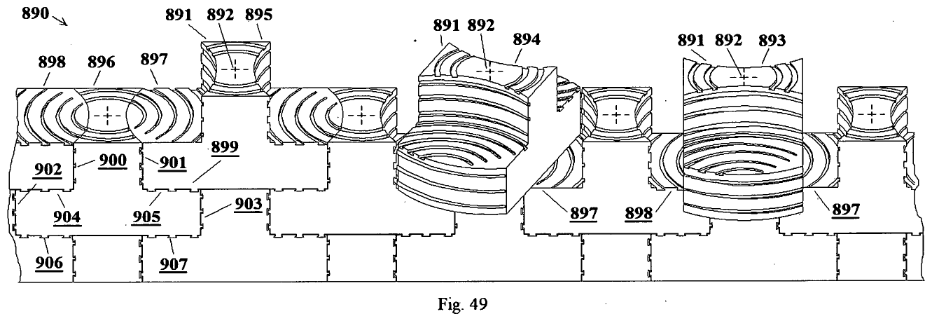

FIG. 49 is another way to make a Key brick wall 890 with Key bricks 891. The purpose is to demonstrate that these tools can be shaped and assembled in different ways. The Key brick 891 has a center axis of rotation 892. This is not practical for assembling against a wall, but does work for a standalone wall. In the first position 893 the brick is perpendicular to the wall 890. In the next position 894 it has half rotate and in the last position 895 it is in its terminal position for its threads.

When the bottom is engaged at its first position 893, it is across the center threads 896. This could be either landing area for a circular thread or a partial thread 896. The side threads 897 849 are circular threads that are engaged as the brick 891 rotates 894 895 into them.

The geometry of the brick 891 is designed to Lock the brick across three layers of bricks. Brick 899 has two ends 900 901 on top and two ends 902 903 on the bottom that are cylinder threads. These are the sides of two layers. It has two top facing threads 904 905 and two bottom facing threads 906 907 that are circular threads. These connect to the four bricks, two above and two below. The top of the middle post 896 is more about its sides

There are many shapes other than the traditional brick that can be used as a repeating pattern. They have to engage at least two threads systems on different faces or sides. There are straight, curved, wedged and domed shapes. The straight surfaces were in FIGS. 44-46, & 48. The same cylinder and disk Key threads are used with the surface curved in FIG. 47. The wedge shape can add an arch curvature to a wall. A dome shape (not shown) is the curved plus the arch surface.

The threads of a flat brick are single axis threads added to squared surfaces. Threads on a curved are single axis threads with curved surfaces or 2 axis threads with curved surfaces. Domed surfaces are 2-axis or 3-axis threads added to curved surfaces.

### Disk and Surface Panels

Key threaded systems include panels. These are flat panels, curved panels, multi-axis sphere-like panels, and combination of surface components that create a structure. A panel can have Key threads on its edges. A panel is constructed of interlocked components. Interlocking is multi-thread, multi-component or both that connect at least two parts together. The bricks are also interlocked.

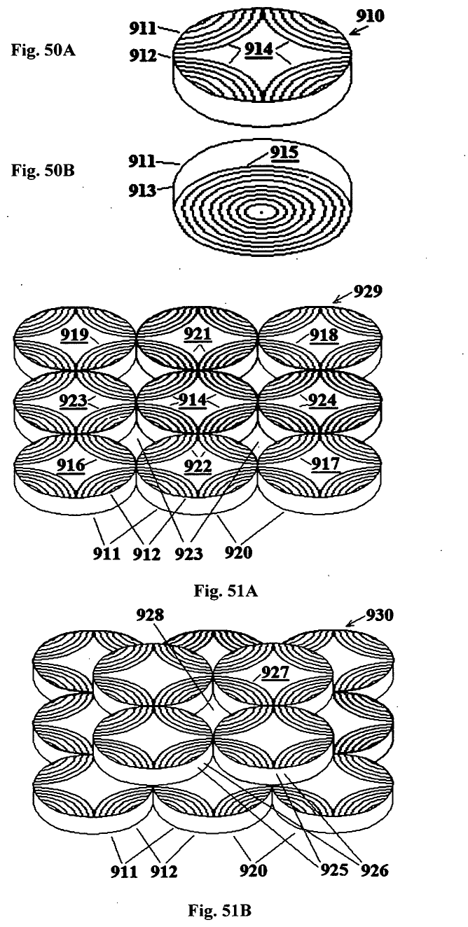

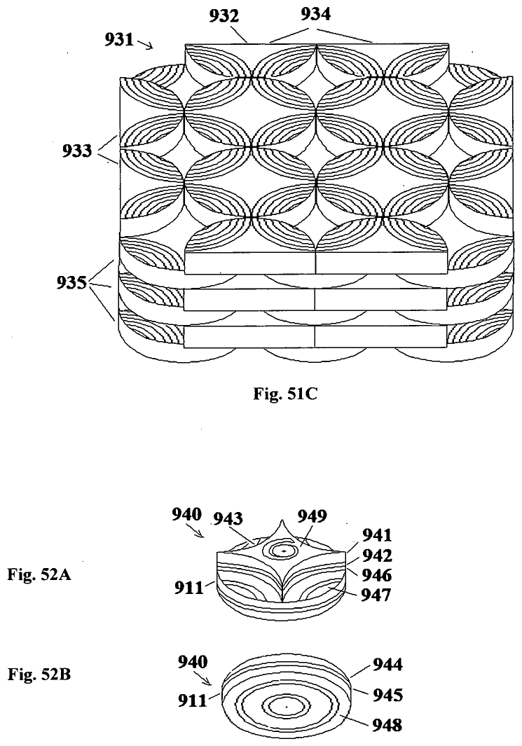

FIG. 50A is a cylinder component 911 for a panel 910 showing the top view 912. FIG. 50 B is the bottom view 913. The top 912 has four partial Key disk threads 914 while the bottom 913 has one disk thread 915. FIGS. 51 A & B are a collection of these components 911 top side up 912. In FIG. 51 A they are arranged such that their partial Key disk threads 914 align with the partial Key disk threads on the top 921 and bottom 922; and left 923 and right 924 components align into circles 916 917 918 919. FIG. 51 B shows a second layer 925 of these cylinder components 911 positioned 926 with their top sides up 912 engaged with the circles 915 916 917 918 not shown. This layer is second layer 925 is fastened with the first layer 920. They also form a circle 927 that a third layer component can engage. This is the basis for creating a simple disk panel with open 928 spaces that will allow flexing.

FIG. 51 C is an expanded panel 931 with fitted side component 932 between the disk 935 on sides 933 and ends 934.

The panel 929 in FIG. 51A had an open space 923 between the cylinder components 911. FIG. 52A is a diagram of a solid panel component 940 design. It has an extension 941 above the same cylinder 911 adding a second layer to form a new panel 942 component or “plug” shown in a top view 943. The bottom view 944 in FIG. 52 B is the same cylinder component 911 with the side cylinder threads 945 added. These will engage with the cylinder threads 946 in the extension 941. The top of the extension 941 has disk threads 947 that more fully engage with the bottom disk threads 948.

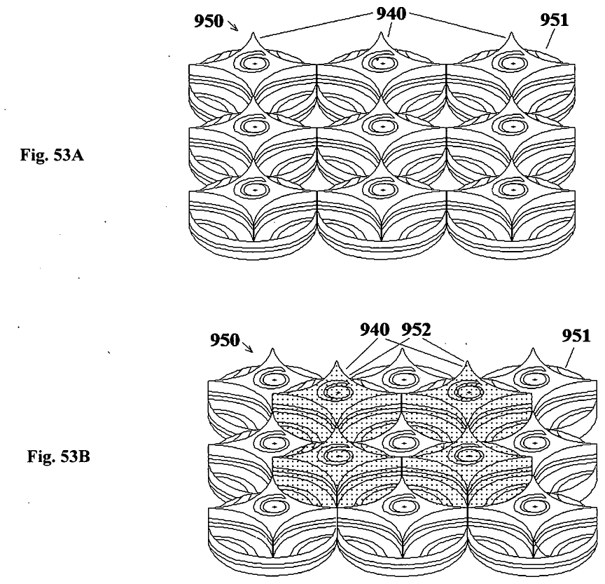

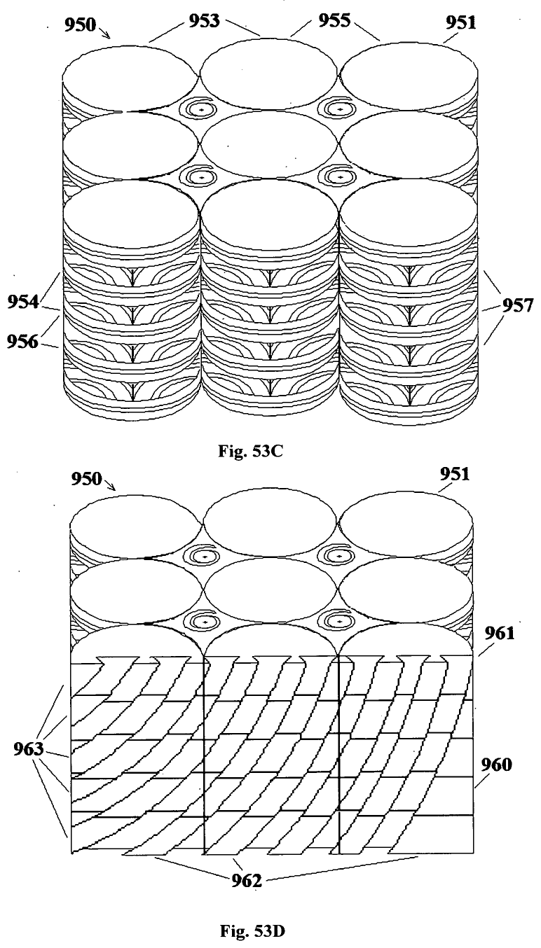

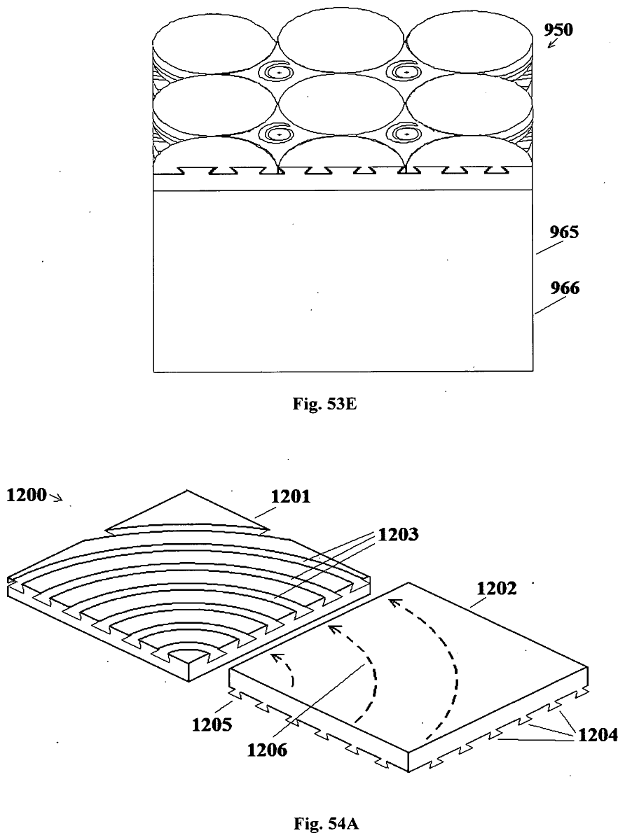

FIG. 53 A has a panel 950 with multiple solid panel components 940 rendered into a single panel unit 951. FIG. 51 B shows solid panel components 940 added to the panel 951 as a first layer 952. FIG. 53 C are multiple layers 957 added to the panel 951. These include additional solid panel components 954 positioned on the outside 956. There is a finishing top partial component 953 on the top 955. FIG. 53 D is the panel system 950 with an additional component system 960 added in the each of the sides 963 and layers 962 to form a receiving panel. FIG. 53 E is that mating panel 965 rotated into position 966 to form a finished shell on the outside.

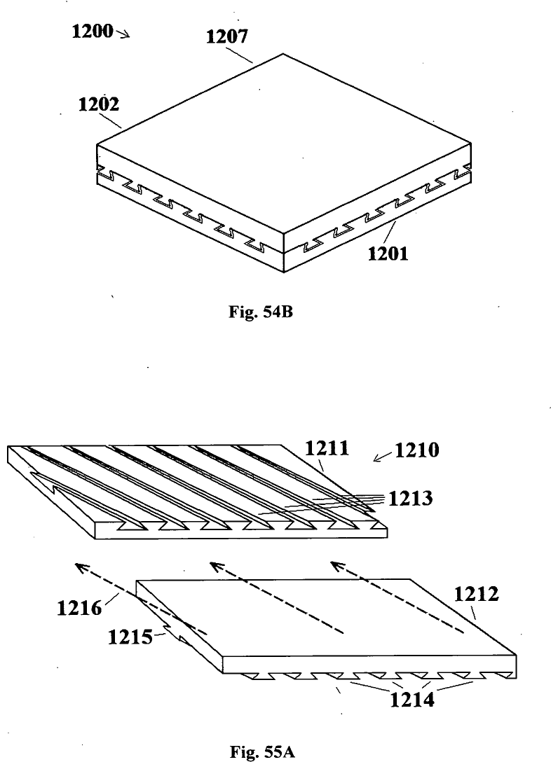

FIG. 54 A are the Locks 1203 of circular Key thread system 1200 on a bottom square 1201. The mating top square 1202 has the Keys 1204 in position 1205 to rotate 1206 on the Locks 1203. FIG. 54 B is the union 1207 of the bottom Lock square 1201 and the top Key square 1202. These represent any flat surface that can be populated with a mating Key threads system such that it be rotated into a terminal Locking position. This is the preferred method because a circular structure has to be unscrewed to separate.

FIG. 55 A is the Locks 1213 on an angular Key thread system 1210 on a square part 1211. Its Keyed 1214 mating part 1212 is in position 1215 to move 1216 at angle into the Locks 1213. FIG. 55 B is the Keyed 1212 and Lock 1211 parts in their terminal position 1217. A Lock and Key can be designed to engage at any angle.

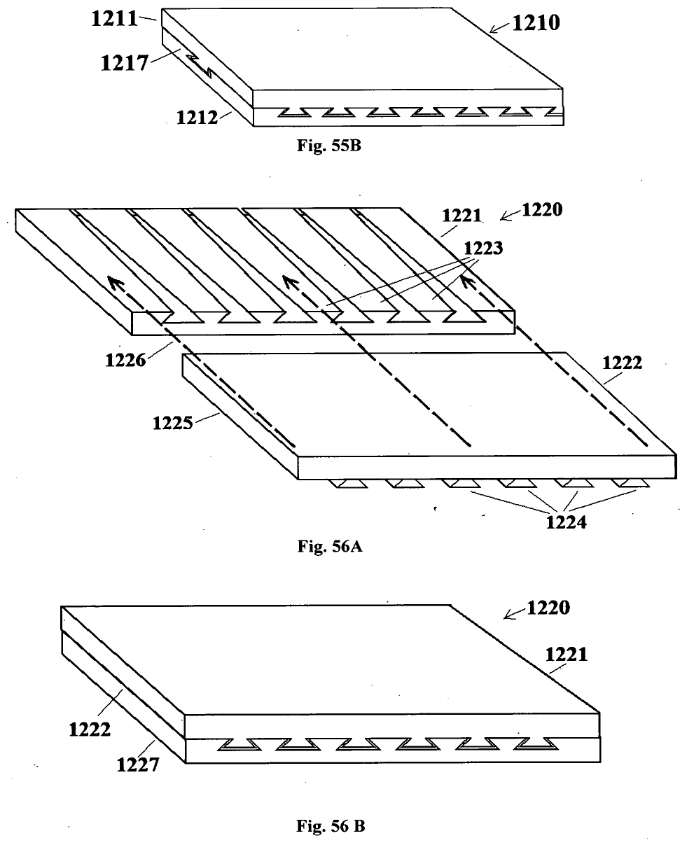

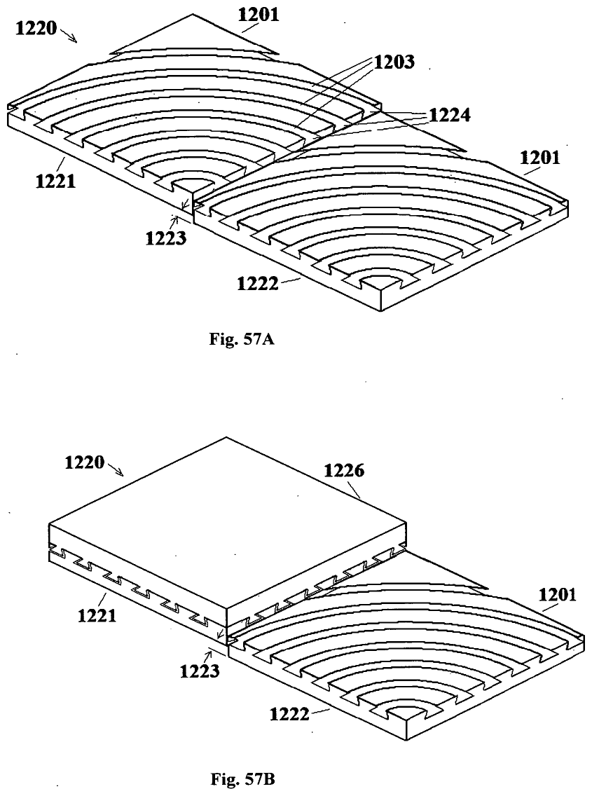

FIG. 56 A is a straight Key threads system 1220. The Locks 1223 on the bottom panel will engage with the Keys 1224 on the top panel 1222 by moving 1226 from position 1225 to the terminal position 1227 in FIG. 56 B. This is the simplest panel connection; easy to engage and disengage.

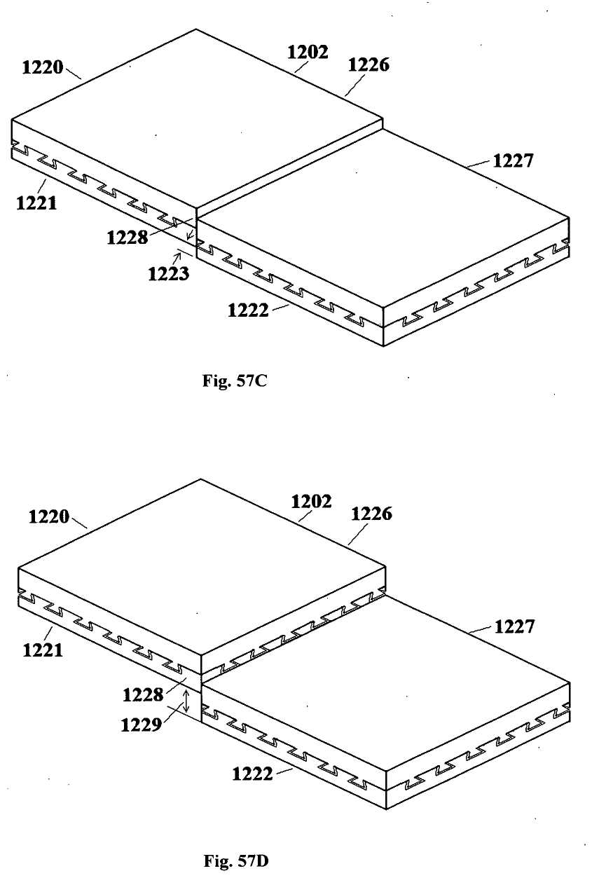

Panels are assembled in an order similar to bricks. The circular Lock 1224 and Key 1203 in FIG. 57 A of the bottom panel 1221 will its mating top panel 1226 rotate into position in FIG. 57 B. The rotation is not shown, but it has to pass over the adjacent panel 1222 and others. Where the first bottom panel 1221 is positioned beside the second bottom panel 1222, there is a difference in height 1223. This height is called a Lock Step because it is the height of the Locks 1124. This allows room for the top panel 1226 to be engaged with the bottom panel 1221. Also in FIG. 57 C The next top panel 1227 secures 1228 the first top panel in place. It can not come out.

This creates a specific sequence of assembly. In FIG. 57 D the greater height difference 1229 is called the Panel Step. This allows the top panel 1226 to be engaged or disengaged above the second top panel 1227. This will allow the mixing of panel types. FIGS. 56 and 57 are examples of positioning. The threads can be on different planes relative to their panels because they change in size or shape. The top panels would normally have the next panel thread or a finished layer.

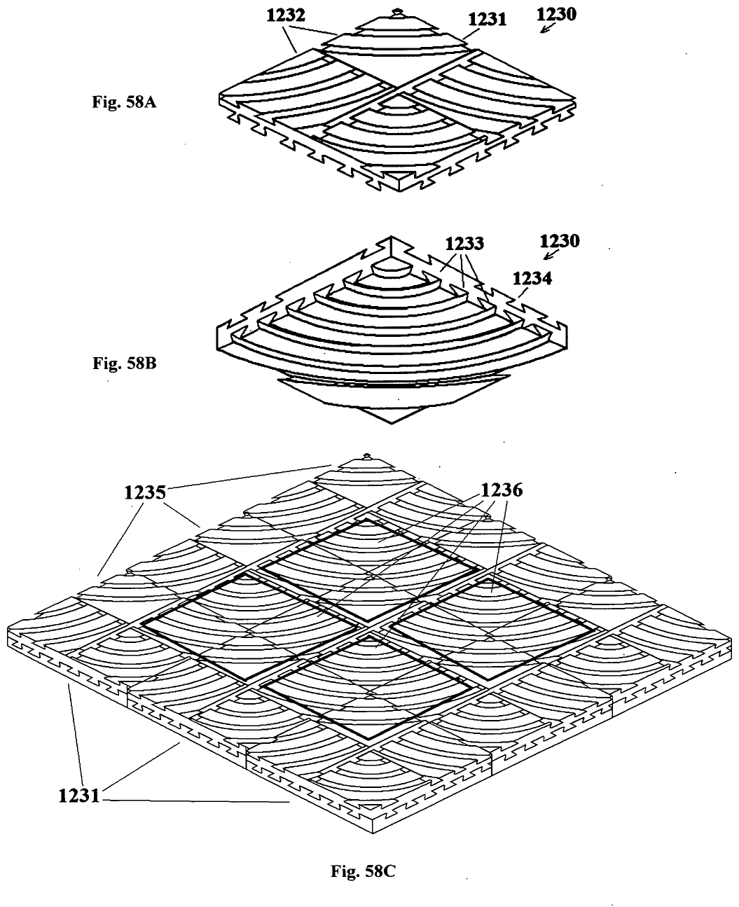

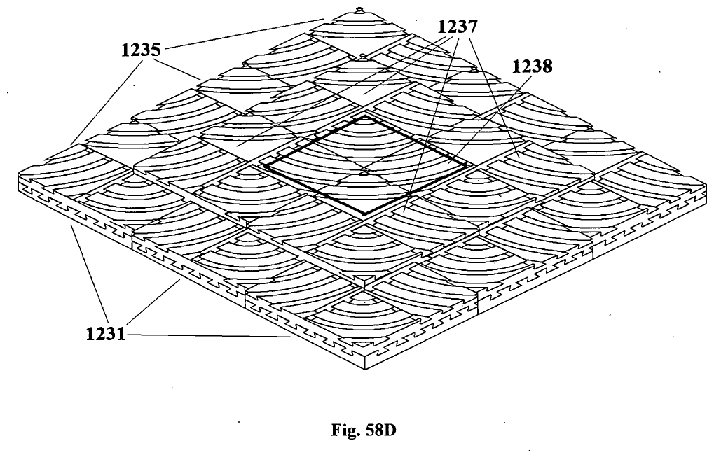

Interlocking is the connection of two or more parts with one or more threads. FIGS. 57 C and D are not interlocked. FIGS. 58 A and 58 B are an interlocked panel 1230. The top 1231 threads are in four quarters 1232. The bottom 1234 is one thread 1233 that will engage with four quarters. FIG. 58 C are how nine quartered 1231 panels are positioned 1235 to form single threads 1236 highlighted with a black square. These become interlocked in FIG. 58 D with the addition of threaded panels 1237 on each of those single thread positions. Another layer using the single thread 1238 created from the quartered panels 1237 formed a single thread 1238 highlighted.

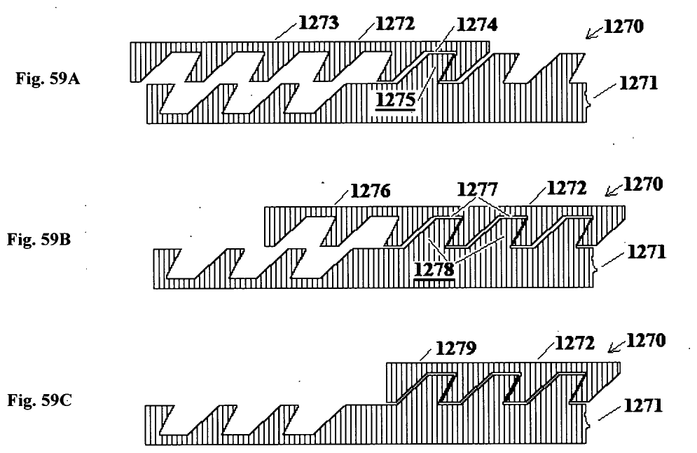

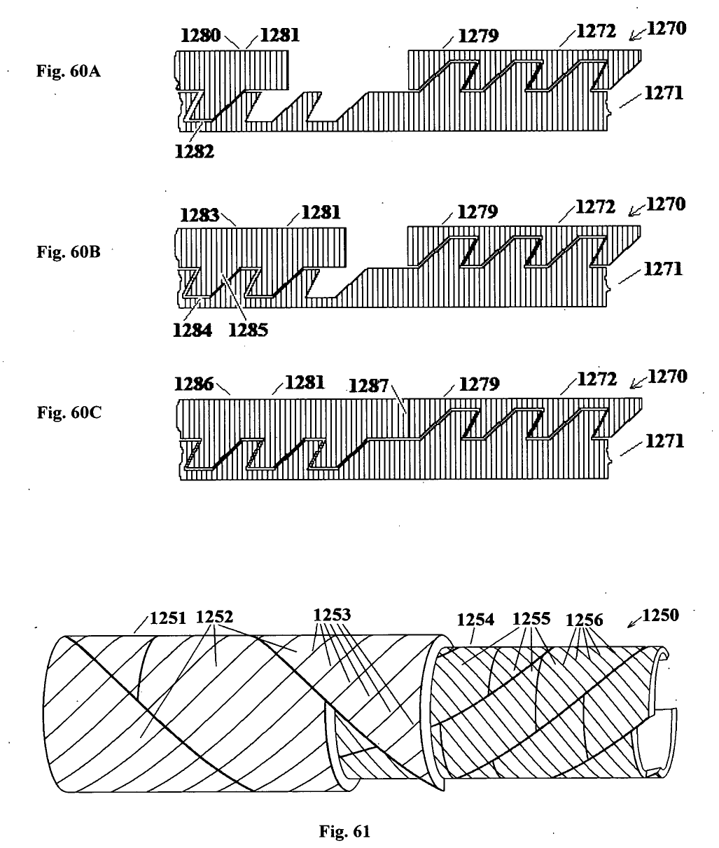

As the surfaces of parts become more complex, assembling panels without interference is needed. One method is split recess panel 1271 concept diagrammed FIGS. 59-60 1270 as cross sections. In FIG. 58A the top panel 1272 is positioned 1273 to engage a Lock 1274 with a Key 1275 on the recess panel 1271. In FIG. 58 B the top panel 1272 is moved 1276 to engage more Locks 1277 on the bottom recess panel 1271 Keys 1278. FIG. 58 C represents the completion of the engagement of the top panel 1272 positioned 1279 with the Key portion of the bottom recess panel 1271.

FIG. 60 A has the recess panel 1271 with its first thread 1272 plus the start 1280 of the second thread 1281 that has engaged the first recessed 1282 Lock. FIG. 60 B is second thread 1281 moving further 1283 on to the recess panel 1281 engaging another Lock 1284 with its Keys 1285. FIG. 60 C is the last position 1286 of the second thread 1281 on the recess panel 1271. It 1281 is abutting 1287 the first top thread 1271. These are the terminal positions 1286 1279 of the top threads 1291 1272 engaged with the recess panel 1271.

### Tubular

Tubes 1250 are a collection of cylinder components 1251 1254 that assemble into a tube. FIG. 61 is a representation of Key Rails 1253 1256 around a cylinder shape 1251 1254. The inner cylinder 1254 has panels 1255 with Key Rails 1256 representing where Key threads would be located. The outer cylinder 1251 has panels 1252 containing Key Rails 1253. The Key Rails are in opposite direction and they overlap. They are interlocked. This will have at least another outer cylinder for the Key Rails 1253 to engage with. Each cylinder is a specific collection of panels making the tube as long as desired. Other components such as elbows and connections will be assembled in a similar way with cylinder layers matching the tubes cylinder 1251 1254 layers.

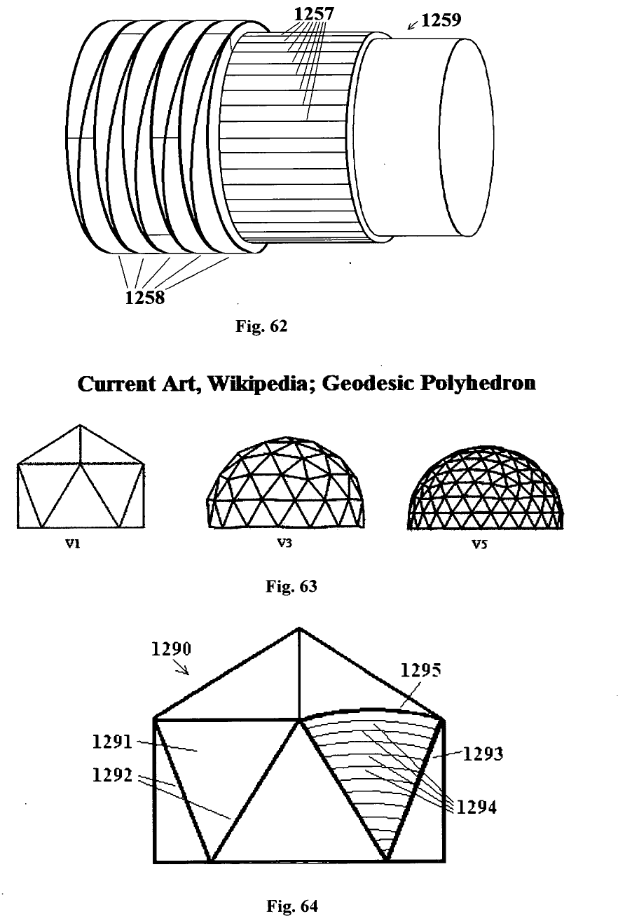

In FIG. 62 is a layer of straight Key Rails 1257 are used for precision positioning 1259. Thirty-six Key Rails are 10-degrees apart. Only straight Rails have angular precision. Curved or angled Rails will be subject to tolerances that will through precision positioning off. Abutting panels 1258 are pipe thread panels. These are 180-degree panels that attached from the side but slide into position down the straight threads. This would be a configuration for adding a valve. This is an example of why a straight Key Rail and Key thread are useful.

### Spherical

The dome or sphere panels can be based on a geodesic polyhedron such as FIG. 63 examples. The sphere surfaces will be circular. The polyhedrons are flat triangles but their end points can be the end points of a spherical Key panel. Plutonic, Archimedean, and some Johnson solids all have intercept surface points with the same radii that can be used to made into other spherical panels. The Plutonic solids are made of triangles, squares and pentagons. By making spherical panels, multiple layers can be out of overlapped and interlock.

FIG. 64 is a geodesic polyhedron 1290 from FIG. 63. The triangle 1291 with the identical sides 1292 can be used to create a panel 1293. The arc 1295 can be based on the radius of the sphere (not shown) or the radius of the sides 1292. The assembly will be a rotation of this panel 1293 such that it engages on its arc 1295 along the rails 1294.

### Key Beam

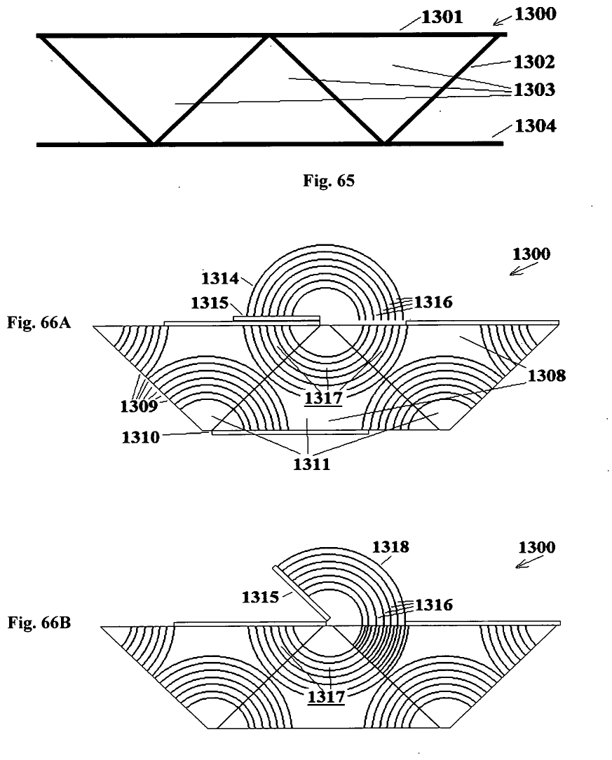

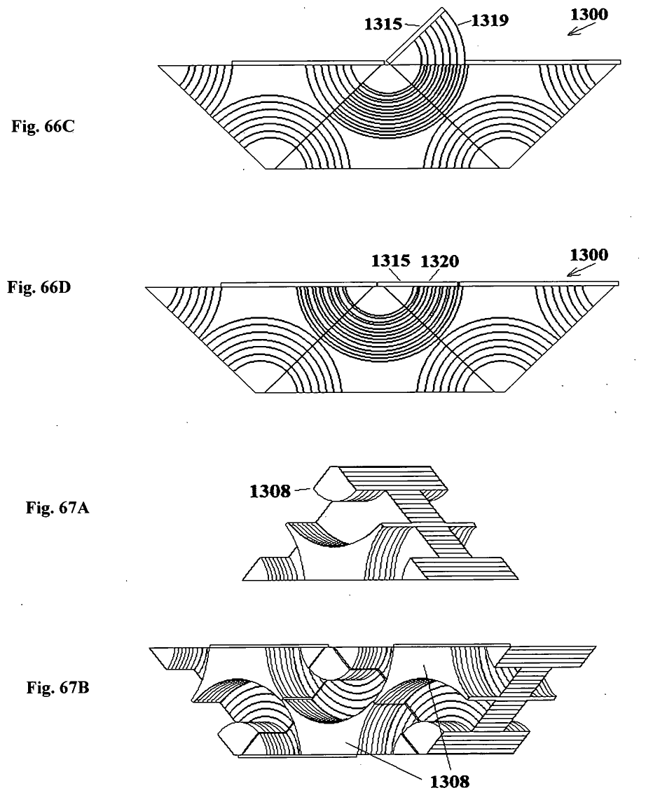

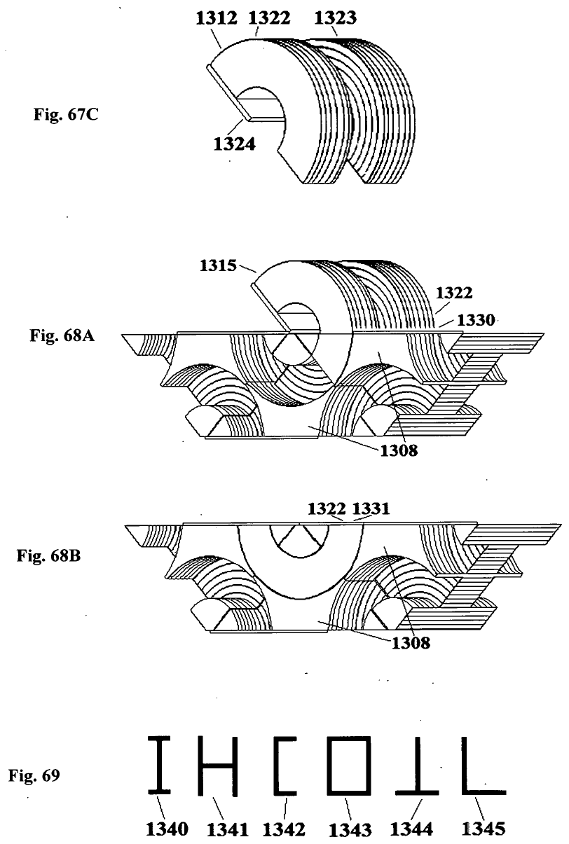

The Key beam is based on a truss 1300 system diagrammed with side views in FIGS. 65 & 66. A truss 1301 has structures 1302 in triangular formations 1303. The bottom 1304 has a flange that extends outward (not shown). A Key beam starts in FIG. 66 A with web panels 1308 positioned 1311 in a truss formation 1300. There are circular threads represented by Key Rails 1309. The flange 1310 is part of the panel 1308. On top is the flange Lock 1315 in its starting position 1314. The flange Lock 1315 Key Rails 1316 will penetrate the grouped 1317 web panels 1308 Key Rails 1309. These Rails 1316 are actually inside and would not be seen. FIG. 66 B is a 30-deg. Rotation 1318. FIG. 66 C is 150-deg rotation 1319 and FIG. 66 D is the terminal position 1320 of the Key thread rails. FIG. 67 A is an angled view of one of the panels 1308 in FIG. 66 A. FIG. 67 B is the same configuration of the FIG. 66 A group 1311 of web panels 1308. FIG. 67 C is an angled view 1322 of the flange Lock 1312. It also shows two flange Locks 1322 1323 one on each side. They are both mounted on the flange 1324. They engage the circular threads of the grouped web panels 1317 on each side.

FIG. 68 A is an angled view of FIG. 66 B. The flange Lock 1315 1322 is position 1330 with a 30-degree rotation into the web panels. FIG. 68 B is an angled view of FIG. 66 D with the flange Lock 1322 in its terminal position 1331.

These Key beam flange Lock and web panel are examples of new construction because Key threads allow overlapping and interlocking. The common steel structural components diagrammed in FIG. 69 are the I beam 1340, H beam 1341, Channel Iron 1342, square tube 1343, T-Iron 1344 and Angle iron 1345. The Key beam web panels and flange Locks could be applied to these and others. The purpose is to assemble Key beam parts into straight or curved structures.

### Keypod

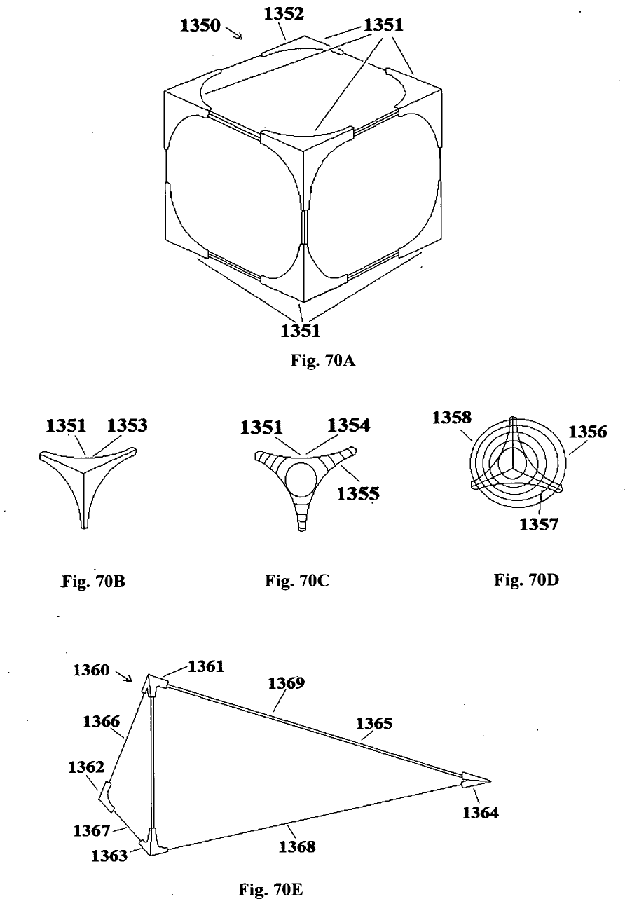

The term Keypod 1350 came from tripod, a similar shape 1351. FIG. 70 A has eight Keypods 1351 fastening the corners of a square box 1352. The outside view 1353 of the Keypod 1351 in FIG. 70B is the external corners. FIG. 70 C is the inside 1354 of the Keypod 1351 showing the Keys Rails 1355 on a cone or convex shape with circular or spiral Key thread. This Keypod 1351 has three legs that fasten on the ridges of the geometric square shape.

The basis of the Keypod is in FIG. 70 D with the Keypod 1357 laid over the circular Key Rails 1358 representing a cone or convex Key thread shape. That Keypod 1357 could be many different shapes that will work with the same Key Rails 1358.

The edges of the box panels not shown has the mating Key threads. This can be expanded on by having bigger Keypods on the ground so a forklift can get under it.

A Keypod can have many legs on the corners of matching polygon ridges. They can be the inside or outside corner fasteners of a structure. A Keypod legs have partial key threads that mate with one or more receiving threads on the edges of one or more panel. The “hooking” property of the Key thread fastens better than any other thread could. While the Key thread could be conic, concave, or convex, each leg does not have to have the same thread. Each leg does have to have the same rate of insertion per degrees of rotation so they join in one motion.

In FIG. 70E 1360 has an unequal four-sided pyramid 1369 have four different Keypods 1361 1362 1364 1365. Each are attached to the union of three of the four ridges 1366 1367 1368 1369. Every Keypod can be unique. It only requires Keypod threaded legs to mate with receiving threads not shown.

Keypods can be added to external or internal corners for additional support or other purposes. These could be to fasten boxes or containers in place. They could be designed for clearance so a forklift can get underneath. The fact that they could be put on and taken off allows for more versatile uses. It also allows containers and boxes to be broken down for condensed storage and transportation. Such a cargo container system would be easy to maintain and use in destructive applications

### Multi-Axial Locking

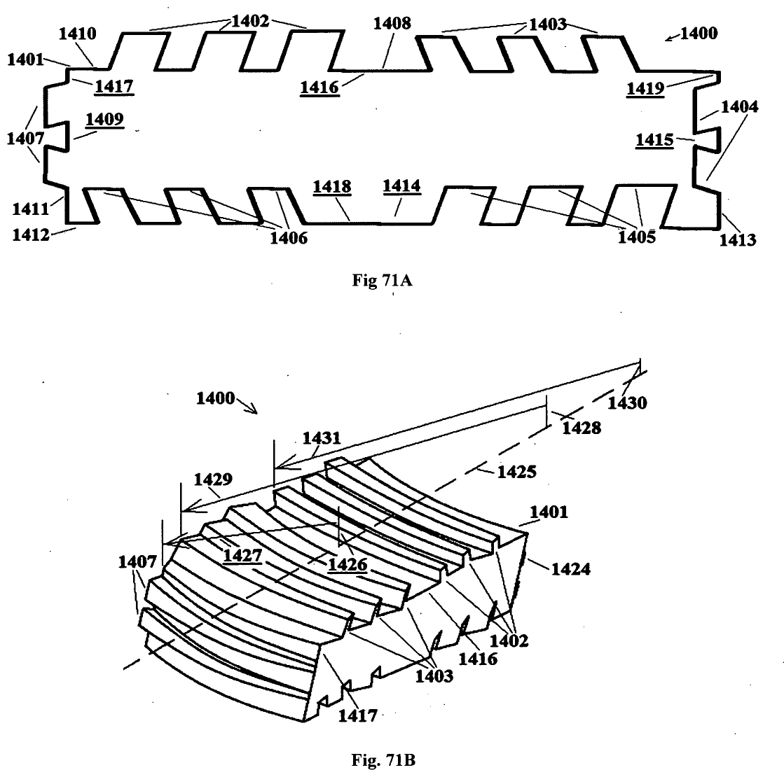

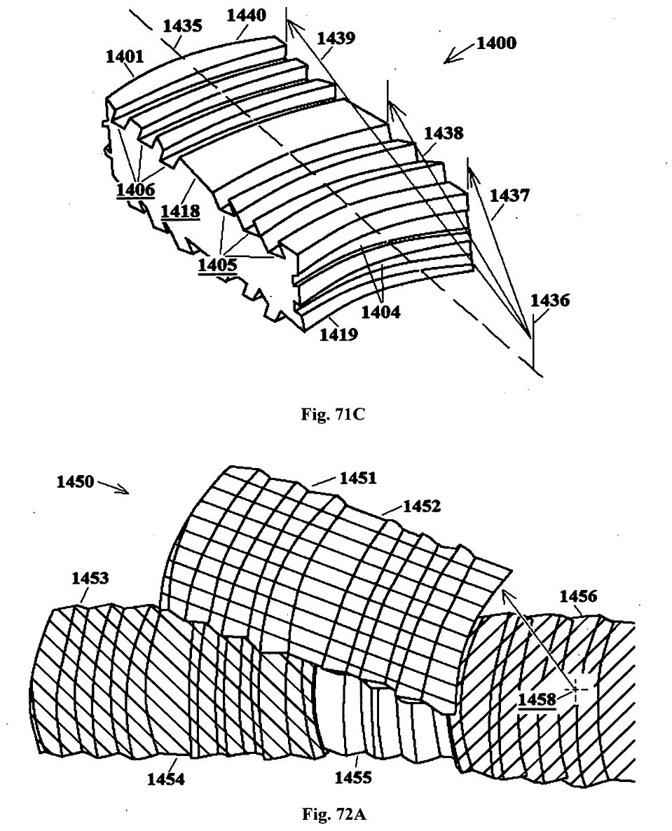

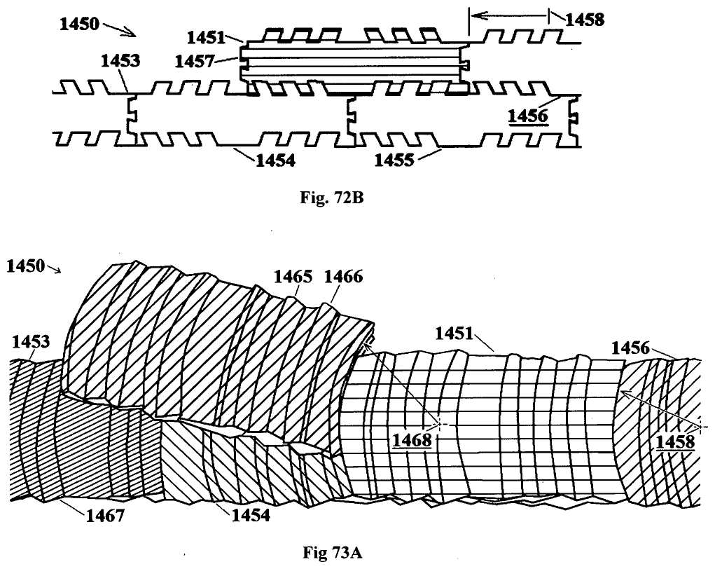

The concept of multi-axial locking is that two or more key threads are leveraged against each other on the same part. That leverage is from different axis of rotation of each set of key threads. Assembling the parts engages the leverages. FIGS. 71A-C are an example of a keyed brick with six threads on four sides. FIGS. 72-75 are the process and effect of assembly. Another aspect is that the MAL (Multi-Axial-Locking) bricks can only be assembled and disassembled in one order. Combined with the high surface contact of the key threads, these aspects create an evolutionary type of construction brick.

The figures are of 3D printed models made and tested.

FIG. 71 A is side view 1400 of a key thread 1401. The top 1416 has the keys 1402 1403 of two sets of external key threads. The first keys 1402 near the open end 1417 are angled right towards the center 1408 while the second 1403 group near the closed end 1419 are angled left, also towards the center 1408. The left end 1417 is the open end because it arc outwards (not shown). It has two keys 1407 angled towards each other. The right end 1419 is the closed end because it arcs inwards (not shown). It has two locks 1404 angled towards each other. This geometry has created another type of key 1415 that will fit into the other type of lock 1409 on the other end. This is a zipped thread.

The bottom 1418 has two sets of locks 1405 1406 embedded. They are angled towards the center 1414. These two sets of locks are keynected. A keynection are two or more key threads that engage on the same axis of rotation, but in different directions or configurations. These 1405 1406 act as a group to pull into the center 1414. The top 1416 keys 1402 1403 are acted; on individually by other parts. This will be shown with the different axis of rotations.

FIGS. 71 A and B will demonstrate the location of the axis of rotation for each of the six groups of keys and locks. These axes are off a center line. A reference radius line is used to show which group of keys/locks belong to which axis. Each thread has multiple radii.

FIG. 71 B is an angled top view 1424 to show the curved open end 1417 with keys 1407 and the two sets of keys 1402 1403 on top 1416. There is a reference center line 1425 and three axis of rotation 1426 1428 1430. The first axis 1426 has a reference radius 1427 for the open curved end 1417 keys 1407. The second axis 1428 has a reference radius 1429 for the top open keys 1403. The third axis 1430 has a reference radius for the group of closed keys 1402.

FIG. 71 C is an angled bottom view 1440 with the closed end 1419 keys 1404 and bottom 1418 sets of locks 1405 1406. The bottom and closed locks all share the same axis of rotation 1436. The closed curved end 1419 locks 1404 have a reference radius 1437. The bottom closed locks 1405 have a reference radius 1438 for that group. The bottom open end locks 1406 has reference radius 1439. This common axis of rotation is an assembly point of rotation of the part 1401 as well while the other axes on the top 1426 1428 1430 are relative to the threads.

This is the key principal of the multi-axial locking. The threads are made with their axis, but their connections are with shared axes of the connected threads on other parts.

FIGS. 72-75 A and B will show the assembly of keyed bricks into a wall. There will be one reference brick with others added to it showing how the different axis of rotations are formed around it. The FIGS. 72-75 A's will be a top view of a partial assemblies centered around the reference brick. FIGS. 72-75 B's will be a front view of a completed assembly around the reference brick.

FIG. 72 A is an assembly 1450 of a reference brick 1451 being rotated 1452 into the wall 1453. It 1451 is engaging the top threads of bricks 1454 1455 on the lower layer and the end open brick 1456 on the same layer. The part's axis rotation 1458 is the same as the bottom threads. FIG. 72 B is a side view 1457 of the brick 1451 in its terminal position.

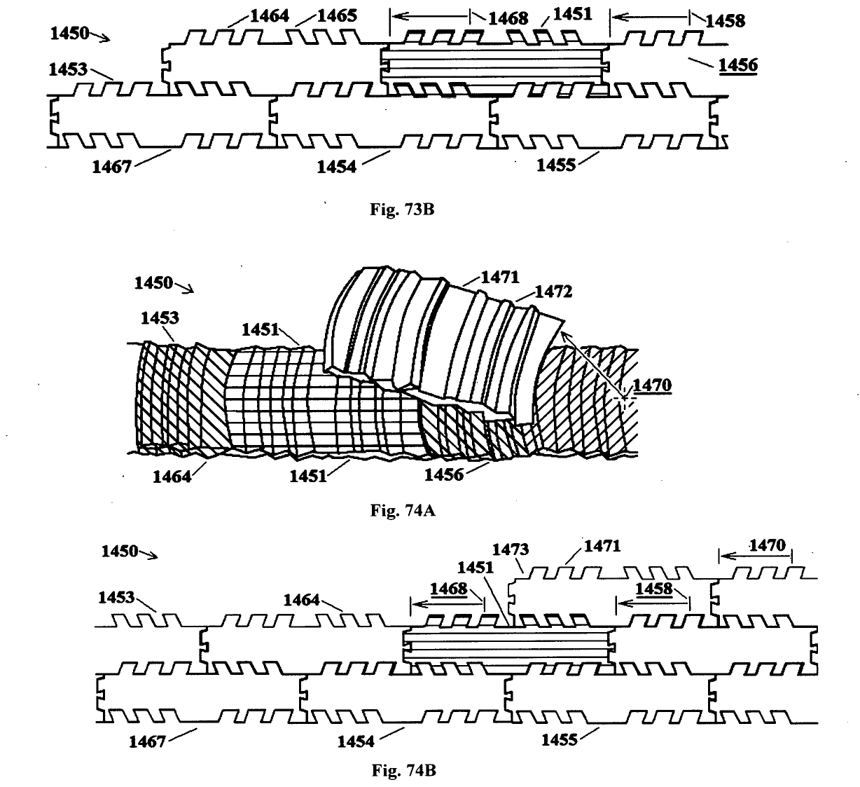

FIG. 73 A is the next brick 1464 which is shown partially rotated 1466 around its axis of rotation 1468 into the open end of the reference brick 1451. At the same time it 1464 is engaging the top threads of two bricks 1467 1454 underneath. FIG. 73 B shows the side view of that next brick 1464 in its terminal position 1465. This has boxed in the two ends of the reference brick 1451. Note it's 1464 axis of rotation 1468 is over the reference brick 1451.

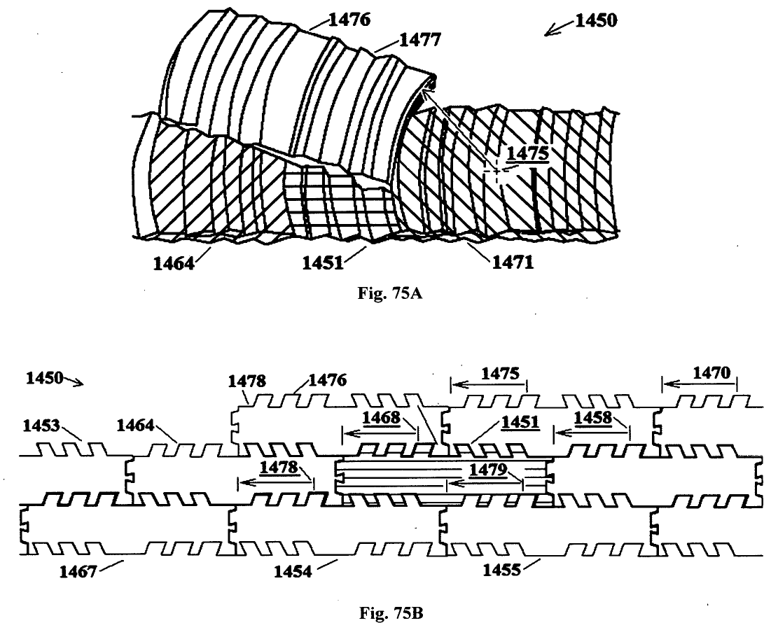

FIG. 74 A shows brick 1471 in rotation 1472 on it's axis 1470 to cover the top half of the reference brick 1451. FIG. 74 B is the wall 1453 view with the brick 1471 in position 1473 over the reference brick. FIG. 75 A is the last brick 1476 to complete the enclosure of the reference brick 1451 partially engaged 1477. FIG. 75 B has the reference brick embedded in the wall 1453. The two axes below the reference 1478 1479 from the bricks 1454 1455 are also engaged.

This makes 6 axes 1478 1479 1458 1468 1470 1475 that engage the reference brick 1451. All of these resist rotation due to the net effect of locking the reference 1451 and all bricks very tightly. The sets of key threads are designed based on a specific axis. They are then positioned on a part. That part has a common axis of rotation with three of these sets. The other threads have an axis common to sets on other parts. Each key thread set resist movement of other sets and fastens with the maximum strength of the materials.

Multi-Axial Locking can be applied to many geometries that allow for multiple key thread sets that include more then one axis of rotation. Such multi-axial engagement resist movement on any axis.

### Shape Resistance

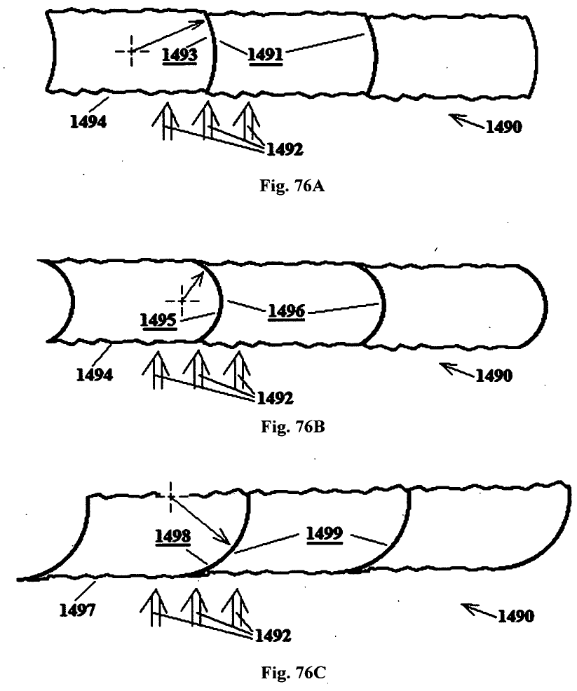

Shape resistance 1490 is how the key threads on a curved brick surfaces bricks adds to its resistance to mechanical stresses. FIG. 76 A is an example of shape resistance 1491 with the curved 1493 shape of the ends of the bricks 1494 are more resistant to mechanical stresses 1492 then squared off shapes would be. This shape resists the development of a sheer plane.

The brick 1495 in FIG. 76 B as a tighter curved 1496. The effect will be a more pronounced shape resistance 1497 to mechanical stresses 1492. The curve 1498 in FIG. 76 C creates a geometry with a shape resistance 1499 more pronounced on one side. These bricks in FIG. 76 B 1495 and C 1497 are more difficult to rotate into position. All aspects of keyed brick design have tradeoffs.

The Key Thread Systems are the unique application that only work or work best with a Key thread.

Although the present invention has been described in considerable detail with reference to certain preferred versions thereof, other versions would be readily apparent to those of ordinary skill in the art. Therefore, the spirit and scope of the present invention should not be limited to the description of the preferred versions contained herein.

What is claimed is:

1. A key threaded system comprising:
a first part having a body comprising at least one mating surface upon which at least one key thread is disposed, said key thread comprising a key train comprising a plurality of key profiles forming an outer surface and having a key train length defined between a smallest key profile and a largest key profile; and
a second part having a body comprising at least one mating surface into which at least one key lock is disposed, said key lock comprising a plurality of key lock profiles forming an inner surface having a lock length defined between a smallest lock profile and a largest lock profile;
wherein said outer surface of said key train of said key thread and said inner surface of said key lock are each shaped and dimensioned to form a key thread set that follows a same key rail around an axis of rotation;
wherein said outer surface of said key train of said key thread and said inner surface of said key lock are each shaped and dimensioned such that each key profile has a cross section that is progressively larger than an adjacent key profile along said key length from said smallest key profile to said largest key profile and each lock profile has a cross section that is progressively larger than an adjacent lock profile along said lock length from said smallest lock profile to said largest lock profile such that said key train may be moved through said key lock along said key rail without substantial interference until said smallest key profile reaches a terminus position at said smallest lock profile;
wherein said key train of said key thread and said key lock are each shaped and dimensioned such that each key profile has substantially the same shape and size as each lock profile at each point along the key rail when said smallest key profile reaches a terminus position at said smallest lock profile such that high surface contact is achieved between said outer surface of said key train of said key thread and said inner surface of said key lock of said first part and said second part when said smallest key profile reaches a terminus position at said smallest lock profile; and
wherein said outer surface of said key train of said key thread and said inner surface of said key lock are each shaped and dimensioned to comprise a hook that resists lateral mechanical forces applied to said first part in a direction perpendicular to said mating surface of said second part.

2. The key threaded system as claimed in claim 1, wherein said hook is shaped and dimensioned to resists mechanical forces applied to said first part in all directions that are not aligned with said axis of rotation of said key rail.

3. The key threaded system as claimed in claim 1, wherein at least two key locks are disposed into said at least one mating surface of said body of said second part.

4. The key threaded system as claimed in claim 3 wherein said inner surface of each of said at least two key locks is shaped and dimensioned to follow a same key rail around an axis of rotation and such that a single first part may mate with and form a single key thread set with at least two second parts together.

5. The key threaded system as claimed in claim 3, wherein said inner surface of each of said at least two key locks is shaped and dimensioned to follow a different key rail around a different axis of rotation such that said second part may be interlocked by and form two key thread sets with two first parts.

6. The key threaded system as claimed in claim 1:
wherein said first part is a first key brick and said at least one mating surface of said body of said first part comprise at least two substantially planar mating surfaces;
wherein said second part is a second key brick and said at least one mating surface of said body of said second part comprise at least two substantially planar mating surfaces;
wherein each of said first key brick and said second key brick comprise at least one mating surface upon which at least one key thread is disposed and at least one mating surface into which at least one key lock is disposed.

7. The key threaded system as claimed in claim 6 wherein said first key brick and said second key brick are substantially identical.

8. The key threaded system as claimed in claim 7 wherein said at least two substantially planar mating surfaces of said first key brick and said second key brick comprises:
a substantially planar top mating surface;
a substantially planar bottom mating surface disposed in parallel relationship to said top mating surface;
a right end surface and a left end surface each disposed in substantially perpendicular relationship to said top mating surface and said bottom mating surface;
wherein said each of said right end surface and said left end surface are shaped and dimensioned to form an arced surface having an axis of rotation substantially equal to said axis of rotation of said key rail and wherein one of said right end surface and said left end surface form an outward arc and the other forms an inward arc.

9. The key threaded system as claimed in claim 8 wherein a key thread is disposed upon one of said right end surface and said left end surface and a key lock is disposed within the other.

10. The key threaded system as claimed in claim 8 further comprising a third key brick and a fourth key brick;
wherein said third key brick and said fourth key brick are substantially identical and each comprises:
a substantially planar top mating surface upon which at least one key thread is disposed, said key thread comprising a key train comprising a plurality of key profiles forming an outer surface and having a key train length defined between a smallest key profile and a largest key profile; and
a substantially planar bottom mating surface disposed in parallel relationship to said top mating surface and into which at least one key lock is disposed, said key lock comprising a plurality of key lock profiles forming an inner surface having a lock length defined between a smallest lock profile and a largest lock profile; and
a right end surface and a left end surface each disposed in substantially perpendicular relationship to said top mating surface and said bottom mating surface;
wherein said outer surface of said key train of said key thread and said inner surface of said key lock are each shaped and dimensioned to form a second key thread set that follows a same key rail around an axis of rotation that is not equal to said axis of rotation of said first rail of said first key brick and said second key brick; and
wherein said each of said right end surface and said left end surface are shaped and dimensioned to form an arced surface having an axis of rotation substantially equal to said axis of rotation of said key rail of said third brick and said fourth brick and wherein one of said right end surface and said left end surface form an outward arc and the other forms an inward arc.

11. The key threaded system as claimed in claim 10 wherein a key thread is disposed upon one of said right end surface and said left end surface of said third key brick and said fourth key brick and a key lock is disposed within the other.

12. The key threaded system as claimed in claim 1:
wherein said first part is a first key disk and said at least one mating surface of said body of said first key disk comprise at least two substantially planar mating surfaces;
wherein said second part is a second key disk and said at least one mating surface of said body of said second key disk comprise at least two substantially planar mating surfaces;
wherein said key train of said first key disk is a spiral key train and said key lock of said second key disk is a spiral key lock; and
wherein said spiral key train and said spiral key lock form a single key thread set having the same axis of rotation.

13. The key threaded system as claimed in claim 3:
wherein said first part is a first key disk;
wherein said second part is a second key disk and said at least one mating surface of said body of said second key disk comprise at least two substantially planar mating surfaces;
wherein four key locks are disposed into said at least one mating surface of said body of said second part; and
wherein said inner surface of each of said four key locks is shaped and dimensioned to follow a same key rail around an axis of rotation and such that a single first part may mate with and form a single key thread set with four second parts.

14. The key threaded system as claimed in claim 13:
wherein said at least one mating surface of said body of said first key disk comprise a substantially planar top mating surface and as substantially planar bottom mating surface;
wherein said key thread is disposed upon said bottom mating surface of said first key disk; and
wherein four key locks are disposed into the top mating surface of said body of said first key disk; and
wherein said inner surface of each of said four key locks disposed into said top mating surface are shaped and dimensioned to follow a same key rail around an axis of rotation and such that said key thread disposed upon said bottom surface of said first part mate with four key locks the top surface of four first key disks to form a single key thread set.

15. The key threaded system as claimed in claim 1:
wherein said first part is a bolt and wherein said at least one mating surface of said body comprises a substantially conic mating surface upon which at least one key thread is disposed; and
wherein said at least one mating surface of said body of said second part comprises a substantially conic mating surface into which at least one key thread is disposed.

16. The key threaded system as claimed in claim 15:
wherein said at least one key thread disposed upon said body of said bolt comprises a first key thread and a second key thread;
wherein said at least one key lock disposed into said body of said second part comprises a first key lock and a second key lock;
wherein said key profile of said first key thread is different from said key profile of said second key thread;
wherein said lock profile of said first key lock is different from said lock profile of said second key lock; and
wherein said first key thread and said first key lock form a first key thread set and said second key thread and said second key lock for a second key thread set.

17. The key threaded system as claimed in claim 1:
wherein said first part is an outer cylinder and said second part is an inner cylinder; and
wherein said at least one key thread disposed upon said body of said outer cylinder comprises a first key thread and a second key thread disposed upon an inner surface of said outer cylinder;
wherein said at least one key lock disposed into said body of said inner cylinder comprises a first key lock and a second key lock disposed into an outer surface of said inner cylinder;
wherein said first key thread and said first key lock form a first key thread set and said second key thread and said second key lock for a second key thread set; and
wherein said first key thread set and said second key thread set have the same axis of rotation.

18. The key threaded system as claimed in claim 17:
wherein said key profile of said first key thread is different from said key profile of said key thread; and
wherein said lock profile of said first key lock is different from said lock profile of the said second key lock.

19. The key threaded system as claimed in claim 4:
wherein said first part is a triangular key beam panel comprising a flange and wherein said at least one mating surface of said body of said first part comprise at least two substantially planar mating surfaces;
wherein said second part is a flange lock and wherein said at least one mating surface of said body of said second part comprise at least two substantially planar mating surfaces;
wherein said system is a key beam system comprising at least three triangular key beam panels; and
wherein said key lock of said flange lock is shaped and dimensioned to mate with and connect three of said at least three triangular key beam panels.

20. The key threaded system as claimed in claim 1 wherein said at least one mating surface of said first part comprises at least two different shapes.
